SEQUENCE LISTING (40 sequences)

SEQ ID NO: 1 - RNA, 25 nt, Homo sapiens
gccaagucugugacuugcacguacu

SEQ ID NO: 2 - RNA, 25 nt, Homo sapiens
ccggacgauauugaacaaugguuca

SEQ ID NO: 3 - RNA, 25 nt, Homo sapiens
gcuucgagauguuccgagagcugaa

SEQ ID NO: 4 - RNA, 25 nt, Homo sapiens
gcacuuaacguaaucacgaagaaga

SEQ ID NO: 5 - RNA, 25 nt, Homo sapiens
ggagcgaugucauucugcugagcuu

SEQ ID NO: 6 - RNA, 25 nt, Homo sapiens
ccaagaucuguuguggguacggcuu

SEQ ID NO: 7 - RNA, 25 nt, Homo sapiens
cccagcccacauguccugaucauau

SEQ ID NO: 8 - RNA, 25 nt, Homo sapiens
ucgcagugaagauuguagauaugaa

SEQ ID NO: 9 - RNA, 25 nt, Homo sapiens
ggcuuggcaacaguauuucgguaua

SEQ ID NO: 10 - RNA, 25 nt, Homo sapiens
ccugcuggaccggauguuaaccuuu

SEQ ID NO: 11 - RNA, 25 nt, Homo sapiens
gcauucuggcugagaugcucucuaa

SEQ ID NO: 12 - RNA, 25 nt, Homo sapiens
ggaagccaugagagaugucuacauu

SEQ ID NO: 13 - RNA, 25 nt, Homo sapiens
ggaguaacaucagacaacucuuauu

SEQ ID NO: 14 - RNA, 25 nt, Homo sapiens
gacguuccugaagcuugccuucugu

SEQ ID NO: 15 - RNA, 25 nt, Homo sapiens
ggagauguugcaguaaagauccuaa

SEQ ID NO: 16 - RNA, 25 nt, Homo sapiens
gacaugugaauauccuacucuucau

SEQ ID NO: 17 - RNA, 25 nt, Homo sapiens
ggaccucagcgagaaaggaagucau

SEQ ID NO: 18 - RNA, 25 nt, Homo sapiens
ggagcauaauccaccaucaauauau

SEQ ID NO: 19 - RNA, 25 nt, Homo sapiens
aguacgugcaagucacagacuuggc

SEQ ID NO: 20 - RNA, 25 nt, Homo sapiens
ugaaccauuguucaauaucguccgg

SEQ ID NO: 21 - RNA, 25 nt, Homo sapiens
uucagcucucggaacaucucgaagc

SEQ ID NO: 22 - RNA, 25 nt, Homo sapiens
ucuucuucgugauuacguuaagugc

SEQ ID NO: 23 - RNA, 25 nt, Homo sapiens
aagcucagcagaaugacaucgcucc

SEQ ID NO: 24 - RNA, 25 nt, Homo sapiens
aagccguacccacaacagaucuugg

SEQ ID NO: 25 - RNA, 25 nt, Homo sapiens
auaugaucaggacaugugggcuggg

SEQ ID NO: 26 - RNA, 25 nt, Homo sapiens
uucauaucuacaaucuucacugcga

SEQ ID NO: 27 - RNA, 25 nt, Homo sapiens
uauaccgaaauacuguugccaagcc

SEQ ID NO: 28 - RNA, 25 nt, Homo sapiens
aaagguuaacauccgguccagcagg

SEQ ID NO: 29 - RNA, 25 nt, Homo sapiens
uuagagagcaucucagccagaaugc

SEQ ID NO: 30 - RNA, 25 nt, Homo sapiens
aauguagacaucucucauggcuucc

SEQ ID NO: 31 - RNA, 25 nt, Homo sapiens
aauaagaguugucugauguuacucc

SEQ ID NO: 32 - RNA, 25 nt, Homo sapiens
acagaaggcaagcuucaggaacguc

SEQ ID NO: 33 - RNA, 25 nt, Homo sapiens
uuaggaucuuuacugcaacaucucc

SEQ ID NO: 34 - RNA, 25 nt, Homo sapiens
augaagaguaggauauucacauguc

SEQ ID NO: 35 - RNA, 25 nt, Homo sapiens
augacuuccuuucucgcugaggucc

SEQ ID NO: 36 - RNA, 25 nt, Homo sapiens
auauauugaugguggauuaugcucc

SEQ ID NO: 37 - protein, 6 aa, Artificial Sequence
  Description of Artificial Sequence Synthetic 6xHis tag
HHHHHH

SEQ ID NO: 38 - DNA, 786 bp, Homo sapiens
atggcagaatcccacctgcagtcatccctcatcacagcctcacagtttttcgagatctggctccatttcgacgctgacggaagtggttacctggaaggaaaggagctgcagaacttgatccaggagctccagcaggcgcgaaagaaggctggattggagttatcacctgaaatgaaaacttttgtggatcagtatgggcaaagagatgatggaaaaataggaattgtagagttggctcacgtattacccacagaagagaatttcctgctgctcttccgatgccagcagctgaagtcctgtgaggaattcatgaagacatggagaaaatatgatactgaccacagtggcttcatagaaactgaggagcttaagaactttctaaaggacctgctagaaaaagcaaacaagactgttgatgacacaaaattagccgagtatacagacctaatgctgaaactatttgattcaaataatgatgggaagctggaattaactgagatggccaggttactaccagtgcaggagaattttcttcttaaattccagggaatcaaaatgtgtgggaaagagttcaataaggcttttgagctgtatgatcaggacggcaatggatacatagatgaaaatgaactggatgctttactgaaggatctgtgcgagaagaataaacaggatctggatattaataatattacaacatacaagaagaacataatggctttgtcggatggagggaagctgtaccgaacggatcttgctcttattctctgtgctggggataactag

SEQ ID NO: 39 - DNA, 786 bp, Homo sapiens; identical to SEQ ID NO: 38

SEQ ID NO: 40 - DNA, 786 bp, Mus musculus
atggcagaatcccacctgcagtcatctctgatcacagcctcacagttttttgagatctggcttcatttcgacgctgacggaagtggttacctggaaggaaaggagctgcagaacttgatccaggagcttctgcaggcgcgaaagaaggctggattggagctatcaccggaaatgaaatcctttgtggatcaatatggacagagagatgatggaaaaataggaattgtagagttggctcacgtcttacccacagaagagaatttcttgctgctctttcgatgccagcaactgaagtcctgcgaggaattcatgaagacttggagaaagtatgatactgaccacagcggcttcatcgaaaccgaggaacttaagaactttctaaaggacctactagagaaagcaaacaagactgtggatgatacaaaactagcagagtacacagacctcatgctgaaactatttgattcaaataatgacggaaagctggaactgacagagatggccaggttactaccagtgcaggaaaatttccttcttaaattccagggaatcaaaatgtgtgggaaagagttcaataaggcttttgagttatatgatcaggatggcaacggatacatagatgaaaatgagctggatgctttgctgaaagatctgtgtgagaagaacaaacaggaattggatattaacaatattactacatacaagaagaacataatggccttgtcggatggagggaagctgtaccgaacagaccttgctcttattctttctgctggagacaactag

(19) United States
(12) Patent Application Publication
(10) Pub. No.: US 2015/0278904 A1
(43) Pub. Date: Oct. 1, 2015

(54) Collections of Matched Biological Reagents and Methods for Identifying Matched Reagents

(71) Applicant: LIFE TECHNOLOGIES CORPORATION, Carlsbad, CA (US)

(72) Inventors: John CARRINO, Cardiff, CA (US); Feng Liang, San Diego, CA (US); Siamak Baharloo, Lexington, MA (US); Barry Schweitzer, Cheshire, CT (US)

(21) Appl. No.: 14/637,587

(22) Filed: Mar. 4, 2015

Related U.S. Application Data
(63) Continuation of application No. 13/422,202, filed on Mar. 16, 2012, now abandoned.
Application No. 13/422,202 is a continuation of application No. 11/112,933, filed on Apr. 22, 2005, now abandoned.
Application No. 11/112,933 is a continuation of application No. 10/830,074, filed on Apr. 23, 2004, now abandoned.
(60) Provisional application No. 60/665,200, filed on Mar. 25, 2005.
(60) Provisional application No. 60/659,492, filed on Mar. 7, 2005.
(60) Provisional application No. 60/651,390, filed on Feb. 8, 2005.
(60) Provisional application No. 60/608,293, filed on Sep. 8, 2004.
(60) Provisional application No. 60/592,239, filed on Jul. 28, 2004.
(60) Provisional application No. 60/591,541, filed on Jul. 26, 2004.
(60) Provisional application No. 60/587,941, filed on Jul. 14, 2004.
(60) Provisional application No. 60/588,158, filed on Jul. 14, 2004.

(51) Int. Cl. G06Q 30/06

(52) U.S. Cl. CPC G06Q 30/0627; G06Q 50/22

(57) ABSTRACT

Provided herein are collections of matched biological reagents selected from a larger collection of biological reagents, wherein the collection of matched biological reagents relate to a biological element. Also provided are methods for selling an isolated biomolecule or biological research reagent in a collection of matched biological reagents, and methods for selecting an isolated biomolecule or biological research reagent from a collection of biological reagents.

Priority is claimed to U.S. patent application Ser. No. 10/830,074, filed 23 Apr. 2004, and entitled “Online Procurement of Biologically Related Products/Services Using Interactive Context Searching of Biological Information”; U.S. Provisional Application No. 60/651,390, filed 8 Feb. 2005 by John Carrino and entitled “Collections of Matched Biological Reagents and Methods for Identifying Matched Reagents”; U.S. Provisional Application Ser. No. 60/659,492, filed 7 Mar. 2005 by John Carrino and Feng Liang and entitled “Collections of Matched Biological Reagents and Methods for Identifying Matched Reagents”; U.S. Provisional Application Ser. No. 60/665,200, filed 25 Mar. 2005 by John Carrino and Feng Liang and entitled “Collections of Matched Biological Reagents and Methods for Identifying Matched Reagents”; U.S. Provisional Application filed 19 Apr. 2005 by John Carrino and Feng Liang having docket number INV-1005-PV7 and entitled “Collections of Matched Biological Reagents and Methods for Identifying Matched Reagents”; U.S. Provisional Application No. 60/587,941, filed 14 Jul. 2004, and entitled “Methods and Systems for in Silico Experimental Design and for Providing a Biotechnology Product to a Customer”; U.S. Provisional Application No. 60/608,293, filed 8 Sep. 2004, and entitled “Methods and Systems for in Silico Experimental Design and for Providing a Biotechnology Product to a Customer”; U.S. Provisional Application No. 60/588,158, filed 14 Jul. 2004, and entitled “Method for Providing Protein Microarrays”; U.S. Provisional Application No. 60/591,541, filed 26 Jul. 2004, and entitled “Method for Providing Protein Microarrays”; U.S. Provisional Application No. 60/592,239, filed 28 Jul. 2004, and entitled “Method for Providing Protein Microarrays”; and U.S. Provisional Application No. 60/953,586, filed 15 Feb. 2005, and entitled “Methods for Providing Protein Microarrays”; which are all referred to and incorporated herein by reference in their entirety.

### BACKGROUND OF THE INVENTION

1. Field of the Invention

The invention is in general directed to collections of biological reagents that are categorized based on biological information, such as, for example, biological pathways, diseases, disease pathways, ontology, or function, or a class of biomolecules to which they relate, an methods for identifying and methods for selling a sub-group of reagents matched to one or more search criteria from a larger collection.

2. Background Information

Discoveries of new medical diagnostics for diagnosing and prognosing a medical condition, and new medical treatments for treating these medical conditions, including new pharmaceuticals, requires years of medical, biological, and biochemical research. This research continues to become more powerful and accelerated by the discovery and availability to scientists and physicians, of a huge number of increasingly powerful research tools and huge amounts of biological information that is being obtained using these research tools. The research tools include, for example, biological research products, services, protocols, and instruments, as well as isolated biomolecules. With this availability of a growing number of research tools and huge amounts of biological and medical information, it is more difficult for scientists and physicians to be aware and knowledgeable of all of the research tools and biological and medical information available to them.

With the increasing popularity of computers (for example, personal computers including smaller devices with computing ability) and advancements in telecommunication network technology, many industries have used these new innovations to improve many commercial operations. In the retail-merchandising arena, for example, hosts of products such as books, music, electronics, athletic gear, etc. are available for online purchases through the Internet. By effectively utilizing virtual stores, merchants streamline purchasing and delivery process for both the consumer and retailer. In similar fashion, telecommunication networks make it possible for many other industries to conduct business in a more efficient manner. To name just a few examples, industries taking advantage of such innovations are financial institutions, travel agencies, and news/media networks. In short, a wide range of industries benefit from the use of computer technology to improve communications, regulatory compliance, manufacturing schedules, security, marketing, sales, and distribution of products and information.

As such, the World Wide Web (WWW) has become a significant new medium for commerce, which is referred to as electronic commerce or E-commerce. Vendors offer goods and services for sale via various WWW sites. However, many of the initial WWW systems were not interactive, and typically addressed only ongoing relationships previously worked out manually, for which extremely expensive custom systems needed to be developed at buyers' or vendors' sites.

Extranet Web technology has been developed to enable a corporation to “talk to” its suppliers and buyers over the Internet or otherwise secure communication routes as though the other companies were part of the corporation's internal “intranet.” This information exchange is done by using, for example, client/server technology, Web browsers, and hypertext technology used in the Internet, on an internal basis, as the first step towards creating intranets and then, through them and connections to the outside, extranets.

For corporations that sell and distribute at wholesale or retail, one technique for selling goods over the Internet uses the concept of a catalog Website that enables buyers to browse through Web pages and use a “shopping cart” feature for selecting items to purchase. Most of these catalog Websites are significantly limited in the interaction, if any, they allow between buyers and sellers (e.g., U.S. Pat. No. 5,117,354). Many corporations, such as General Electric and General Motors, use electronic communications for soliciting bids and ordering parts, supplies, raw materials, products and services on a wholesale basis. The present system and methods are amenable to any scale and any stage of providing information and ordering products and/or services.

Many vendors of biologically related products have also taken advantage of E-commerce to sell goods and services to buyers. Scientists, as consumers of such products, may be interested in more information about a particular product's characteristics beyond availability and price, to include biological attributes such as sequence similarity, linkage data, metabolic and signal pathway participation, compatibility with other systems or molecules, alternative pathways for substrate or product (and availability or provision thereof), etc. Scientists may also be interested in determining the availability of all of the products that are related to their area of research, for example, all of the products that might be used to determine a gene's expression and function, for example, products that could be used to determine the phenotype of cells in which the gene's expression is inhibited or overexpressed, the effect of particular candidate drug molecules on the gene or protein it encodes, or protein/protein interactions within a biological pathway of which the target protein is a member.

For thousands of years, scientists have been collecting biological data on different types of organisms, ranging from bacteria to human beings. Presently, much of the data collected is stored in one or more databases shared by scientists around the world. For example, a genetic sequence database referred to as the European Molecular Biology Lab (EMBL) gene bank is maintained in Germany. Another example of a genetic sequence database is Genbank, and is maintained by the United States Government.

Another useful database is known as the GO or Gene Ontology database, maintained by the Gene Ontology Consortium. The goal of the Gene Ontology™ (GO) Consortium is to produce a controlled vocabulary that can be applied to all organisms even as knowledge of gene and protein roles in cells is accumulating and changing. GO provides at present three structured networks of defined terms to describe gene product attributes. GO is one of the controlled vocabularies of the Open Biological Ontologies.

Biologists currently waste a lot of time and effort in searching for all of the available information about a desired small area of research. The search is hampered further by the wide variations in terminology that may be common usage at any given time, and that inhibit effective searching by computers as well as people. For example, if one were searching for new targets for antibiotics, he or she might want to find all the gene products that are involved in bacterial protein synthesis, and that have significantly different sequences or structures from those in another organism such as humans. But if one database describes these molecules as being involved in ‘translation’, whereas another uses the phrase ‘protein synthesis’, it will be difficult for an individual and even harder for a computer to recognize functionally equivalent terms.

The Gene Ontology project is a collaborative effort to address the beneficial need for consistent descriptions of gene products across different databases. The project began as a collaboration between three model organism databases: FlyBase (Drosophila), the Saccharomyces Genome Database, and Mouse Genome Database (MGD) in 1998. Since then, the GO Consortium has grown to include many databases, including several of the world's major repositories for plant, animal and microbial genomes. Such databases include The Arabidopsis Information Resource (TAIR); the WormBase; the EBI GOA project (i.e., annotation of UniProt Knowledgebase (Swiss-Prot/TrEMBL/PIR-PSD) and InterPro databases); Rat Genome Database (RGD); DictyBase (i.e., informatics resource for the slime mold Dictyostelium discoideum); GeneDB S. pombe; (part of the Pathogen Sequencing Unit at the Wellcome Trust Sanger Institute); GeneDB for protozoa; (part of the Pathogen Sequencing Unit at the Wellcome Trust Sanger Institute); Genome Knowledge Base (GK) (i.e., a collaboration between Cold Spring Harbor Laboratory and EBI); TIGR; Gramene; (i.e., a comparative mapping resource for monocots); Compugen and the Zebrafish Information Network (ZFIN).

The GO collaborators are currently developing three structured, controlled vocabularies (ontologies) that describe gene products in terms of their associated biological processes, cellular components and molecular functions in a species-independent manner. There are three separate aspects to this effort: first, to write and maintain the ontologies themselves; second, to make associations between the ontologies and the genes and gene products in the collaborating databases, and third, to develop tools that facilitate the creation, maintenance and use of ontologies.

The use of GO terms by several collaborating databases facilitates uniform queries across them. The controlled vocabularies are structured so that one can query them at different levels: for example, one can use GO to find all the gene products in the mouse genome that are involved in signal transduction, and one can zoom in on all the receptor tyrosine kinases. This structure also allows annotators to assign properties to gene products at different levels, depending on how much is known about a gene product.

Even with the availability of these bioinformatics databases, scientists are required to first search these databases for information, design their experiments, then search through traditional multiple catalogue-style vendor websites to determine the availability of biological reagents needed for their experiments. Aside from the time-consuming aspect of these searches, scientists must pull the information from the vendor websites, and may be unaware of the availability of products that could assist them in their research, but that they are not searching for. In addition, vendors do not have the opportunity to push information about related products toward the scientist customer, as the vendor may only be aware of the particular biological reagent that the scientist desires, and not the field of research the scientist is pursuing.

The information content available in one or more of such bioinformatics databases, combined with other information that can be provided by the vendor, can be invaluable to a scientist customer. As buyers of such products tend to be more sophisticated users of computer related technologies, and given the wealth of information available in various collections and combinations of biological data, advantages and efficiencies can be obtained from a merging of such biological data with searchable vendor based browsers for biologically related product and service acquisition.

The availability of searching for biological reagents matched to the target biomolecule that the scientist is seeking, allows the scientist to design more experiments to study the target biomolecule, and its pathway, and furthermore allows the scientist to obtain the necessary reagents in a quicker and easier manner. Accordingly, there is a need for larger and more clearly organized and more easily searchable collections of research tools that can be easily obtained by scientists and physicians. Furthermore, there is a need for more powerful, intelligent, customized, and user-friendly methods and means of presenting these research tools to scientists and physicians.

The present invention satisfies this need and provides additional advantages.

### SUMMARY

Provided herein is a collection of matched biological reagents comprising biomolecules and/or biological research products, comprising, for example, at least 100 different isolated biomolecules and/or biological research products of each of at least two biomolecule classes and/or biological research product classes. By matching biological reagents having a common biological link, customers can easily obtain information about the various available products that are biologically relevant to their research. The matched biological reagents of the collection often are related to one or more biological elements (e.g., one or more search elements), such as a target biomolecule, a target biomolecular pathway, a target biomolecular pathway member, a disease, a disease pathway, and a disease pathway member. The biological reagents may, for example, be selected from the group consisting of antibodies, RNAi, nucleic acids, enzymes, proteins, cell culture products, detection products, separation media, microarrays, and the like. In another example, the biological reagents may, for example, be selected from the group consisting of antibodies, nucleic acids, enzymes, proteins, cell culture products, detection products, separation media, microarrays, and the like.

The collection sometimes comprises, for example, at least 2, at least 3, at least 5, at least 7, at least 10, at least 20, at least 25, at least 50, at least 100, at least 200, at least 250, at least 500, at least 750, at least 1000, at least 1100, at least 1200, at least 1300, at least 1400, at least 1500, at least 1750, at least 2000, at least 2250, at least 2500, at least 2750, at least 3000, at least 3500, at least 4000, at least 4500, at least 5000, at least 5500, at least 6000, at least 6500, at least 7000, at least 7500, at least 8000, at least 8500, at least 9000, at least 9500, or at least 10,000 different isolated biomolecules of each of at least 2, at least 3, at least 4, at least 5, at least 6, at least 7, at least 8, at least 9, or at least 10 biomolecule classes. The collection sometimes comprises, for example, from 2 to 10, 5 to 15, 10 to 20, 15 to 25, 20 to 30, 25 to 35, 30 to 40, 35 to 45, 40 to 50, 45 to 55, 50 to 70, 60 to 80, 70 to 90, 80 to 100, 90 to 110, 100 to 150, 125 to 175, 150 to 200, 175 to 225, 200 to 250, 225 to 275, 250 to 300, 275 to 325, 300 to 400, 350 to 450, 400 to 500, 450 to 550, 500 to 600, 550 to 650, 600 to 700, 650 to 750, 700 to 800, 750 to 850, 800 to 900, 850 to 950, 900 to 1000, 950 to 1050, 1000 to 1100, 1050 to 1150, 1100 to 1300, 1200 to 1400, 1300 to 1500, 1400 to 1600, 1500 to 1700, 1600 to 1800, 1700 to 1900, or 1800 to 2000 biological reagents of at least 2, at least 3, at least 4, at least 5, at least 6, at least 7, at least 8, at least 9, or at least 10 biological reagent classes. The collection sometimes comprises, for example, from 2 to 10, 5 to 15, 10 to 20, 15 to 25, 20 to 30, 25 to 35, 30 to 40, 35 to 45, 40 to 50, 45 to 55, 50 to 70, 60 to 80, 70 to 90, 80 to 100, 90 to 110, 100 to 150, 125 to 175, 150 to 200, 175 to 225, 200 to 250, 225 to 275, 250 to 300, 275 to 325, 300 to 400, 350 to 450, 400 to 500, 450 to 550, 500 to 600, 550 to 650, 600 to 700, 650 to 750, 700 to 800, 750 to 850, 800 to 900, 850 to 950, 900 to 1000, 950 to 1050, 1000 to 1100, 1050 to 1150, 1100 to 1300, 1200 to 1400, 1300 to 1500, 1400 to 1600, 1500 to 1700, 1600 to 1800, 1700 to 1900, or 1800 to 2000 biological reagents of at least two, at least 3, at least 4, at least 5, at least 6, at least 7, at least 8, at least 9, or at least 10 biomolecule classes and/or biological research product classes.

The collection may comprise, for example, at least 2, at least 3, at least 5, at least 7, at least 10, at least 20, at least 25, at least 50, at least 100, at least 200, at least 250, at least 500, at least 750, at least 1000, at least 1100, at least 1200, at least 1300, at least 1400, at least 1500, at least 1750, at least 2000, at least 2250, at least 2500, at least 2750, at least 3000, at least 3500, at least 4000, at least 4500, at least 5000, at least 5500, at least 6000, at least 6500, at least 7000, at least 7500, at least 8000, at least 8500, at least 9000, at least 9500, or at least 10,000 matched biological reagents comprising at least 2, 5, 10, 20, 25, 30, 35, 40, 45, 50, 55, 60, 65, 70, 75, 80, 85, 90, 95, 100, 150, 200, 250, 300, 350, 400, 450, 500, 750, 1000, 1250, 1500, 1750, or 2000 sets of matched biological reagents. The collection may comprise, for example, from 2 to 10, 5 to 15, 10 to 20, 15 to 25, 20 to 30, 25 to 35, 30 to 40, 35 to 45, 40 to 50, 45 to 55, 50 to 70, 60 to 80, 70 to 90, 80 to 100, 90 to 110, 100 to 150, 125 to 175, 150 to 200, 175 to 225, 200 to 250, 225 to 275, 250 to 300, 275 to 325, 300 to 400, 350 to 450, 400 to 500, 450 to 550, 500 to 600, 550 to 650, 600 to 700, 650 to 750, 700 to 800, 750 to 850, 800 to 900, 850 to 950, 900 to 1000, 950 to 1050, 1000 to 1100, 1050 to 1150, 1100 to 1300, 1200 to 1400, 1300 to 1500, 1400 to 1600, 1500 to 1700, 1600 to 1800, 1700 to 1900, 1800 to 2000, 1900-2500, 2000-2500, 2250-2750, 2500-3000, 3750-4250, 4000-4500, 4250-4750, 4500-5000, 4750-5250, 5000-5500, 5250-5750, 5500-6000, 6250-6750, 6500-7500, 7000-8000, 7500-8500, 8000-9000, 8500-9500, or 9000-10000 matched biological reagents comprising 2 to 10, 5 to 15, 10 to 20, 15 to 25, 20 to 30, 25 to 35, 30 to 40, 35 to 45, 40 to 50, 45 to 55, 50 to 70, 60 to 80, 70 to 90, 80 to 100, 90 to 110, 100 to 150, 125 to 175, 150 to 200, 175 to 225, 200 to 250, 225 to 275, 250 to 300, 275 to 325, 300 to 400, 350 to 450, 400 to 500, 450 to 550, 500 to 600, 550 to 650, 600 to 700, 650 to 750, 700 to 800, 750 to 850, 800 to 900, 850 to 950, 900 to 1000, 950 to 1050, 1000 to 1100, 1050 to 1150, 1100 to 1300, 1200 to 1400, 1300 to 1500, 1400 to 1600, 1500 to 1700, 1600 to 1800, 1700 to 1900, or 1800 to 2000 sets of matched biological reagents.

In some embodiments, the invention comprises a combination of two or more matched reagents of at least two biological reagent classes. In some embodiments, the invention comprises a combination of two or more matched reagents of the biological reagent collection of the present invention. In some embodiments, the collection comprises at least 100 different isolated biomolecules of each of at least three biological research product classes. The collection sometimes comprises at least 50, at least 100, at least 150, at least 200, at least 250, at least 300, at least 350, at least 400, at least 450, at least 500, at least 750, or at least 1000 different isolated mammalian biomolecules. In certain embodiments, the collection comprises at least 100 different isolated nucleic acids, at least 100 different isolated proteins encoded by the at least 100 different isolated nucleic acids, at least 100 different antibodies against the at least 100 different proteins, and at least 100 different recombinant cell lines comprising each of the at least 100 different isolated nucleic acids. In certain embodiments, the collection comprises at least 50, at least 100, at least 150, at least 200, at least 250, at least 300, at least 350, at least 400, at least 450, at least 500, at least 750, or at least 1000 different isolated nucleic acids; at least 50, at least 100, at least 150, at least 200, at least 250, at least 300, at least 350, at least 400, at least 450, at least 500, at least 750, or at least 1000 different isolated proteins encoded by the at least 100 different isolated nucleic acids; at least 50, at least 100, at least 150, at least 200, at least 250, at least 300, at least 350, at least 400, at least 450, at least 500, at least 750, or at least 1000 different antibodies against the at least 100 different proteins; and at least 50, at least 100, at least 150, at least 200, at least 250, at least 300, at least 350, at least 400, at least 450, at least 500, at least 750, or at least 1000 different recombinant cell lines comprising each of the at least 50, at least 100, at least 150, at least 200, at least 250, at least 300, at least 350, at least 400, at least 450, at least 500, at least 750, or at least 1000 different isolated nucleic acids. In some embodiments, the collection comprises at least at least 1, at least 2, at least 3, at least 4, at least 5, at least 6, at least 7, at least 8, at least 9, at least 10, at least 15, at least 20, at least 25, at least 30, at least 40, at least 50, at least 75, at least 100, at least 150, at least 200, at least 250, at least 300, at least 350, at least 400, at least 450, at least 500, at least 750, or at least 1000 isolated proteins. In some embodiments, the collection comprises at least at least 1, at least 2, at least 3, at least 4, at least 5, at least 6, at least 7, at least 8, at least 9, at least 10, at least 15, at least 20, at least 25, at least 30, at least 40, at least 50, at least 75, at least 100, at least 150, at least 200, at least 250, at least 300, at least 350, at least 400, at least 450, at least 500, at least 750, or at least 1000 isolated proteins, such as, for example, the isolated proteins listed in the accompanying Table 11. In some embodiments, the collection comprises at least 1, at least 2, at least 3, at least 4, at least 5, at least 6, at least 7, at least 8, at least 9, at least 10, at least 15, at least 20, at least 25, at least 30, at least 40, at least 50, at least 75, at least 100, at least 150, at least 200, at least 250, at least 300, at least 350, at least 400, at least 450, at least 500, at least 750, or at least 1000 isolated proteins categorized as one family or class of proteins, for example, such as the families and classes listed in the accompanying Table 10. In some embodiments, the isolated proteins represent at least 5%, at least 10%, at least 15%, at least 20%, at least 25%, at least 30%, at least 40%, at least 50%, at least 60% at least 70%, at least 80%, or at least 90% of all members of a family or class of proteins, for example, such as the families and classes listed in the accompanying Table 10. A matched reagent collection may include, for example, matched reagents for each of at least 1, at least 2, at least 3, at least 4, at least 5, at least 6, at least 7, at least 8, at least 9, at least 10, at least 15, at least 20, at least 25, at least 30, at least 40, at least 50, at least 75, at least 100, at least 150, at least 200, at least 250, at least 300, at least 350, at least 400, at least 450, at least 500, at least 750, or at least 1000 isolated proteins. A matched reagent collection may include, for example, matched reagents for each of at least 1, at least 2, at least 3, at least 4, at least 5, at least 6, at least 7, at least 8, at least 9, at least 10, at least 15, at least 20, at least 25, at least 30, at least 40, at least 50, at least 75, at least 100, at least 150, at least 200, at least 250, at least 300, at least 350, at least 400, at least 450, at least 500, at least 750, or at least 1000 isolated proteins, such as, for example, those listed in Table 11. A matched reagent collection may include, for example, matched reagents for at least 1, at least 2, at least 3, at least 4, at least 5, at least 6, at least 7, at least 8, at least 9, at least 10, at least 15, at least 20, at least 25, at least 30, at least 40, at least 50, at least 75, at least 100, at least 150, at least 200, at least 250, at least 300, at least 350, at least 400, at least 450, at least 500, at least 750, or at least 1000 isolated proteins categorized as one family or class of proteins. A matched reagent collection may include, for example, matched reagents for isolated proteins that proteins represent at least 5%, at least 10%, at least 15%, at least 20%, at least 25%, at least 30%, at least 40%, at least 50%, at least 60% at least 70%, at least 80%, or at least 90% of all members of a family or class of proteins. Isolated proteins may be, for example, isolated native proteins, isolated recombinant native proteins, or isolated recombinant proteins with post-translational modifications.

Also provided herein are collections of matched biological reagents, comprising at least 5, 10, 20, 25, 30, 35, 40, 50, 75, 100, 150, 200, 250, 300, 350, 400, 450, 500, 550, 600, 650, 700, 750, 800, 850, 900, 950, or 1000 matched biological reagents, wherein the collections comprises at least 1, 2, 3, 4, 5, 10, 20, 25, 30, 35, 40, 45, 50, 55, 60, 65, 70, 75, 80, 85, 90, 95, 100, 150, 200, 250, 300, 350, 400, 450, or 500 sets of matched biological reagents. Also provided herein are suites of matched biological reagents, comprising at least 5, 10, 20, 25, 30, 35, 40, 50, 75, 100, 150, 200, 250, 300, 350, 400, 450, 500, 550, 600, 650, 700, 750, 800, 850, 900, 950, or 1000 matched biological reagents, wherein the suites comprise at least 1, 2, 3, 4, 5, 10, 20, 25, 30, 35, 40, 45, 50, 55, 60, 65, 70, 75, 80, 85, 90, 95, 100, 150, 200, 250, 300, 350, 400, 450, or 500 sets of matched biological reagents.

Also provided is a method for selling an isolated biomolecule or biological research reagent, comprising presenting to a customer an input function for identifying a target biological molecule; and presenting to the customer a graphical representation of a biological pathway comprising the target biological molecule and a visual link presented within the graphical representation of the biological pathway, the visual link providing access to a purchase function of one or more biological reagents related to the target biological molecule. In some aspects of the invention, a plurality of visual links are presented within the graphical representation of the biological pathway, each visual link providing access to a purchase function of one or more biological reagents related to a biological molecule. The biological reagent may be, for example, any of the biological reagents of the present application, including, for example, an antibody, an RNAi, a nucleic acid, a protein, a cell culture medium, a detection product, a separation medium, or a microarray. The present invention also provides a method for selling an isolated biological reagent, comprising: presenting to a customer an input function comprising a data entry field or a selectable list of entries, wherein a target biomolecule is identified using the input function; presenting to the customer a graphical representation of a biological pathway comprising the target biological molecule and a visual link related to the target biological molecule, and presenting to the customer a purchasing function accessed via the visual link, wherein the purchasing function is used by the customer to purchase a biological reagent related to the target biomolecule. In one aspect, a plurality of visual links are presented within the graphical representation of the biological pathway, each visual link providing access to a purchase function of one or more biological reagents related to the target biological molecule. The biological reagent may be, for example, any of the biological reagents of the present application, including, for example, an antibody, an RNAi, a nucleic acid, a protein, a cell culture medium, a detection product, a separation medium, or a microarray. The method may further comprise activating the purchasing function to purchase a biological reagent related to the target biomolecule. The method may further comprise shipping the purchased biological reagent to the customer. In some aspects of the invention, the visual link provides access to a set of matched biological reagents related to the target biomolecule. In certain aspects of the invention, the plurality of visual links provide access to a suite of matched biological reagents.

Also provided is a method for selling an isolated biomolecule or biological research reagent, comprising: presenting to a customer an input function for identifying a target biological molecule or target biological pathway; and presenting to the customer a purchasing function comprising links to purchases of at least 10, at least 20, at least 25, at least 50, at least 100, at least 200, at least 250, at least 500, at least 750, at least 1000, at least 1100, at least 1200, at least 1300, at least 1400, at least 1500, at least 1750, at least 2000, at least 2250, at least 2500, at least 2750, at least 3000, at least 3500, at least 4000, at least 4500, at least 5000, at least 5500, at least 6000, at least 6500, at least 7000, at least 7500, at least 8000, at least 8500, at least 9000, at least 9500, or at least 10,000 different individual or different combinations of matched biological reagents of a collection of matched biological reagents comprising at least 10, at least 20, at least 25, at least 50, at least 100, at least 200, at least 250, at least 500, at least 750, at least 1000, at least 1100, at least 1200, at least 1300, at least 1400, at least 1500, at least 1750, at least 2000, at least 2250, at least 2500, at least 2750, at least 3000, at least 3500, at least 4000, at least 4500, at least 5000, at least 5500, at least 6000, at least 6500, at least 7000, at least 7500, at least 8000, at least 8500, at least 9000, at least 9500, or at least 10,000 different isolated biological reagents of each of at least 2, at least 3, at least 4, at least 5, at least 6, at least 7, at least 8, at least 9, or at least 10 biomolecule classes and/or biological research product classes, wherein the isolated biological reagents of the collection are related to the target biomolecule or biomolecular pathway. Certain embodiments are directed to a method for selecting an isolated biomolecule or biological research reagent, comprising: inputting a search parameter into an input function; identifying at least 10, at least 20, at least 25, at least 50, at least 100, at least 200, at least 250, at least 500, at least 750, at least 1000, at least 1100, at least 1200, at least 1300, at least 1400, at least 1500, at least 1750, at least 2000, at least 2250, at least 2500, at least 2750, at least 3000, at least 3500, at least 4000, at least 4500, at least 5000, at least 5500, at least 6000, at least 6500, at least 7000, at least 7500, at least 8000, at least 8500, at least 9000, at least 9500, or at least 10,000 different individual or different combinations of matched biological reagents from a collection of biological reagents comprising at least 10, at least 20, at least 25, at least 50, at least 100, at least 200, at least 250, at least 500, at least 750, at least 1000, at least 1100, at least 1200, at least 1300, at least 1400, at least 1500, at least 1750, at least 2000, at least 2250, at least 2500, at least 2750, at least 3000, at least 3500, at least 4000, at least 4500, at least 5000, at least 5500, at least 6000, at least 6500, at least 7000, at least 7500, at least 8000, at least 8500, at least 9000, at least 9500, or at least 10,000 different biological reagents of each of at least two biomolecule classes and/or biological research product classes, wherein the isolated biological reagents of the collection are related to the search parameter. The search parameter sometimes is selected from the group consisting of a target biological molecule, a target biological pathway, a target biological pathway member, a disease, a disease pathway, and a disease pathway member. The search parameter may also be based on gene ontology, wherein a target biological molecule is searched based on its protein or gene family or class. The biological reagents sometimes are selected from the group consisting of antibodies, RNAi, nucleic acids, enzymes, proteins, cell culture products, detection products, separation media, microarrays, and the like. In some embodiments, the collection comprises at least 500 different isolated biological reagents of each of at least 2, at least 3, at least 4, at least 5, at least 6, at least 7, at least 8, at least 9, or at least 10 biomolecule classes and/or biological research product classes. The collection sometimes comprises at least 100 different isolated biological reagents of each of at least three biological research product classes, and sometimes the collection comprises at least 50, at least 100, at least 150, at least 200, at least 250, at least 300, at least 350, at least 400, at least 450, at least 500, at least 750, or at least 1000 different isolated mammalian biomolecules. In certain embodiments, the collection comprises at least 50, at least 100, at least 150, at least 200, at least 250, at least 300, at least 350, at least 400, at least 450, at least 500, at least 750, or at least 1000 different isolated nucleic acids; at least 50, at least 100, at least 150, at least 200, at least 250, at least 300, at least 350, at least 400, at least 450, at least 500, at least 750, or at least 1000 different isolated proteins encoded by the at least 50, at least 100, at least 150, at least 200, at least 250, at least 300, at least 350, at least 400, at least 450, at least 500, at least 750, or at least 1000 different isolated nucleic acids; at least 50, at least 100, at least 150, at least 200, at least 250, at least 300, at least 350, at least 400, at least 450, at least 500, at least 750, or at least 1000 different antibodies against the at least 50, at least 100, at least 150, at least 200, at least 250, at least 300, at least 350, at least 400, at least 450, at least 500, at least 750, or at least 1000 different isolated proteins; and at least 50, at least 100, at least 150, at least 200, at least 250, at least 300, at least 350, at least 400, at least 450, at least 500, at least 750, or at least 1000 different recombinant cell lines comprising each of the at least 50, at least 100, at least 150, at least 200, at least 250, at least 300, at least 350, at least 400, at least 450, at least 500, at least 750, or at least 1000 different isolated nucleic acids.

Also provided is a method for selling an isolated biological reagent, comprising: presenting to a customer an input function for identifying a target biological molecule; and presenting to the customer a purchasing function comprising a graphical representation of a biological pathway comprising the target biological molecule and a visual link presented within the graphical representation of the biological pathway, the visual link being related to a purchase function of one or more biological reagents related to the target biological molecule. In some aspects of this method, a plurality of visual links are presented within the graphical representation of the biological pathway, each visual link being related to a purchase function of one or more biological reagents related to a biological molecule. The biological reagent may be, for example, but not limited to, an antibody, an RNAi, a nucleic acid, a protein, a cell culture medium, a detection product, a separation medium, or a microarray.

Also provided is a method for selling an isolated biological reagent, comprising: presenting to a customer an input function comprising a data entry field or a selectable list of entries, wherein a target biomolecule is identified using the input function; presenting to the customer a graphical representation of a biological pathway comprising the target biological molecule and a visual link related to the target biological molecule, and presenting to the customer a purchasing function activated by the visual link, wherein the purchasing function is used by the customer to purchase a biological reagent related to the target biomolecule. In some aspects of this method, a plurality of visual links are presented within the graphical representation of the biological pathway, each visual link being related to a purchase function of one or more biological reagents related to a biological molecule. The biological reagent may be, for example, but not limited to, an antibody, an RNAi, a nucleic acid, a protein, a cell culture medium, a detection product, a separation medium, or a microarray. In some aspects of this method, the method further comprises activating the purchasing function to purchase a biological reagent related to the target biomolecule. In some aspects of this method, the method further comprises shipping the purchased biological reagent.

Thus, in a first aspect of the invention is provided a collection of matched biological reagents comprising at least 100 sets of matched biological reagents, wherein each set is associated with a different target biomolecule. In some aspects collection may comprise at least 250, 500, 1000, 2500, 5000, or 10000 sets of matched biological reagents.

In some aspects of the invention, each different target biomolecule is, for example, a different gene, an open reading frame from a gene, a mammalian gene, or a human gene. In some aspects of the invention, the collection includes a set of biological reagents that relate to every known gene of an organism. In some aspects of the invention, the collection includes a set of biological reagents that relate to every known gene of an organism selected from the group of organisms consisting of humans, mouse, rat, E. coli, S. cerevisiae, corn, Arabdopsis, Bacillus, and Drosophila. In some aspects of the invention, the collection includes a set of biological reagents that relate to every known human gene. In some aspects of the invention, the collection includes a set of biological reagents that relate to every human gene. In some aspects of the invention, the sets of the collection are categorized according to a biological pathway in which the target biomolecule is involved. In some aspects of the invention, the sets of the collection are categorized according to a disease state in which the target biomolecule is involved.

In some aspects of the invention, each set of matched biological reagents in a collection comprises 5 different types of biological reagents, each type being a different class of biomolecules and/or a different type of biological research product. In some aspects of the invention, each set of matched biological reagents in a collection comprises 10 different types of biological reagents. In some aspects of the invention, each set of matched biological reagents in a collection comprises at least 25 different types of biological reagents. In some aspects of the invention, each set of matched biological reagents in a collection comprises 100 different types of biological reagents. In some aspects of the invention, each set of matched biological reagents in a collection comprises 1000 different types of biological reagents.

In some aspects of the invention, the biological reagents comprise isolated biomolecules. The isolated biomolecules in a set may, for example, comprise proteins and nucleic acids. The isolated biomolecules in a set may, for example, comprise antibodies, RNAi, RNA, DNA, enzymes, and peptides. The isolated biomolecules in a set may, for example, comprise antibodies, RNA, DNA, and enzymes. The isolated biomolecules in a set may, for example, comprise antibodies, isolated proteins, RNA, DNA, and enzymes. The biological reagents may, for example, comprise biological research products. The biological reagents in a set may, for example, comprise cell culture media, detection products, separation media, and microarrays.

In some aspects of the invention, the collection comprises at least 500 different isolated biomolecules. In some aspects of the invention, the collection comprises at least 1,000 different isolated biomolecules. In some aspects of the invention, the collection comprises at least 10,000 different isolated biomolecules. In some aspects of the invention, the collection comprises at least 25,000 different isolated biomolecules. In some aspects of the invention, the isolated biomolecules are human biomolecules or selectively bind to human biomolecules.

In some aspects of the invention, the collection comprises at least 100 different isolated nucleic acids, at least 100 different isolated proteins encoded by the at least 100 different isolated nucleic acids, at least 100 different antibodies against the at least 100 different proteins, and at least 100 different recombinant cell lines comprising each of the at least 100 different isolated nucleic acids. In some aspects of the invention, the collection comprises at least 1000 different isolated nucleic acids, at least 1000 different isolated proteins encoded by the at least 1000 different isolated nucleic acids, at least 1000 different antibodies against the at least 1000 different proteins, and at least 1000 different recombinant cell lines comprising each of the at least 1000 different isolated nucleic acids. In some aspects of the invention, the collection further comprises at least 100 different primer pairs for amplifying the at least 100 different isolated nucleic acids. In some aspects of the invention, the collection further comprises at least 1000 different primer pairs for amplifying the at least 1000 different isolated nucleic acids.

Also provided in the present invention is a method for selling a target biological reagent, comprising: presenting to a customer an input function for identifying a target biomolecule from a plurality of biomolecules; identifying a target set of matched biological reagents that relate to the target biomolecule, wherein the target set of matched biological reagents is identified by using information input by the customer using the input function to search a database of information regarding a collection of matched biological reagents comprising at least 100 sets of matched biological reagents, wherein each set is associated with a different target biomolecule of the plurality of biomolecules; and presenting to the customer a purchasing function comprising links to purchase the matched biological reagents, wherein the target biological reagent is a biological reagent of the target set of matched biological reagents. The collection used in this method for selling a target biological reagent may comprise, for example, any of the collections of the present invention. The collection used in this method for selling a target biological reagent may comprise, for example, any of the sets of the present invention.

In some aspects of the present invention, the search identifies at least one biological element and the matched biological reagents of the collection are associated with at least one of the identified biological elements. In some aspects of the present invention, a plurality of target sets are identified, wherein said target sets are associated with target biomolecules that are members of a common biological pathway. In some aspects of the present invention, said target sets are presented to the customer as linked to a map of said biological pathway. In some aspects of the present invention, a plurality of target sets are identified, wherein said target sets are associated with target biomolecules that are categorized according to the same gene ontology. In some aspects of the present invention, the input function provides the customer with an option to browse by ontology, wherein the customer may select from a plurality of categories of gene ontology in order to identify a target biomolecule or a plurality of target biomolecules. The categories may, for example, be selected from the group consisting of biological process, cellular component, or molecular function. The categories may, for example, be associated with subcategories. The categories may, for example, be associated with species designations. In some aspects of the present invention the search identifies at least one biological element and the matched biological reagents of the collection are associated with at least one of the identified biological elements.

The present invention also provides a method for selecting a biological reagent from a collection of matched biological reagents, comprising: inputting a search parameter into an input function for identifying a target biomolecule from a plurality of biomolecules; identifying a target set of matched biological reagents that relate to the target biomolecule, wherein the target set of matched biological reagents is identified by searching a database of information regarding a collection of matched biological reagents comprising at least 100 sets of matched biological reagents, wherein each set is associated with a different target biomolecule of the plurality of biomolecules; and selecting at least one biological reagent from said target set of matched biological reagents. The search parameter may, for example, be selected from the group consisting of a the name or structure of a target biological molecule, a target biological pathway, a target biological pathway member, a disease, a disease pathway, and a disease pathway member. The collection used in this method for selling a target biological reagent may comprise, for example, any of the collections of the present invention. The collection used in this method for selling a target biological reagent may comprise, for example, any of the sets of the present invention. In some aspects, the search identifies at least one biological element and the matched biological reagents of the collection are associated with at least one of the identified biological elements. In some aspects, a plurality of target sets are identified, wherein said target sets are associated with target biomolecules that are members of a biological pathway in which the input target biomolecule is involved. In some aspects, said target sets are presented to the customer as linked to a map of said biological pathway. In some aspects, a plurality of target sets are identified, wherein said target sets are associated with target biomolecules that are categorized according to the same gene ontology. In some aspects, said input function provides the customer with an option to browse by ontology, wherein the customer may select from a plurality of categories of gene ontology in order to identify a target biomolecule. In some aspects, the categories are selected from the group consisting of biological process, cellular component, or molecular function. In some aspects, the categories are associated with subcategories. In some aspects, the categories are associated with species designations. In some aspects, the search identifies at least one biological element and the matched biological reagents of the collection are associated with at least one of the identified biological elements.

Also provided in the present invention is a method for selling an isolated biological reagent, comprising: presenting to a customer an input function for identifying a target biological molecule; and presenting to the customer a graphical representation of a biological pathway comprising the target biological molecule and a visual link presented within the graphical representation of the biological pathway, the visual link providing access to a purchase function of one or more biological reagents related to the target biological molecule. In some aspects, a plurality of visual links are presented within the graphical representation of the biological pathway, each visual link providing access to a purchase function of one or more biological reagents related to a biological molecule. In some aspects, the biological reagent is an antibody, an RNAi, a nucleic acid, a protein, a cell culture medium, a detection product, a separation medium, or a microarray. In some aspects, the biological reagents associated with said purchase function are members of target sets of matched biological reagents, wherein said target sets are identified by searching a database of information regarding a collection of matched biological reagents comprising at least 100 sets of matched biological reagents, wherein each set is associated with a different target biomolecule of a plurality of biomolecules. The method for selling an isolated biological reagent may, for example, comprise the use of any of the collections of the present invention. The method for selling an isolated biological reagent may, for example, comprise the use of any of the sets of the present invention. In some aspects, the search identifies at least one biological element and the matched biological reagents of the collection are associated with at least one of the identified biological elements.

The present invention also provides a method for selling a biological reagent, comprising: presenting to a customer an input function comprising a data entry field or a selectable list of entries, wherein a target biomolecule is identified using the input function; presenting to the customer a graphical representation of a biological pathway comprising the target biological molecule and a visual link related to the target biological molecule, and presenting to the customer a purchasing function accessed via the visual link, wherein the purchasing function is used by the customer to purchase a biological reagent related to the target biomolecule. In some aspects, a plurality of visual links are presented within the graphical representation of the biological pathway, each visual link providing accesss to a purchase function of one or more biological reagents related to the target biological molecule. In some aspects, the biological reagent is an antibody, an RNAi, a nucleic acid, a protein, a cell culture medium, a detection product, a separation medium, or a microarray. In some aspects, the method further comprises activating the purchasing function to purchase a biological reagent related to the target biomolecule. In some aspects, the method further comprises shipping the purchased biological reagent to the customer. In some aspects, the visual link provides access to a set of matched biological reagents related to the target biomolecule. In some aspects, the plurality of visual links provide access to a suite of matched biological reagents. In some aspects, the biological reagents associated with said purchase function are members of target sets of matched biological reagents, wherein said target sets are identified by searching a database of information regarding a collection of matched biological reagents comprising at least 100 sets of matched biological reagents, wherein each set is associated with a different target biomolecule of a plurality of biomolecules. The method for selling an isolated biological reagent may, for example, comprise the use of any of the collections of the present invention. The method for selling an isolated biological reagent may, for example, comprise the use of any of the sets of the present invention. In some aspects, the search identifies at least one biological element and the matched biological reagents of the collection are associated with at least one of the identified biological elements.

Also provided in the present invention is a collection of at least 100 expressed and isolated human proteins selected from the group of human proteins listed in Table 1, Table 7, Table 8, Table 9, and Table 10. The collection may comprise, for example, at least 500, at least 100, at least 2000, or at least 3000, expressed and isolated human proteins. In some aspects, the proteins are contained in more than one vessel. In some aspects, the proteins are immobilized on a solid support. In some aspects, each protein is contained in a separate vessel.

The present invention also provides methods of accessing biological content and their biologically related products and/or services using one or more electronic inventory files, preferably stored on a compact electronic storage medium. For example, an inventory file is stored on one or more electronic storage media, which may include a number of target items that are separated into various groupings according to their informational format and/or content. In one embodiment, the method includes interfacing by a user or client by way of user terminals and bi-directional communication connections with a server which includes or accesses the electronic storage medium. Further, extracts, which include biological attribute annotations, are generated in the server for each target item stored on the medium by inputting an appropriate request, subsequently the extracts may be retrieved.

Such extracts may contain, but are not limited to, separate categories having one or more data registries or loci which correspond to, for example, headings for organisms, nucleotide accession numbers, related accession numbers, gene names, gene definitions, gene symbols, text summary of gene products, expression profiles, mRNA records, references, length of inserts in base pairs, nucleic acid sequences, collection names, collection types, vector names, vector antibiotics, host names, Stealth RNA, siRNA, protein accession numbers, protein records, amino acid sequences, molecular weights, isoelectric points, protease digestion patterns, domain searches, predicted secondary and tertiary structures, binding sites, classes of enzymes, classes of substrates, associated proteins (for example, other members of protein complexes), inhibitors, blockers, agonists, antagonists, labels, tags, markers or other indicators, protein model searches, Online Mendelian Inheritance in Man (OMIM) data, product data, metabolic pathway data, single nucleotide polymorphism (SNP) data, SNP map data, locus link ID, Unigene ID and genomic alignment data.

In a related aspect, the target server automatically upon request generates an extract based on the content of an associated target item.

In a related aspect, the loci are associated with annotations or objects which provide hyperlinks to one or more internal and/or external database servers.

The resulting outputs from such methods are displayed as browser pages containing for example, hierarchical menus that are based on the retrieved extracts which provide the user with one or more subsets or compilations of the stored target items. The menus represent assortments of target items within the subsets, where the content and/or format of the displayed target items is based on an empirical measure of similarity of the associated biological attributes for all of the assorted target items. Moreover, the hierarchical menu output display pages identify favored or all target items assorted into each of the files which have one or more associated biological attributes in common to enable a user, for example, to differentiate products and/or services of interest stored on electronic media and to obtain or purchase one or more listed products or services (i.e., custom order, catalog listing or service provided) by activating an appropriate graphic user interface (e.g., a check box) that is included on the displayed output pages. In one aspect, any one menu item output on the displayed format page will contain a buy option graphic user interface (GUI) and one or more of the following, including a clone identification number, definition of the expressed product, gene symbol, and accession number.

In a related aspect, the biologically related products include, but are not limited to, cloned nucleic acid inserts comprising one or more items selected from, for example, an open reading frame, structural gene or transcriptional unit, enzymes, buffers, substrates, cofactors, indicator molecules, bioassay, vectors, antibodies, peptides, synthetic nucleic acid, such as DNA and RNA primers and proteins.

In one aspect, each searchable file for a target item includes, but is not limited to, a unique dataset of named annotated text strings having set elements such as a unique name, or identifier, one or more base texts, biologically related annotations that apply to the base text, and/or gene ontology categories. In a related aspect, the ontology category is selected from the group consisting of a biological process, cell component, and/or molecular function.

In one embodiment, the request may include, but is not limited to, inputting a parsable biological attribute in a sub-window accessible module for entering one or more keywords, annotations, sequences, or unique identification numbers. Further, such requests may be processed as, for example, word-for-word searches, Boolean searches, proximity searches, phrase searches, truncation searches or a combination of the above. In other embodiments, methods may include processing string searches using a Blast server (including, but not limited to, in-house or external server) or keyword jump navigation. Further, such searches may include accessing external databases/servers.

In a related aspect, such request may be input by a variety of means, including but not limited to, manual input devices or direct data entry devices (DDEs). For example, manual devices may include, keyboards, concept keyboards, touch sensitive screens, light pens, mouse, tracker balls, joysticks, graphic tablets, scanners, digital cameras, video digitizers and voice recognition devices. DDEs may include, for example, bar code readers, magnetic strip codes, smart cards, magnetic ink character recognition, optical character recognition, optical mark recognition, and turnaround documents. In one embodiment, an output from a gene or a protein chip reader my serve as an input signal.

In another related aspect, the biological attributes may include, but are not limited to, nucleic acid or amino acid sequences, molecular weights, isoelectric points, metabolic and signal pathway participation, restriction maps, organisms, protease fragments, epitopes, hydropathic profiles, separation patterns, such as electrophoresis gels, chromatographic output, mass spec output, fluorescence data, tissue distributions, expression patterns, kinetic constants, binding constants, antagonists, agonists, inverse agonists, linkage maps, substrates, ligands, inhibitors, disease associations, alleles, homologies, interacting molecules, biological functions, phosphorylation patterns, sub-cellular localizations, glycosylation patterns, post-translational modification patterns, motif consensus, crystal structures, pharmacokinetic properties, pharmacologic properties, toxicologic properties, secondary, tertiary and/or quaternary structures.

In one embodiment, when a GUI is activated by the user, the activation triggers the content of the page to be transmitted to a purchase database server. Moreover, the purchase server verifies the transmission to be an order for the product associated with the activated GUI, and subsequently, the verified order is assigned a job number or identifier by the purchase server. Further, the purchase server may enter the verified order and store items selected by the user in a shopping cart database, and thereafter, the purchase server may update the shopping cart database preferably in real time to synchronize the shopping cart database with any incoming transmissions.

In a related aspect, a user can be identified by comparing the customer information in the purchase server with previously-stored customer database information and indicate if a match exists between a customer name field on the transmitted data (e.g., personal names, company names, addresses, institutional names, pass codes, passwords, user IDs, etc.) and the previously-stored customer database information stored on the purchase server (names, addresses, preferences, purchase patterns, last visited site dates, last order dates, etc.).

In another related aspect, customer information can be added to the purchase server customer database when there is not a match between the stored information and that contained in a customer name field.

In another embodiment, transmission to the purchase server can be used to identify the user with a unique session identifier, including embedding the unique session identifier in a universal resource locator (URL). The information can be used to store the user activity in the purchase server, and associate such activity with the session identifier.

In another embodiment, a method of offering a product or service to a user in a remote location is envisaged, including remotely providing access to an electronic data server to a user where the server receives input from a user and processes the input to produce a first output, based on interfacing with one or more public consortium databases, where the latter database has one or more databases which are, for example, proprietary to an offerer of the product or service. The user can select one or multiple products or services or a link or description of a product or service to create an extract, where the extract serves as an output for the user, thus, facilitating delivery of a product or service to the user, whether delivery is remote or local to the offerer/user. In a related aspect, the choice of delivery may be that of the offerer or user.

In a related aspect, the first service may be delivering information to the user, where the product may be a data product. Further, Internet link, electromagnetic wave signal, metallic conductor, or fiber optic cable may provide such remote access.

In another related aspect, a packing function may be facilitated by the method as envisaged (e.g., where special packing requirements are necessary).

In another related aspect, the creation of an extract results in the generation of a message, where such a message is transmitted to a recipient other than the user, including transmission to inventory control, to trigger information related to a manufacturing request or schedule. Further, such a message may relate to compliance with an internal corporate procedure or regulation, a governmental procedure or regulation, or a financial control mechanism. Moreover, such a message is envisaged to be transmissible to a sales representative or may be incorporated into a database tracker for understanding user activity related to an offering/promotion.

The method as envisaged can be used with servers that are either in-house servers, public servers or other private servers. For example, the public server may include a government institution, a private institution, a college or university, a consortium or a private individual. Other databases may include data related to inventory, shippers, seasonal or regional requirements, credit history, hazardous products and interactions, notifications associated with making dangerous or hazardous products, warning flags, etc.

In certain embodiments, provided herein is a method for selling a target biological reagent based on a workflow. For example, the method can include presenting to a customer an input function for identifying a research objective, a workflow, and/or an application of a workflow. Next, a target set of matched biological reagents is identified from a collection of sets of matched biological reagents based on the identified research objective, application, and/or workflow. The target set of matched biological reagents is typically identified by searching a database of information regarding a collection of matched biological reagents that includes at least 2, 3, 4, 5, 6, 7, 8, 9, 10, 15, 20, 25, 50, 75, 100, 125, 150, 200, 250, 500, or 1000 sets of matched biological reagents, wherein each set is associated with a different workflow. In other examples, the collection can include 2-1000, 10-500, 25-250, or 5-50 sets of matched biological reagents. Each set can include at least 2, 3, 4, 5, 6, 7, 8, 9, 10, 15, 20, 25, 50, 75, 100, 125, 150, 200, 250, 500 or 1000 types of biological reagents. In other examples, the set can include 2-1000, 10-500, 25-250, or 5-50 types of iological reagents. A purchasing function is then presented to the customer, which includes links to purchase the matched biological reagents, wherein the target biological reagent is a biological reagent of the target set of matched biological reagents. Typically, for this embodiment, the target set of matched biological reagents are a set of matched biological research products.

In certain aspects of this embodiment, identification of a target set of matched reagents, takes into account a discipline of the identified research objective or workflow. For example, the discipline can be genomics, such as functional genomics, or proteomics, such as functional proteomics.

In certain aspects of this embodiment, and all embodiments presented herein, as illustrated in Example 7, a customer profile, or user profile, can be used to assist in identifying a target set of matched biological reagents. The customer background, can include, for example, a technical background of a customer, an employer of the customer, or an ordering history of a customer. In certain aspects, the customer profile is automatically updated using ordering information of a customer.

In certain examples, each set of matched biological reagents is matched to a different application related to a workflow. Furthermore, the order of applications within a workflow can be used to identify a set of matched biological reagents. Additionally, each application can be related to a set of matched biological reagents by associating the application to a technology or method that is related to the set of matched biological reagents.

As a non-limiting example, the workflow can be gene expression profiling, protein expression profiling, RNAi, or protein-protein interactions.

Illustrative examples of workflows, applications, technologies and methods, and associated biological research products is presented in FIGS. 27-30 As an illustrative example, a gene expression profiling workflow (FIG. 27) can include the following the sequence of applications: a gene expression method, microarray selection, RNA purification, RNA quality control, cDNA and aRNA synthesis and labeling, hybridization, microarray scanning, image analysis, data analysis and interpretation, data validation, and downstream workflows. Downstream workflows can be used to associate and order separate workflows. FIG. 28 provides a flow chart of a protein expression profiling workflow within a functional proteomics discipline. This workflow can follow the gene expression profiling workflow, in illustrative aspects. In FIGS. 27-30 the first row of text boxes provides illustrative applications, the second row provides exemplary technologies and methods, and the third row provides exemplary products and tools. FIG. 29 provides a diagram of gene RNAi analysis workflow within an RNAi discipline. FIG. 30 provides a diagram of protein-protein interaction workflow within a functional proteomics discipline.

### BRIEF DESCRIPTION OF THE FIGURES

FIG. 1. Illustration of networked computer system.

FIG. 2. Illustration of data set entry.

FIG. 3. Window for Shopping Cart/Purchase Order.

FIG. 4. Window for search browser.

FIG. 5. Flow chart for processing search.

FIG. 6. Block diagram of Index File and File Map.

FIG. 7. Illustration of network search flow for Keyword, Sequence and ID searching.

FIG. 8. Flow chart for Purchase processing.

FIG. 9. Flow chart for processing keyword search.

FIG. 10. Browser window for Keyword and/or ID search.

FIG. 11. Results window for Keyword search.

FIG. 12. Results window for ID search.

FIG. 13. Browser window for Sequence search.

FIGS. 14A-14C. Results window for Sequence search.

FIG. 15. Browser window for Ontology search.

FIG. 16. Illustration of network search flow for Gene Ontology searching.

FIGS. 17A-17Q. Table of examples of siRNA reagents that may be comprised in collections of matched biological reagents. Information for each siRNA in the table is organized in the following order: siRNA designation, catalog no., target gene symbol, definition, primary target accession, other target accession identifiers.

FIGS. 18A-18E. List of examples of cell culture products that may be comprised in collections of matched biological reagents.

FIG. 19. A diagrammatical rendition of a non-limiting list of various types of matched reagents that can be included in a collection and methods of the present invention.

FIG. 20: Browser window for performing search of database that includes pathway information and other biological information.

FIG. 21: Results window after performing database search.

FIG. 22: Pathway tree window grouping pathways based on function).

FIG. 23: Graphical display of a target pathway.

FIG. 24: Annotation window of detailed gene information.

FIG. 25: Public database access window.

FIG. 26: Products results window for pathway search with check boxes for ordering listed products.

FIGS. 27A-27B: Diagram of gene expression profiling workflow within a functional genomics discipline. The first row of text boxes provides illustrative applications, the second row provides exemplary technologies and methods, and the third row provides exemplary products and tools.

FIGS. 28A-28B: Diagram of protein expression profiling workflow within a functional proteomics discipline. This workflow can follow the gene expression profiling workflow, in illustrative aspects. The first row of text boxes provides illustrative applications, the second row provides exemplary technologies and methods, and the third row provides exemplary products and tools.

FIG. 29. Diagram of gene RNAi analysis workflow within an RNAi discipline. The first row of text boxes provides illustrative applications, the second row provides exemplary technologies and methods, and the third row provides exemplary products and tools.

FIGS. 30A-30B. Diagram of protein-protein interaction workflow within a functional proteomjics discipline. The first row of text boxes provides illustrative applications, the second row provides exemplary technologies and methods, and the third row provides exemplary products and tools.

The present application incorporates by reference herein, in their entirety, each of the following files encoded on a recordable compact disk (CD-R) filed herewith on 22 Apr. 2005: Table 1, which is contained in the file named “Table 1,” (size 3,427 KB, created Feb. 10, 2005), Table 2, which is contained in the file named “Table 2” (size 7,350 KB, created Feb. 10, 2005), Table 3, which is contained in the file named “Table 3” (size 4,037 KB, created Feb. 10, 2005), Table 4, which is contained in the file named “Table 4” (size 2 KB, created Feb. 10, 2005), Table 5, which is contained in the file named “Table 5” (size 63 KB, created Feb. 10, 2005), Table 6, which is contained in the file named “Table 6” (size 3 KB, created Feb. 10, 2005), Table 7, which is contained in the file named “Table 7” (size 70 KB, created Feb. 10, 2005), Table 8, which is contained in the file named “Table 8” (size 4 KB, created Feb. 10, 2005), Table 9, which is contained in the file named “Table 9” (size 849 KB, created Feb. 10, 2005), Table 10, which is contained in the file named “Table 10” (size 2051 KB; created Mar. 25, 2005), Table 11, which is contained in the file named “Table 11” (size 1,316 KB; created Mar. 25, 2005). Table 12, which is contained in the file named “Table 12” (size 173 KB, created Apr. 22, 2005). Each of these files is included on the CD-R filed herewith in duplicate labeled as “Copy 1,” and “Copy 2.

### DETAILED DESCRIPTION OF THE INVENTION

Provided are collections of biological reagents matched to one or more input biological elements. Such collections of matched biomolecules and/or biological reagents are generated by sorting a larger collection of such molecules by one or more search parameters. These collections of matched reagents and methods for selecting them are useful in part for identifying a subset of research products from a larger collection of products that are suited to effecting a particular research objective. Such collections of matched reagents also are useful for selecting pertinent biological research reagents for purchase.

Certain terms utilized herein are defined hereafter.

Clone Collection: As used herein, “clone collection” refers to two or more nucleic acid molecules, each of which comprises one or more nucleic acid sequences of interest.

Customer: As used herein, the term customer refers to any individual, institution, corporation, university, or organization seeking to obtain genomic and proteomic products and services.

Provider: As used herein, the term provider refers to any individual, institution, corporation, university, or organization seeking to provide genomic and proteomic products and services.

Subscriber: As used herein, the term subscriber refers to any customer having an agreement with a provider to obtain public and private genomic and proteomic products and services at subscriber rates.

Non-subscriber: As used herein, the term non-subscriber refers to any customer who does not have an agreement with a provider to obtain public and private genomic and proteomic products and services at subscriber rates.

Host: As used herein, the term “host” refers to any prokaryotic or eukaryotic (e.g., mammalian, insect, yeast, plant, avian, animal, etc.) cell and/or organism that is a recipient of a replicable expression vector, cloning vector or any nucleic acid molecule. The nucleic acid molecule may contain, but is not limited to, a sequence of interest, a transcriptional regulatory sequence (such as a promoter, enhancer, repressor, and the like) and/or an origin of replication. As used herein, the terms “host,” “host cell,” “recombinant host” and “recombinant host cell” may be used interchangeably. For examples of such hosts, see Sambrook, et al., Molecular Cloning: A Laboratory Manual, Cold Spring Harbor Laboratory, Cold Spring Harbor, N.Y.

Related products or services. As used herein, the phrase “related product or service” refers to a product or service that relates to a region of a biomolecule, or an entire biomolecule, presented to a customer. The related product or service is typically used to study a biomolecule and can be related to the biomolecule based on, for example, a biomolecular class of the biomolecule. As a non-limiting example, if a target biomolecule is a protein, then a related product or service can be a polyacrylamide gel for studying the protein, or a kinase substrate identification assay for determining whether the target biomolecule is a substrate for a kinase. Furthermore, the related product or service can be identified not only based on a biomolecular class of the biomolecule, but also, based on one or more specific attributes of the target biomolecule. For example, a polyacrylamide gel related to a biomolecule that is a protein, can be a specific formulation of gel depending on the size of the target biomolecule, for example a 10% polyacrylamide bis-tris gel. Furthermore, the related product or service can be related specifically to the identified biomolecule. For example, where the identified biomolecule is P53, a related product or service can include an antibody against p53, one or a set of siRNA against P53, a clone encoding P53, a transgenic animal mutated in the P53 gene, one or more kinases that phosphorylate P53, or one or more proteins that bind P53. A directly related product or service is a product or service that relates to an entire biomolecule presented to a customer. For example, if an in silico vector design experiment is design of a primer, then a link to a service for synthesizing the primer presented to the customer by the in silico primer design function, is a directly related product.

As used herein, the phrase “indirectly related product” refers to a product that relates to a region or feature of a biomolecule presented to a customer, but is not an entire biomolecule presented to a customer. In one embodiment of the invention, an indirectly related product refers to a portion or feature of the entire biomolecule, but the product is less then the entire biomolecule. In another embodiment, the indirectly related product may be peripheral to the specifically identified biomolecule, but related to the identified biomolecule in the sense that the product or service is useful and/or necessary in accomplishing the ultimate experimental goals of the researcher. For example, in an in silico vector design experiment, a link to an indirectly related product may be a link to the purchase of an antibiotic that corresponds to an antibiotic resistance gene that is on a vector that is designed by the in silico biotechnology experiment design and simulation function. A Table listing exemplary features and associated products is attached hereto (Table 2). From the specific product listing, general classes of products are revealed that can be used with the methods provided herein.

The phrase “indirectly related service” refers to a service that relates to a step, biomolecule, portion of a biomolecule, or feature of a biomolecule, provided by an in silico design or simulation experiment, but is not an entire step of the in silico design or simulation experiment that resulted in the presentation of the service to the customer. Furthermore, an indirectly related service can be related to a region of a biomolecule presented to a customer by the in silico design and simulation function, but is not synthesis of the entire biomolecule present to the customer.

Collections of Biological Reagents

The term “biological reagents” as used herein generally refers to isolated biomolecules and biological research products utilized in biological research procedures. Biomolecules include but are not limited to various classes of biomolecules, including, but not limited to, proteins, peptides, antibodies, nucleic acids, nucleotides, carbohydrates, and variants of the foregoing, for example. For example, nucleic acids can include, but are not limited to, open reading frames, structural genes, or transcription units. Two target biomolecules are “different” when they are structurally different. For example, two different nucleic acids have different nucleotide sequences. Two different proteins have different amino acid sequences. Biomolecules may be categorized into families or subclasses based on, for example, a function of the related protein or nucleic acid, such as the functions of the proteins presented in, for example, Table 10, or, for example, based on the activity of the related protein or nucleic acid, such as those having enzyme classifications (for illustrative purposes only, a protein kinase family may have various subclasses of protein kinases, such as, for example, tyrosine kinases and serine/threonine kinases, each subclass can itself be further subdivided into narrower subclasses). In certain embodiments, the target biomolecule or a protein encoded by the target biomolecule (for example, when the target biomolecule is a nucleic acid encoding a protein) is a signal transduction factor, cell proliferation factor, apoptosis factor, angiogenesis factor, or cell interaction factor. Examples of cell interaction factors include but are not limited to cadherins (e.g., cadherins E, N, BR, P, R, and M; desmocollins; desmogleins; and protocadherins); connexins; integrins; proteoglycans; immunoglobulins (e.g., ALCAM, NCAM-1 (CD56), CD44, intercellular adhesion molecules (e.g., ICAM-1 and ICAM-2), LFA-1, LFA-2, LFA-3, LECAM-1, VLA-4, ELAM and N-CAM); selectins (e.g., L-selectin (CD62L), E-selectin (CD62e), and P-selectin (CD62P)); agrin; CD34; and a cell surface protein that is cyclically internalized or internalized in response to ligand binding. Examples of signal transduction factors include but are not limited to protein kinases (e.g., mitogen activated protein (MAP) kinase and protein kinases that directly or indirectly phosphorylate it, Janus kinase (JAK1), cyclin dependent kinases, epidermal growth factor (EGF) receptor, platelet-derived growth factor (PDGF) receptor, fibroblast-derived growth factor receptor (FGF), insulin receptor and insulin-like growth factor (IGF) receptor); protein phosphatases (e.g., PTP1B, PP2A and PP2C); GDP/GTP binding proteins (e.g., Ras, Raf, ARF, Ran and Rho); GTPase activating proteins (GAFs); guanine nucleotide exchange factors (GEFs); proteases (e.g., caspase 3, 8 and 9), ubiquitin ligases (e.g., MDM2, an E3 ubiquitin ligase), acetylation and methylation proteins (e.g., p300/CBP, a histone acetyl transferase) and tumor suppressors (e.g., p53, which is activated by factors such as oxygen tension, oncogene signaling, DNA damage and metabolite depletion). The protein sometimes is a nucleic acid-associated protein (e.g., histone, transcription factor, activator, repressor, co-regulator, polymerase or origin recognition (ORC) protein), which directly binds to a nucleic acid or binds to another protein bound to a nucleic acid. In certain embodiments, the target biomolecule or the protein related to the target biomolecule is a growth factor receptor, hormone receptor, neurotransmitter receptor, catecholamine receptor, amino acid derivative receptor, cytokine receptor, extracellular matrix receptor, antibody, lectin, cytokine, serpin, protease, kinase, phosphatase, ras-like GTPase, hydrolase, steroid hormone receptor, transcription factor, heat-shock transcription factor, DNA-binding protein, zinc-finger protein, leucine-zipper protein, homeodomain protein, intracellular signal transduction modulator, intracellular signal transduction effector, apoptosis-related factor, DNA synthesis factor, DNA repair factor, DNA recombination factor, cell-surface antigen, hepatitis C virus (HCV) protease or HIV protease.

Biological research products include various types of biological research products, protocols, instruments, and services, including, but not limited to, products such as, for example, cell culture products, detection products, separation media and systems, and microarrays, for example; services, such as, for example, nucleic acid synthesis, vector construction, and performance of one or more assays; protocols such as a protocol for constructing a vector, performing an assay, or making a monoclonal antibody; or instruments such as mass spectrometers, microscopes, or microfluidic devices. Further examples of biological research products include but are not limited to gels, enzymes, buffers, substrates, cofactors, indicator molecules, bioassays, vectors, synthetic nucleic acids (e.g., DNA and RNA primers and pairs of primers), cloning reagents, PCR reagents, cell culture products, and reagents needed for bioassays. Biological reagents are described in greater detail hereafter.

A biological research product or isolated biomolecule, can include, for example, any of the biological research products, services, instruments, protocols, or isolated biomolecules in the collection of biological research products, services, protocols, instruments, and isolated biomolecules available from a commercial biological research reagent, service, and/or instrument provider. A biological research product or isolated biomolecule, can include, for example, any of the biological research products, services, protocols, or isolated biomolecules in the collection of biological research products, services, protocols, and isolated biomolecules disclosed at and linked to the Internet site available on the worldwide web at the URL invitrogen.com, which Internet site is incorporated by reference in its entirety on the date this application is filed, and available in the 2005 catalog of Invitrogen Corporation (Carlsbad, Calif.), which is incorporated by reference in its entirety on the date this application is filed, the 2005 catalog of Dynal Biotech (Oslo, Norway), which is incorporated by reference in its entirety on the date this application is filed, and the 2005 catalog of Zymed, Inc. (South San Francisco, Calif., USA).

“Matched biological reagents” include the following: (i) two or more isolated biomolecules that relate to the same gene; (ii) a combination of one or more isolated biomolecules that relate to the same gene and one or more biological research products that are used to study the gene, (iii) biological research products that are used to study a class of biomolecules and/or a sub-class of biomolecules and optionally one or more isolated biomolecules of the class of biomolecules and/or sub-class of biomolecules and that relate to the same gene, (iv) biological research products that are used in the same or subsequent steps of a workflow and optionally one or more isolated biomolecules studied using the workflow and that relate to the same gene, and (v) biological research products that are used to study a disease and optionally isolated biomolecules that are involved in the disease, such as isolated biomolecules involved in a pathway of the disease. A set of matched biological reagents includes more than one type of matched biological reagent. Fifty sets of matched biological reagents, for example, can include 50 isolated proteins, 50 nucleic acids each encoding a different one of the 50 isolated proteins, and 50 antibodies each recognizing a different one of the isolated proteins. In this example, 3 classes of biomolecules make up one set of matched reagents. The sets, in this example, can be further expanded to include, for example, biological research products, such as 2 types of biological research products. The biological research products can be, for example, research products that are used to analyze proteins (e.g., protein gels) and/or research products that are used to analyze nucleic acids (nucleic acid gels) and/or research products that include antibodies (enzyme-linked immunoassay kits). Accordingly, different matched reagent sets can include the same research products. A collection of matched biological reagents includes one or more sets of matched biological reagents.

Sets of biological reagents can be bundled that relate to the same biological pathway or condition. Thus, for example, where two different biomolecules, for example, kinase A and kinase B, have been implicated as being members of a particular biological pathway, sets of matched biological reagents for each of kinase A and kinase B may be bundled in a collection of matched biological reagents. A suite of matched biological reagents thus includes a collection of two or more sets of matched biological reagents where the sets of matched biological reagents include biomolecules that are members of the same biological pathway, are implicated in the same disease, or are members of the same disease pathway. For example, such a suite may include, set 1 and set 2. Set 1 may comprise, for example, protein kinase A, a nucleic acid encoding protein kinase A, an antibody that recognizes protein kinase A, a protein gel, labeled secondary antibodies, and a bioassay kit that measures protein kinase A activity. Set 2 may comprise, for example, protein kinase B, a nucleic acid encoding protein kinase B, an antibody that recognizes protein kinase B, a protein gel, labeled secondary antibodies, and a bioassay kit that measures protein kinase B activity. It is understood that the components of set 1 and set 2 need not be in parallel. For example, set 2 may comprise different biological reagents matched to protein kinase B, for example, a cell line that expresses protein kinase B, cell culture media, an antibody that recognizes protein kinase B, and an siRNA directed against protein kinase B expression.

Proteins, Peptides and Variants Thereof

A protein sometimes is a native full-length protein, a portion of the protein, a polypeptide or a peptide. A portion of a protein includes but is not limited to an N-terminus, C-terminus, extracellular region, intracellular region, transmembrane region, subunit, active site (e.g., nucleotide binding region or a substrate binding region), a domain (e.g., an SH2 or SH3 domain). A protein sometimes comprises a post-translational modification (e.g., phosphorylation, glycosylation or ubiquination), for example.

Protein and peptides sometimes include D-amino acids, L-amino acids, natural amino acids, unnatural or non-classical amino acids, and/or alpha amino acid homologs (e.g., beta²-, beta³- and/or gamma-amino acids). Examples of non-classical amino acids include but are not limited to ornithine (hereinafter referred to as Z), diaminobutyric acid (hereinafter referred to as B), norleucine (hereinafter referred to as O), pyrylalanine, thienylalanine, naphthylalanine, phenylglycine, alpha and alpha-disubstituted amino acids, N-alkyl amino acids, lactic acid, halide derivatives of natural amino acids such as trifluorotyrosine, p-X-phenylalanine (where X is a halide such as F, Cl, Br, or I), allylglycine, 7-aminoheptanoic acid, methionine sulfone, norleucine, norvaline, p-nitrophenylalanine, hydroxyproline, thioproline, methyl derivatives of phenylalanine (Phe) such as 4-methyl-Phe, pentamethyl-Phe, Phe (4-amino), Tyr (methyl), Phe (4-isopropyl), Tic (1,2,3,4-tetrahydroisoquinoline-3-carboxyl acid), diaminopropionic acid, Phe (4-benzyl), 4-aminobutyric acid (gamma-Abu), 2-aminobutyric acid (alpha-Abu), 6-aminohexanoic acid (epsilon-Ahx), 2-aminoisobutyric acid (Aib), 3-aminopropionic acid, norvaline, hydroxyproline, sarcosine, citrulline, homocitrulline, cysteic acid, t-butylglycine, t-butylalanine, phenylglycine, cyclohexylalanine, fluoroamino acids, designer amino acids such as beta-methyl amino acids, and the like.

Variant amino acid sequences sometimes include suitable spacer groups inserted between any two amino acid residues of the sequence, such as alkyl groups (e.g., methyl, ethyl or propyl groups) or amino acid spacers (e.g., glycine or beta-alanine). Peptide moieties sometimes comprise or consist of peptoids. The term “peptoids” refers to variant amino acid structures where the alpha-carbon substituent group is linked to the backbone nitrogen atom rather than the alpha-carbon (e.g., Simon et al., PNAS (1992) 89(20), 9367-9371 and Horwell, Trends Biotechnol. (1995) 13(4), 132-134).

In certain aspects, the proteins of the matched biological reagent collection include the collection of human proteins that can be expressed in vitro. For example, the collection can include at least 100, 200, 250, 300, 400, 500, 600, 700, 750, 800, 900, 1000, 1250, 1500, 1750, 2000, 2250, 2500, 2750, 3000, 3250, 3500, 3750, 4000, 5000, 5500, 6000, 6500, 7000, 7500, 8000, 8500, 9000, 9500, 10,000, or all expressible human proteins. In another aspect, the proteins include 10%, 20%, 25%, 30%, 40%, 50%, 75%, 80%, 90%, 95%, or 99% of all expressible human proteins. By “expressible human protein” is meant that the protein can be expressed at a level of at least 0.1 microgram/ml, at least 0.5 microgram/ml, or at least 1 microgram/ml.

In certain aspects, the proteins, peptides, and variants thereof, are encoded by a portion of, or the entire nucleotide sequence of each nucleotide sequence of a collection of nucleotide sequences that include at least 2, 3, 4, 5, 6, 7, 8, 9, 10, 15, 20, 25, 30, 35, 40, 45, 50, 75, 100, 125, 150, 175, 200, 250, 500, 750, 1000, 1250, 1500, 1750, 2000, 2500, 3000 or all the nucleic acid sequences listed in Table 1 or Table 2, filed herewith on a separate CD. Table 1, filed herewith on CD in the file named “Table 1,” lists the coding sequences encoding 3469 human proteins that have been expressed and isolated at Invitrogen, Inc. using an insect cell system. Table 2, filed herewith, includes coding sequences encoding approximately 7600 human proteins, that include the 3469 coding sequences of Table 1 and coding sequences which are available as part of a commercial clone collection (Invitrogen, Inc., Carlsbad, Calif.), that are similar to those used to express the 3469 clones. In certain embodiments, the proteins of the present invention include isolated forms of at least some of the proteins of Table 9 or Table 11 or the proteins are encoded by all or a portion of the nucleotide sequences of Table 3, or by the nucleotide sequences whose accession numbers are listed in Table 4, Table 5, Table 6, Table 7, or Table 8.

Using a high throughput method, open reading frames encoding the 3469 recombinant human fusion proteins encoded by the nucleotide sequence of Table 1, were cloned, expressed, purified and arrayed. The human cDNAs were cloned into a Gateway entry vector, completely sequence-verified, expressed as GST and/or 6XHis-fusions in a high-throughput baculovirus-based system, and purified using affinity chromatography. The proteins having accession numbers listed in Table 7, Table 8, Table 9 and Table 11 have been cloned and expressed and purified at the concentration indicated in the Tables using a high-throughput insect cell expression system, as well.

In certain aspects of the invention are provided collections of at least 100, 200, 250, 500, 1000, 1500, 2000, 3000, 3200, 3400, 3469, or all of the expressed and isolated human proteins listed in Table 1, Table 7, Table 8, Table 9, or Table 11. In other aspects of the invention are provided collections of at least 100, 200, 250, 500, 1000, 1500, 2000, 3000, 3200, 3400, 3500, 4000, 5000, 6000, 7000, or all of the expressed and isolated human proteins listed in Table 2. The collections of expressed and isolated human proteins may include proteins that are contained in separate vessels, or the proteins of the collections may be immobilized on a solid support, for example, arrayed on a solid support on a high density array. The expressed and isolated proteins may be, for example, expressible in insect cells. Thus, in certain aspects of the invention are provided collections of at least 100, 200, 250, 500, 1000, 1500, 2000, 3000, 3200, 3400, 3469, or all of the expressed and isolated human proteins expressible in insect cells and listed in Table 1, Table 7, Table 8, Table 9, or Table 11. In other aspects of the invention are provided collections of at least 100, 200, 250, 500, 1000, 1500, 2000, 3000, 3200, 3400, 3500, 4000, 5000, 6000, 7000, or all of the expressed and isolated human proteins expressible in insect cells and listed in Table 2.

Antibodies

An antibody sometimes is a complete immunoglobulin or an antibody fragment. Antibodies sometimes are IgG, IgM, IgA, IgE, or an isotype thereof (e.g., IgG1, IgG2a, IgG2b or IgG3), sometimes are polyclonal or monoclonal, and sometimes are chimeric, humanized or bispecific versions of such antibodies. Antibody fragments include but are not limited to Fab, Fab′, F(ab)′2, Dab, Fv and single-chain Fv (ScFv) fragments. Bifunctional antibodies sometimes are constructed by engineering two different binding specificities into a single antibody chain and sometimes are constructed by joining two Fab′ regions together, where each Fab′ region is from a different antibody (e.g., U.S. Pat. No. 6,342,221). Antibody fragments often comprise engineered regions such as CDR-grafted or humanized fragments. Antibodies sometimes are derivitized with a functional molecule, such as a detectable label (e.g., dye, fluorophore, radioisotope, light scattering agent (e.g., silver, gold)) or binding agent (e.g., biotin, streptavidin), for example.

Sets of biological reagents may include, for example, any antibody that recognizes a target biomolecule, and may include, for example, at least one of the antibodies listed in Table 12. Collections of biological reagents may include, for example, at least 1, 5, 10, 25, 50, 75, 100, 200, 300, 400, 500, 600, 700, 800, 900, 1000, 1250, 1500, 1750, 2000, 2050, or all of the antibodies listed in Table 12. Collections of biological reagents may include, for example, from 1-10, 5-25, 20-30, 25-50, 35-100, 50-125, 100-200, 150-250, 200-300, 200-400, 300-500, 400-600, 500-700, 600-800, 700-1000, or all of the antibodies listed in Table 12, which is contained in the file named “Table 12” and included on the CD-R filed herewith, and incorporated by reference herein in its entirety.

Nucleic Acids, Nucleotides and Variants Thereof

A nucleic acid may comprise or consist of DNA (e.g., genomic DNA (gDNA) and complementary DNA (cDNA)) or RNA (e.g., mRNA, tRNA, rRNA, and siRNA). A nucleic acid sometimes comprises or is a clone, vector (e.g., expression vector, shuttle vector, in vitro transcription/translation vector), open reading frame, an untranslated region, a tRNA, a suppressor tRNA, an rRNA, a primer, and an oligonucleotide. A vector sometimes is a plasmid or is linear, and sometimes includes one or more of a selectable marker, an origin of replication, a promoter (e.g., RNA polymerase or DNA polymerase), a PCR primer hybridization site, a topoisomerase linkage site, a recombinase interaction site, a cap, an enhancer and one or more stop codons (e.g., amber stop codon). A nucleotide or nucleoside may be provided in the collection, as well as analogs thereof. In embodiments where the nucleic acid is a synthetic oligonucleotide, the oligonucleotide can be about 8 to about 50 nucleotides in length, often about 8 to about 35 nucleotides in length, and sometimes from about 10 to about 25 nucleotides in length. Nucleic acids may include, for example, any of the nucleic acids disclosed at and linked to http address http://orf.invitrogen.com/cgi-bin/ORF_Browser on the date this patent application is filed, which collection is hereby incorporated by reference in its entirety.

Nucleic acids may comprise or consist of analog or derivative nucleic acids, such as polyamide nucleic acids (PNA) and others exemplified in U.S. Pat. Nos. 4,469,863; 5,536,821; 5,541,306; 5,637,683; 5,637,684; 5,700,922; 5,717,083; 5,719,262; 5,739,308; 5,773,601; 5,886,165; 5,929,226; 5,977,296; 6,140,482; 5,614,622; 5,739,314; 5,955,599; 5,962,674; 6,117,992; WIPO publications WO 00/56746, WO 00/75372 and WO 01/14398, and related publications. Analog or derivative nucleic acids may also include stealth siRNA or other synthetic forms of siRNA. The term “siRNA reagent” comprises siRNA as well as modified forms of siRNA that have additional properties, such as causing a reduced level of induction of the PKR/interferon response pathway, avoidance of stress response to siRNA, higher specificity, or greater stability, compared to non-modified siRNA.

Nucleic acid molecules which can be used in the practice of the invention include interfering RNAs (RNAi) and those which generate RNAi. RNAi is double-stranded RNA (dsRNA) which mediates degradation of specific mRNAs, and can also be used to lower or eliminate gene expression.

RNAi may be produced in cells in vivo or synthesized ex vivo and then introduced into cells. When such molecules are synthesized in cells, they will often be generated by transcription of one or more nucleic acid molecules (e.g., DNA or RNA). A considerable number of expression systems are commercially available and include the BLOCK-IT™ Inducible H1 Lentiviral RNAi System available from Invitrogen Corp., Carlsbad, Calif. (cat. no. K4925-00).

While nucleic acid molecules with any number of different chemical modifications may be used in the practice of the invention, one example of a chemically modified nucleic acid molecule which may be used in the practice of the invention is STEALTH™ RNAi (Invitrogen Corp., Carlsbad, Calif.).

A considerable number of chemically modified nucleic acid molecules, as well as chemical modifications themselves are described in U.S. Patent Publication No. 2004/0014956 (application Ser. No. 10/357,529) and U.S. patent application Ser. No. 11/049,636, filed Feb. 2, 2005), the entire disclosures of which are incorporated herein by reference.

The term “short interfering nucleic acid”, “siNA”, “short interfering RNA”, “siRNA”, “short interfering nucleic acid molecule”, “short interfering oligonucleotide molecule”, or “chemically-modified short interfering nucleic acid molecule” as used herein refers to any nucleic acid molecule directed against a gene, that is, the siRNA is capable of inhibiting or down regulating gene expression or viral replication, for example by mediating RNA interference “RNAi” or gene silencing in a sequence-specific manner; see for example Zamore et al., 2000, Cell, 101, 25-33; Bass, 2001, Nature, 411, 428-429; Elbashir et al., 2001, Nature, 411, 494-498; and Kreutzer et al., International PCT Publication No. WO 00/44895; Zernicka-Goetz et al., International PCT Publication No. WO 01/36646; Fire, International PCT Publication No. WO 99/32619; Plaetinck et al., International PCT Publication No. WO 00/01846; Mello and Fire, International PCT Publication No. WO 01/29058; Deschamps-Depaillette, International PCT Publication No. WO 99/07409; and Li et al., International PCT Publication No. WO 00/44914; Allshire, 2002, Science, 297, 1818-1819; Volpe et al., 2002, Science, 297, 1833-1837; Jenuwein, 2002, Science, 297, 2215-2218; and Hall et al., 2002, Science, 297, 2232-2237; Hutvagner and Zamore, 2002, Science, 297, 2056-60; McManus et al., 2002, RNA, 8, 842-850; Reinhart et al., 2002, Gene & Dev., 16, 1616-1626; and Reinhart & Bartel, 2002, Science, 297, 1831). There is no particular limitation in the length of siRNA as long as it does not show toxicity.

The siNA can be a double-stranded polynucleotide molecule comprising self-complementary sense and antisense regions, wherein the antisense region comprises nucleotide sequence that is complementary to nucleotide sequence in a target nucleic acid molecule or a portion thereof and the sense region having nucleotide sequence corresponding to the target nucleic acid sequence or a portion thereof. The siNA can be assembled from two separate oligonucleotides, where one strand is the sense strand and the other is the antisense strand, wherein the antisense and sense strands are self-complementary (i.e. each strand comprises nucleotide sequence that is complementary to nucleotide sequence in the other strand; such as where the antisense strand and sense strand form a duplex or double stranded structure, for example wherein the double stranded region is about 19 base pairs); the antisense strand comprises nucleotide sequence that is complementary to nucleotide sequence in a target nucleic acid molecule or a portion thereof and the sense strand comprises nucleotide sequence corresponding to the target nucleic acid sequence or a portion thereof. Alternatively, the siNA is assembled from a single oligonucleotide, where the self-complementary sense and antisense regions of the siNA are linked by means of a nucleic acid based or non-nucleic acid-based linker(s). The siNA can be a polynucleotide with a duplex, asymmetric duplex, hairpin or asymmetric hairpin secondary structure, having self-complementary sense and antisense regions, wherein the antisense region comprises nucleotide sequence that is complementary to nucleotide sequence in a separate target nucleic acid molecule or a portion thereof and the sense region having nucleotide sequence corresponding to the target nucleic acid sequence or a portion thereof. The siNA can be a circular single-stranded polynucleotide having two or more loop structures and a stem comprising self-complementary sense and antisense regions, wherein the antisense region comprises nucleotide sequence that is complementary to nucleotide sequence in a target nucleic acid molecule or a portion thereof and the sense region having nucleotide sequence corresponding to the target nucleic acid sequence or a portion thereof, and wherein the circular polynucleotide can be processed either in vivo or in vitro to generate an active siNA molecule capable of mediating RNAi. The siNA can also comprise a single stranded polynucleotide having nucleotide sequence complementary to nucleotide sequence in a target nucleic acid molecule or a portion thereof (for example, where such siNA molecule does not require the presence within the siNA molecule of nucleotide sequence corresponding to the target nucleic acid sequence or a portion thereof), wherein the single stranded polynucleotide can further comprise a terminal phosphate group, such as a 5′-phosphate (see for example Martinez et al., 2002, Cell., 110, 563-574 and Schwarz et al., 2002, Molecular Cell, 10, 537-568), or 5′,3′-diphosphate. In certain embodiments, the siNA molecule of the invention comprises separate sense and antisense sequences or regions, wherein the sense and antisense regions are covalently linked by nucleotide or non-nucleotide linkers molecules as is known in the art, or are alternately non-covalently linked by ionic interactions, hydrogen bonding, van der waals interactions, hydrophobic intercations, and/or stacking interactions. In certain embodiments, the siNA molecules of the invention comprise nucleotide sequence that is complementary to nucleotide sequence of a target gene. In another embodiment, the siNA molecule of the invention interacts with nucleotide sequence of a target gene in a manner that causes inhibition of expression of the target gene.

The double-stranded RNA portions of siRNAs in which two RNA strands pair up are not limited to the completely paired ones, and may contain nonpairing portions due to mismatch (the corresponding nucleotides are not complementary), bulge (lacking in the corresponding complementary nucleotide on one strand), and the like. Nonpairing portions can be contained to the extent that they do not interfere with siRNA formation. The “bulge” used herein preferably comprise 1 to 2 nonpairing nucleotides, and the double-stranded RNA region of siRNAs in which two RNA strands pair up contains preferably 1 to 7, more preferably 1 to 5 bulges. In addition, the “mismatch” used herein is contained in the double-stranded RNA region of siRNAs in which two RNA strands pair up, preferably 1 to 7, more preferably 1 to 5, in number. In a preferable mismatch, one of the nucleotides is guanine, and the other is uracil. Such a mismatch is due to a mutation from C to T, G to A, or mixtures thereof in DNA coding for sense RNA, but not particularly limited to them. Furthermore, in the present invention, the double-stranded RNA region of siRNAs in which two RNA strands pair up may contain both bulge and mismatched, which sum up to, preferably 1 to 7, more preferably 1 to 5 in number. The terminal structure of siRNA may be either blunt or cohesive (overhanging) as long as siRNA enables to silence the target gene expression due to its RNAi effect.

As used herein, siRNA molecules need not be limited to those molecules containing only RNA, but further encompasses chemically-modified nucleotides and non-nucleotides. In addition, as used herein, the term RNAi is meant to be equivalent to other terms used to describe sequence specific RNA interference, such as post transcriptional gene silencing, translational inhibition, or epigenetics. For example, siRNA molecules of the invention can be used to epigenetically silence genes at both the post-transcriptional level or the pre-transcriptional level. In a non-limiting example, epigenetic regulation of gene expression by siRNA molecules of the invention can result from siRNA mediated modification of chromatin structure to alter gene expression (see, for example, Verdel et al., 2004, Science, 303, 672-676; Pal-Bhadra et al., 2004, Science, 303, 669-672; Allshire, 2002, Science, 297, 1818-1819; Volpe et al., 2002, Science, 297, 1833-1837; Jenuwein, 2002, Science, 297, 2215-2218; and Hall et al., 2002, Science, 297, 2232-2237).

RNAi may be designed by those methods known to those of ordinary skill in the art. In one example, siRNA may be designed by classifying RNAi sequences, for example 1000 sequenced, based on functionality, with a functional group being classified as having greater than 85% knockdown activity and a non-functional group with less than 85% knockdown activity. The distribution of base composition was calculated for entire the entire RNAi target sequence for both the functional group and the non-functional group. The ratio of base distribution of functional and non-functional group may then be used to build a score matrix for each position of RNAi sequence. For a given target sequence, the base for each position is scored, and then the log ratio of the multiplication of all the positions is taken as a final score. Using this score system, a very strong correlation may be found of the functional knockdown activity and the log ratio score. Once the target sequence is selected, it may be filtered through both fast NCBI blast and slow Smith Waterman algorithm search against the Unigene database to identify the gene-specific RNAi or siRNA. Sequences with at least one mismatch in the last 12 bases may be selected.

Collections of matched biological reagents of the invention may include, for example, at least 1, 2, 5, 10, 15, 20, 25, 30, 50, 100, 150, 200, 300, 400, 500, 1000, 1500, 2000, 2500, 3000, 3500, 4000, 4500, 5000, 5500, 6000, 6500, 7000, 7500, 8000, 8500, 9000, 10000, 20000, 30000, or 40000 siRNA molecules. Collections of matched biological molecules may include, for example, at least 1, 2, 5, 10, 15, 20, or 24 of the siRNA molecules listed in Table 13.

In certain aspects, the nucleic acids of the matched reagent collection include a portion of (e.g., at least 50, 100, 150, 200, 250, 300, 400, 500, 600, 700, 800, 900, 1000, 1500, 2000 nucleotides), or the entire nucleotide sequence of each nucleotide sequence of a collection of nucleotide sequences that include at least 2, 3, 4, 5, 6, 7, 8, 9, 10, 15, 20, 25, 30, 35, 40, 45, 50, 75, 100, 125, 150, 175, 200, 250, 500, 750, 1000, 1250, 1500, 1750, 2000, 2500, or 4000 or all the nucleic acid sequences listed in Table 1 or Table 2, filed herewith on a separate CD. Table 1, filed herewith on CD in the file named “Table 1,” lists the coding sequences encoding 3469 human proteins that have been expressed and isolated using an insect cell system. Table 2, filed herewith on CD in the file named “Table 2,” includes coding sequences encoding approximately 7600 human proteins, that include the 3469 coding sequences of Table 1, and coding sequences which are available as part of a commercial clone collection (Invitrogen, Inc., Carlsbad, Calif.).

In certain aspects, the nucleic acids encode at least some of the proteins of Table 9, Table 10, or Table 11, or the nucleotides include all or a portion of the nucleotide sequences of Table 3, or the nucleotide sequences whose accession numbers are listed in Table 4, Table 5, and Table 6. Alternatively, the nucleotide sequences of the nucleic acids of the present invention, encode all or a portion of the proteins whose accession numbers are listed in Table 7, Table 8, Table 9, Table 10, or Table 11.

Nucleic acid molecules of the invention include those which are engineered, for example, to produce dsRNAs. Examples of such nucleic acid molecules include those with a sequence that, when transcribed, folds back upon itself to generate a hairpin molecule containing a double-stranded portion. One strand of the double-stranded portion may correspond to all or a portion of the sense strand of the mRNA transcribed from the gene to be silenced while the other strand of the double-stranded portion may correspond to all or a portion of the antisense strand. Other methods of producing dsRNAs may be used, for example, nucleic acid molecules may be engineered to have a first sequence that, when transcribed, corresponds to all or a portion of the sense strand of the mRNA transcribed from the gene to be silenced and a second sequence that, when transcribed, corresponds to all or portion of an antisense strand (i.e., the reverse complement) of the mRNA transcribed from the gene to be silenced.

Nucleic acid molecules which mediate RNAi may also be produced ex vivo, for example, by oligonucleotide synthesis. Oligonucleotide synthesis may be used for example, to design dsRNA molecules, as well as other nucleic acid molecules (e.g., other nucleic acid molecules which mediate RNAi) with one or more chemical modification (e.g., chemical modifications not commonly found in nucleic acid molecules such as the inclusion of 2′-O-methyl, 2′-O-ethyl, 2′-O-propyl, 2′-fluoro, etc. groups).

In some embodiments, a dsRNA to be used to silence a gene may have one or more (e.g., one, two, three, four, five, six, etc.) regions of sequence homology or identity to a gene to be silenced. Regions of homology or identity may be from about 20 bp (base pairs) to about 5 kbp (kilo base pairs) in length, 20 bp to about 4 kbp in length, 20 bp to about 3 kbp in length, 20 bp to about 2.5 kbp in length, from about 20 bp to about 2 kbp in length, 20 bp to about 1.5 kbp in length, from about 20 bp to about 1 kbp in length, 20 bp to about 750 bp in length, from about 20 bp to about 500 bp in length, 20 bp to about 400 bp in length, 20 bp to about 300 bp in length, 20 bp to about 250 bp in length, from about 20 bp to about 200 bp in length, from about 20 bp to about 150 bp in length, from about 20 bp to about 100 bp in length, from about 20 bp to about 90 bp in length, from about 20 bp to about 80 bp in length, from about 20 bp to about 70 bp in length, from about 20 bp to about 60 bp in length, from about 20 bp to about 50 bp in length, from about 20 bp to about 40 bp in length, from about 20 bp to about 30 bp in length, from about 20 bp to about 25 bp in length, from about 15 bp to about 25 bp in length, from about 17 bp to about 25 bp in length, from about 19 bp to about 25 bp in length, from about 19 bp to about 23 bp in length, or from about 19 bp to about 21 bp in length.

A hairpin containing molecule having a double-stranded region may be used as RNAi. The length of the double stranded region may be from about 20 bp (base pairs) to about 2.5 kbp (kilo base pairs) in length, from about 20 bp to about 2 kbp in length, 20 bp to about 1.5 kbp in length, from about 20 bp to about 1 kbp in length, 20 bp to about 750 bp in length, from about 20 bp to about 500 bp in length, 20 bp to about 400 bp in length, 20 bp to about 300 bp in length, 20 bp to about 250 bp in length, from about 20 bp to about 200 bp in length, from about 20 bp to about 150 bp in length, from about 20 bp to about 100 bp in length, 20 bp to about 90 bp in length, 20 bp to about 80 bp in length, 20 bp to about 70 bp in length, 20 bp to about 60 bp in length, 20 bp to about 50 bp in length, 20 bp to about 40 bp in length, 20 bp to about 30 bp in length, or from about 20 bp to about 25 bp in length. The non-base-paired portion of the hairpin (i.e., loop) can be of any length that permits the two regions of homology that make up the double-stranded portion of the hairpin to fold back upon one another.

Any suitable promoter may be used to control the production of RNA from the nucleic acid molecules of the invention. Promoters may be those recognized by any polymerase enzyme. For example, promoters may be promoters for RNA polymerase II or RNA polymerase III (e.g., a U6 promoter, an H1 promoter, etc.). Other suitable promoters include, but are not limited to, T7 promoter, cytomegalovirus (CMV) promoter, mouse mammary tumor virus (MMTV) promoter, metalothionine, RSV (Rous sarcoma virus) long terminal repeat, SV40 promoter, human growth hormone (hGH) promoter. Other suitable promoters are known to those skilled in the art and are within the scope of the present invention.

Double-stranded RNAs used in the practice of the invention may vary greatly in size. Further the size of the dsRNAs used will often depend on the cell type contacted with the dsRNA. As an example, animal cells such as those of C. elegans and Drosophila melanogaster do not generally undergo apoptosis when contacted with dsRNAs greater than about 30 nucleotides in length (i.e., 30 nucleotides of double stranded region) while mammalian cells typically do undergo apoptosis when exposed to such dsRNAs. Thus, the design of the particular experiment will often determine the size of dsRNAs employed.

In many instances, the double stranded region of dsRNAs contained within or encoded by nucleic acid molecules used in the practice of the invention will be within the following ranges: from about 20 to about 30 nucleotides, from about 20 to about 40 nucleotides, from about 20 to about 50 nucleotides, from about 20 to about 100 nucleotides, from about 22 to about 30 nucleotides, from about 22 to about 40 nucleotides, from about 20 to about 28 nucleotides, from about 22 to about 28 nucleotides, from about 25 to about 30 nucleotides, from about 25 to about 28 nucleotides, from about 30 to about 100 nucleotides, from about 30 to about 200 nucleotides, from about 30 to about 1,000 nucleotides, from about 30 to about 2,000 nucleotides, from about 50 to about 100 nucleotides, from about 50 to about 1,000 nucleotides, or from about 50 to about 2,000 nucleotides. The ranges above refer to the number of nucleotides present in double stranded regions. Thus, these ranges do not reflect the total length of the dsRNAs themselves. As an example, a blunt ended dsRNA formed from a single transcript of 50 nucleotides in total length with a 6 nucleotide loop, will have a double stranded region of 23 nucleotides.

As suggested above, dsRNAs used in the practice of the invention may be blunt ended, may have one blunt end, or may have overhangs on both ends. Further, when one or more overhang is present, the overhang(s) may be on the 3′ and/or 5′ strands at one or both ends. Additionally, these overhangs may independently be of any length (e.g., one, two, three, four, five, etc. nucleotides). As an example, STEALTH™ RNAi is blunt at both ends.

The invention also includes sets of RNAi and those which generate RNAi. Such sets include those which either (1) are designed to produce or (2) contain more than one dsRNA which directed against the same target gene. As an example, the invention includes sets of STEALTH™ RNAi wherein more than one STEALTH™ RNAi shares sequence homology or identity to different regions of the same target gene.

Cell Culture Products

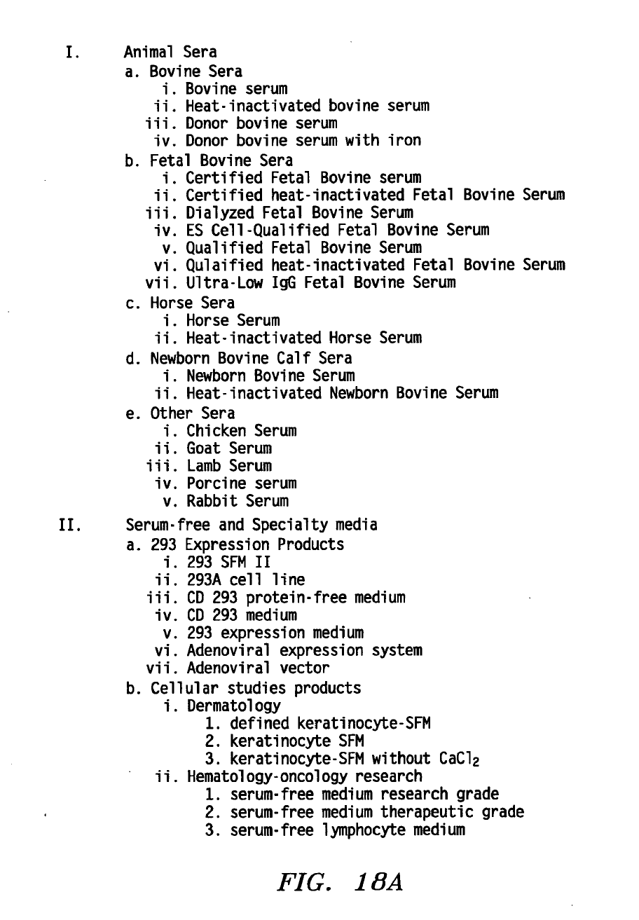

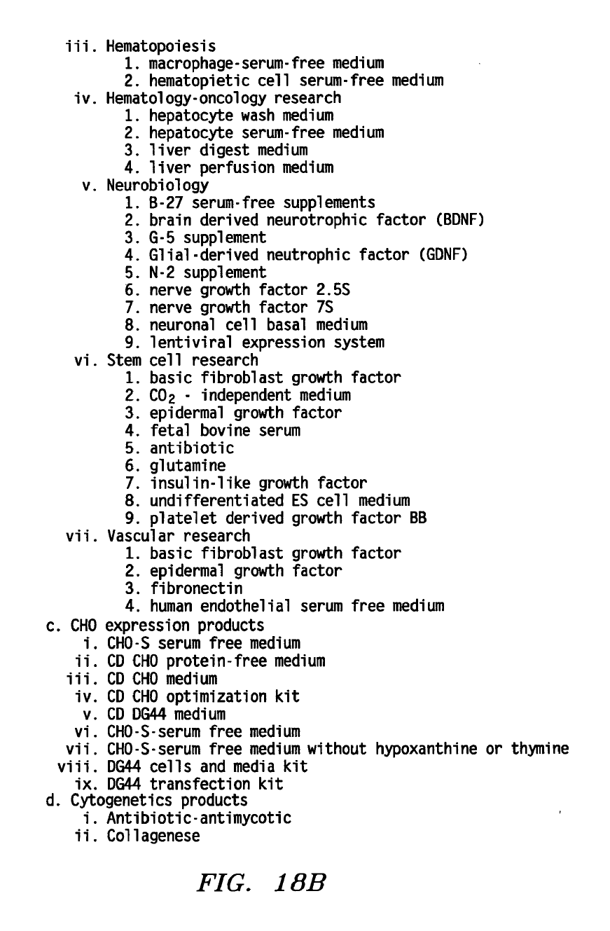

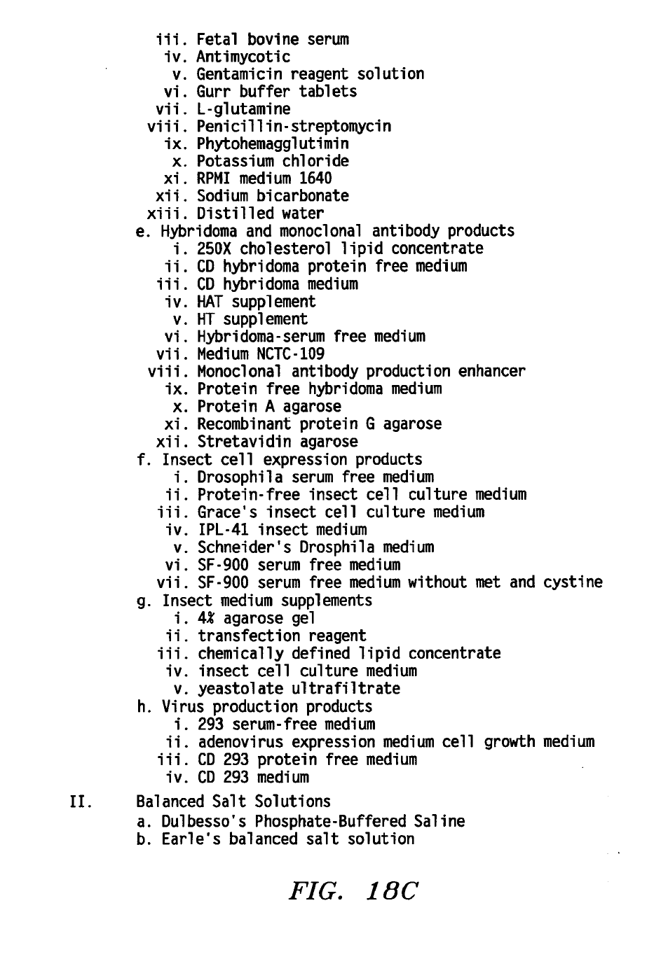

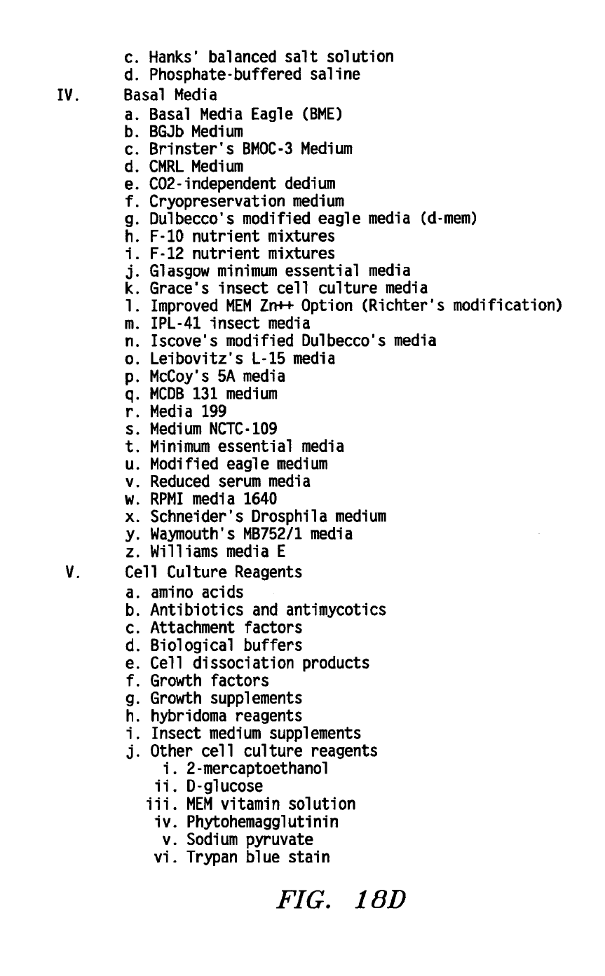

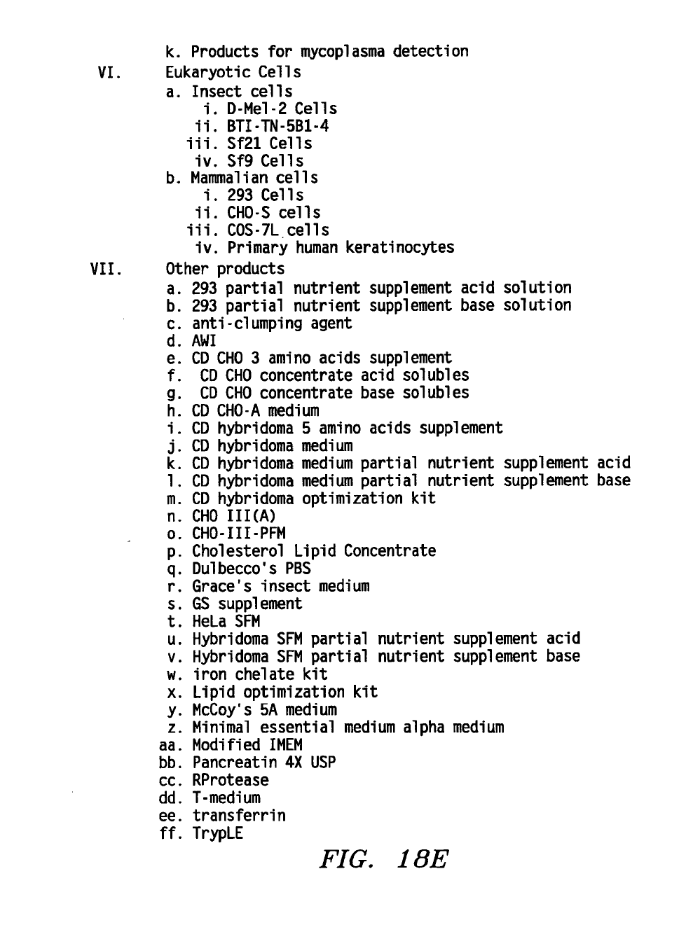

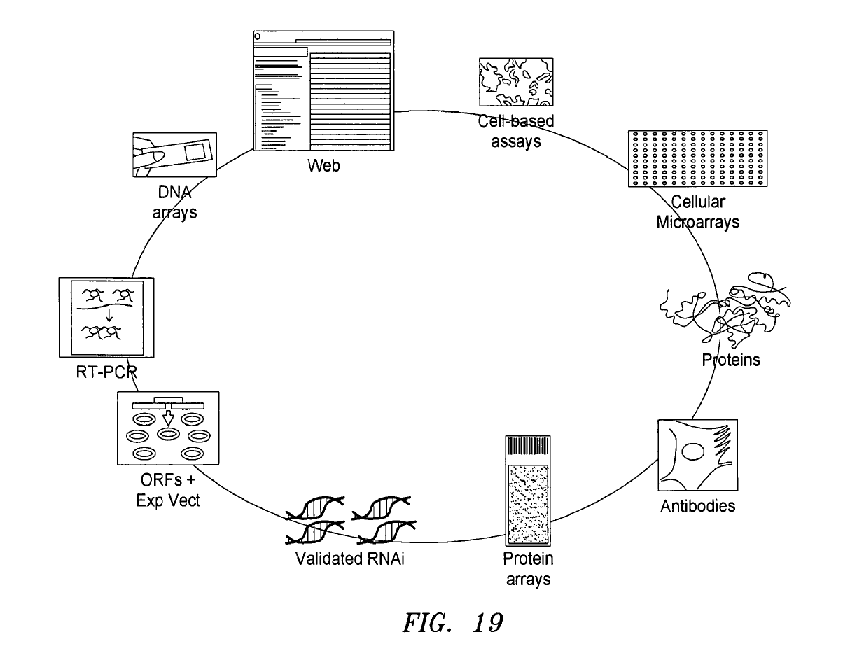

Cell culture products, including cells, cell culture media, and cell culture components such as, for example, serum, nutrients, salts, antibiotics, and other additives, for growing and/or maintaining cells are provided (e.g., bacteria, yeast, insect and mammalian cells) in the collection. Culture media may be nutrient rich or nutrient poor, and sometimes is selected based on the cells grown or maintained. Also provided in the collection are cells (e.g., bacteria, yeast, insect and mammalian cells), including cells competent for transfection of a nucleic acid, and cells modified for use in cellular assays. Included in the collection are reagents and apparatus for transfecting a nucleic acid into a cell, such as detergents and electroporation devices, for example. Cell culture products also comprise vessels and apparatus for growing and/or maintaining cells, such as flasks, dishes, plates, and fermentors. Cell culture products may include, for example, those listed in FIG. 18.

Detection Products, Separation Media and Microarrays

Provided in the collection are detection products, including, for example, bioassays, and products used to perform bioassays, such as antibodies, including, for example, epitope-specific antibodies, detectable labels (e.g., fluorophores, radioisotopes, light scattering compounds (e.g., molecules containing gold or silver), dyes), metabolic labels, enzymatic labels, light-producing labels such as, for example, luciferase, and molecules capable of linking detection agents to a molecule (e.g., derivitized biotin or streptavidin). Bioassays may include, for example, in vitro assays and cell based assays. Other examples of detection products include ion indicators, such as calcium, magnesium, sodium, potassium, chloride, or heavy metal indicators, chelating agents, and pH indicators. Other examples of detection products include instrumentation used in bioassays and other assays, such as, for example, flow cytometers, mass spectrometers, and consumable and non-consumable products used with the instrumentation, such as, for example, tubes, flasks, slides, plates, microspheres, and nanospheres. Other examples of detection products include electrophoresis products such as gel electrophoresis instrumentation, supplies, pre-cast gels, blotting, such as Western blot products, standards, stains, and dyes. Detection products may include, for example, products to detect protein-protein interactions. A collection may include a planar solid support (microtiter plate with wells, wafer with pits or wells), a chromatography resin, a bead (e.g., magnetic bead) for separation of biomolecules. Such separation media sometimes are derivitized with affinity agents, such as ligands, analytes, proteins, and oligonucleotides. A collection often comprises one or more microarrays, sometimes high density microarrays, with arrays of nucleic acids and/or arrays of proteins or peptides. Microarrays also include, for example, cellular microarrays. Detection products may also include products such as those disclosed at and linked to the http address https://catalog.invitrogen.com/index.cfm?fuseaction=viewCatalog.viewCategories&npc=92&pc=232 & nc=232 on the date this patent application is filed, which collection is hereby incorporated by reference in its entirety.

Databases, Search Elements, Search Interfaces and Database Output

As used herein, “procuring,” including grammatical variations thereof, means to obtain, gain, access, receive, acquire, or buy.

As used herein, “appropriate,” including grammatical variations thereof, means capable of being acted on or carrying out an act. For example, an appropriate request or command when inputted into a dialog box would trigger a search of a database to find or identify an object conforming to the request or command (e.g., keyword search to retrieve objects containing the inputted keyword).

As used herein, “biologically related,” including grammatical variations thereof, means associated with life and living processes. For example, anaerobic respiration is a biologically related metabolic action. Protein expression (in vitro) is another example.

As used herein, “electronic storage medium,” including grammatical variations thereof, means space in electronic memory where information is held for later use. For example, this may include, but is not limited to, magnetic tape, CD-ROMS, DVD, optical disks, flash drives, RAM or floppy disk.

As used herein, “electronic inventory,” including grammatical variations thereof, means a digital catalog which corresponds to some or all of the products and or services offered by the vendor.

As used herein, “target item,” including grammatical variations thereof, means data or files to be affected by an action. For example, a target item can be a file name, a word, an image, a text string, a number or a value stored on electronic media that is retrievable upon request by a user.

As used herein, “sundry groupings,” including grammatical variations thereof, means a collection of various data segregated into named files for orderly access of such data from an electronic storage medium.

As used herein, “interfacing,” including grammatical variations thereof, means the method of interaction between a person and a computer, or between a computer and a peripheral device, or between two computers. In a related aspect, user interface would include the environment that permits one to interact with a computer (e.g., World Wide Web, WiFi, browsers, web pages).

As used herein, “user,” including grammatical variations thereof, means an entity that requests services from a server. The entity can be a human or a device (e.g., see input devices, above).

As used herein, “user terminals,” including grammatical variations thereof, means a node or hardware that accesses a server.

As used herein, “bi-directional communication,” including grammatical variations thereof means a process by which information is exchanged between two systems in both directions, where each system receives and sends information.

As used herein, “searchable,” including grammatical variations thereof, means the ability of data or files to be looked into in an effort to mark, find or discover such data or files.

As used herein, “extracts,” including grammatical variations thereof, means a product prepared by retrieving files or data from a database or server.

As used herein, “associated biological attributes,” including grammatical variations thereof, means a specific feature related to living things and/or processes of living things (including such a feature carried out in vitro).

As used herein, “request,” including grammatical variations thereof, means one or a series of user inputs or commands for retrieving information from a server or database.

As used herein, “inputting,” including grammatical variations thereof, means the act of entering a request or data. For example, typing at a keyboard pointing, speaking to, etc.

As used herein, “hierarchal menu output,” including grammatical variations thereof, means a list transmitted to the user (e.g., but not limited to, a display on a computer screen) of available alternatives for selection by the operator or user organized into orders or ranks each subordinate to the one above it.

As used herein, “display,” including grammatical variations thereof, means what a user sees on a CRT unit or monitor. More broadly, substitutes may be used as displays, such as auditory signals for the visually impaired or any other means of information communication.

As used herein, “subset,” including grammatical variations thereof, means a set each of whose elements is an element of an inclusive set.

As used herein, “empirical measure of similarity” including grammatical variations thereof, means a method of comparing target items or objects between extracts containing such items or objects, where the extracts are considered to be similar if the distance between the items or objects comprising the extracts is small according to arbitrary values of attributes or annotations associated with items or objects in the target file. For example, values can be given for molecular weights, isoelectric points, metabolic pathway participation, restriction maps, organisms, protease fragments, epitopes, hydropathic profiles, separation patterns, such as electrophoresis gels, chromatographic output, mass spec output, fluorescence data, tissue distributions, expression patterns, kinetic constants, binding constants, antagonists, agonists, inverse agonists, linkage maps, substrates, ligands, inhibitors, disease associations, alleles, homologies, interacting molecules, biological functions, phosphorylation patterns, sub-cellular localizations, glycosylation patterns, post-translational modification patterns, motif consensus, crystal structures, pharmacokinetic properties, pharmacologic properties, and toxicologic properties secondary, tertiary and/or quaternary structures. Thus, for example, each attribute can be given a numerical value. Further, each biologically related product, for example, would have a different set of values for some or all of these attributes/annotations. Extracts with values for one or more attributes/annotations that are numerically similar are judged to be similar. Using such similarity, as distances between values become greater, the extracts are judged as less similar. Based on software design choices, ranks for the spectrum of similarity are determined and the resulting output of the extracts of interest are reflected in hierarchical fashion according to high and low values of similarity. Systems for determining such similarity are disclosed in, for example, U.S. Pat. No. 5,835,087, herein incorporated by reference.

As used herein, “graphic user interface (GUI),” including grammatical variations thereof, means a user interface to a computer that uses icons to represent items, such as documents and programs, that the user can access and manipulate with a pointing device or other signal transducer.

As used herein, “annotated text strings,” including grammatical variations thereof, means text or embedded comments or instructions within text which may or may not print but which may be viewed and referred to by an operator or user that include a consecutive series of characters to be specified by command.

As used herein, “base text,” including grammatical variations thereof, means the number of different values that can be represented by each digit position (e.g., binary or base 2) that correspond to the body copy on a page.

As used herein, “loci,” including grammatical variations thereof, means a site or one or more digital addresses where related information may be found.

As used herein, “objects,” including grammatical variations thereof, means a searchable element that is a part of a locus. For example, an annotation under an “organism” locus would be considered an object.

As used herein, “hyperlinks,” including grammatical variations thereof, means a pointer within a hypertext document that points (links) to another document, which may or may not be a hypertext document.

As used herein, “server,” including grammatical variations thereof, means a functional unit that provides shared services to workstations/clients/users over a network; for example, a file server, a print server, a mail server. The server may be internal or external, single or multitask.

As used herein, “Web page browser,” including grammatical variations thereof, means a program used to read a file or to navigate through a hypermedia document.

As used herein, “parsable,” including grammatical variations thereof, means to be amenable to analysis where the operands entered with a command create a parameter list in the command processor from the information.

As used herein, “sub-window,” including grammatical variations thereof, means a secondary window that is presented to a user to allow the user to perform a task on the primary browser window. For example, a dialog box is a sub-window.

As used herein, “module,” including grammatical variations thereof, means, a self-contained functional unit which is used with a larger system. For example, a software module is a part of a program that performs a particular task.

As used herein, “word-for-word searching” including grammatical variations thereof, means a keyword or keywords serve as the primary unit that represents the information for which the search is being conducted, where the search systems will search for strings of words, as well as individual words. Such a system will not automatically keep words together as a phrase. Further, a word-for-word searching method would envisage the use of wild cards (i.e., include variant endings to any word request).

As used herein, “Boolean searching,” including grammatical variations thereof, means a search structure that uses the logical operators, AND, OR & NOT, to connect search terms in search statements. The operators tell the database what the relationship is between the search terms. Further, a Boolean searching method would envisage the use of wild cards (i.e., include variant endings to any word request).

As used herein, “proximity searching,” including grammatical variations thereof, means a search structure that uses relative location and distance of query words or characters in a search statement. The location and distance operators (e.g., “near,” “adjacent,” “within”) tell the database what the relationship is between the search terms. Further, a proximity searching method would envisage the use of wild cards (i.e., include variant endings to any word request).

As used herein, “phrase searching,” including grammatical variations thereof, means keywords serve as the primary unit that represents the information for which the search is being conducted, where the search systems will search for strings of words. Such a system will automatically keep words together as a phrase. Further, a phrase searching method would envisage the use of wild cards (i.e., include variant endings to any word request).

As used herein, “truncation,” including grammatical variations thereof, means a searching system that uses a symbol at the end of a word to retrieve variant endings of that word.

As used herein, “keyword jump,” including grammatical variations thereof, means a method of navigation that transports a user to content/record stored on a database by entering a keyword or code associated with that content/record.

As used herein, “Blast server,” including grammatical variations thereof, means Basic Local Alignment Search Tool, which is a set of similarity search programs designed to explore all of the available sequence databases regardless of whether the query is protein or nucleic acid.

As used herein, “gene ontology,” including grammatical variations thereof, means a controlled and dynamic vocabulary that can be applied to all organisms as knowledge of gene and protein roles in cells accumulates and changes.

As used herein, “public consortium,” including grammatical variations thereof, means an individual or group recognized by a community to possess authority that can be cited freely by members of the public and understood by members of the community.

As used herein, “tabbed,” including grammatical variations thereof, means a way of creating DHTML dialog boxes, or the like (HTML, XHTML, XML), or sub-windows as a type of interfacing to load such sub-windows.

As used herein, “triggers,” including grammatical variations thereof, means to initiate, actuate, or set off a program.

As used herein, “tree navigation,” including grammatical variations thereof, means using an organization of directories (or folders) and files which resemble the branches of an upside-down tree that allow users to find their way through a Web site.

In some embodiments, provided herein are methods for selling an isolated biomolecule or biological research reagent or service, related thereto, that include: presenting to a customer an input function for identifying a target biological molecule or target biological pathway; and presenting to the customer a purchasing function comprising links to purchases of at least 5, 10, 20, 25, 50, 100, 200, 250, 500, 750, 1000, 1250, 1500, 1750, 2000, 2500, 5000, 7500, 10000, 12500, 15000, 17500, 20000 different individual or different sets of matched biomolecules and/or biological research products of a collection of matched biomolecules and/or biological research products comprising at least 100 different isolated biomolecules and/or biological research products of each of at least two biomolecule classes and/or biological research product classes, wherein the isolated biomolecules and/or biological research products of the collection are related to the target biomolecule or biomolecular pathway.

Methods of such embodiments are performed by a provider to generate revenue from a customer. Exemplary products offered by the provider can include clone collections and individual clones, polypeptides, such as enzymes, antibodies, libraries (e.g., cDNA libraries, genomic libraries, etc.), buffers, growth media, purification systems, primers, cell lines, chemical compounds, fluorescent labels, functional assays, and a variety of kits including DNA and protein purification, amplification and modification. Further, these exemplary products are provided for example only and are not intended to limit the present invention.

In certain aspects, provided is a method for selling a plurality of related products and services that generates revenue for a provider. Exemplary services offered by the provider include clone construction services, protein expression services, antibody production services, library (e.g., cDNA library, genomic library, etc.) construction services, and research and development consulting services.

One or more input functions described herein typically search a collection of biological reagents by a biological element to identify a sub-collection of biological reagents matched to the biological element. A biological element includes but is not limited to a biomolecule, pathway, workflow, developmental state, or disease, and often is utilized to search a collection of biological reagents to identify matched reagents. The term “matched” as used herein generally refers to a set of reagents related to the biological element. In certain preferred embodiments, the biological element is a nucleic acid sequence of a gene from a collection of gene sequences. One or more biological elements may be utilized to search a collection, and can be selected from the group consisting of a target biomolecule, a target biomolecular pathway, a target biomolecular pathway member, a disease, a disease pathway, and a disease pathway member. A target biomolecule sometimes is a nucleic acid or protein, such as one or more of those described herein. The search parameter may also be based on gene ontology, wherein a target biological molecule is searched based on its protein or gene family. For example, a target protein that is a member of a protein subclass or family may be searched within that subclass or family. Protein subclasses or families may include, for example, G-protein coupled receptors, kinases, protein kinases, nuclear hormone receptors, protein phosphatases, phosphodiesterases, proteases such as, for example, endopeptidases and exopeptidases, ino channels, cytokines, and chemokines. Other examples of protein subclasses or families are listed in, for example, Table 10, which is incorporated by reference herein. Examples of expressed isolated proteins are listed in, for example, Table 11, which is incorporated by reference herein. A target biomolecular pathway often is a related group of biomolecules that interact with one another (e.g., bind, phosphorylate, dephosphorylate, cleave by proteolysis) in cells or tissues of an organism. A disease is any known condition or disorder, and a disease pathway often is a group of biomolecules that interact with one another in diseased tissue or cells. Additional examples of biological elements include but are not limited to biological attributes such as nucleic acid or amino acid sequences, molecular weights, isoelectric points, metabolic and signal pathway participation, restriction maps, organisms, protease fragments, epitopes, hydropathic profiles, separation patterns, such as electrophoresis gels, chromatographic output, mass spec output, fluorescence data, tissue distributions, expression patterns, kinetic constants, binding constants, antagonists, agonists, inverse agonists, linkage maps, substrates, ligands, inhibitors, disease associations, alleles, homologies, interacting molecules, biological functions, phosphorylation patterns, sub-cellular localizations, glycosylation patterns, post-translational modification patterns, motif consensus, crystal structures, pharmacokinetic properties, pharmacologic properties, toxicologic properties, secondary, tertiary and/or quaternary structures. In addition to one or more biological elements, customer information can be added to a purchase server customer database when there is not a match between the stored information and that contained in a customer name field.

Descriptors corresponding to a collection of physical biological reagents generally are maintained in one or more databases. Known database structures can be utilized for maintaining descriptors corresponding to the collection. Descriptors include but are not limited to a scientific name descriptive of a biological reagent, a commercial name descriptive of a biological reagent, a chemical representation of a biological reagent, an amino acid or nucleotide sequence corresponding to a biological reagent, a research protocol useful for using a biological reagent, a flow chart showing mechanisms of action for one or more reagents, and price information, for example. Further examples of descriptors include but are not limited to organisms, nucleotide accession numbers, related accession numbers, gene names, gene definitions, gene symbols, text summary of gene products, expression profiles, mRNA records, references, length of inserts in base pairs, nucleic acid sequences, collection names, collection types, vector names, vector antibiotics, host names, Stealth RNA, siRNA, protein accession numbers, protein records, amino acid sequences, molecular weights, isoelectric points, protease digestion patterns, domain searches, predicted secondary and tertiary structures, binding sites, classes of enzymes, classes of substrates, associated proteins (for example, other members of protein complexes), inhibitors, blockers, agonists, antagonists, labels, tags, markers or other indicators, protein model searches, Online Mendelian Inheritance in Man (OMIM) data, product data, metabolic pathway data, single nucleotide polymorphism (SNP) data, SNP map data, locus link ID, Unigene ID and genomic alignment data. Descriptors corresponding to a biological reagent often are linked to one or more descriptors corresponding to an input biological element utilized to search the collection, described in greater detail below.

Those of ordinary skill in the art recognize that protocols may be developed in order to ensure that the information about each target biomolecule is updated on a regular basis. For example, protocols may be developed to regularly update the gene sequence or protein sequence of the target biomolecules in the matched reagent collection. Also, for example, information about the function of each target biomolecule as well as the biological pathways and/or disease pathways in which the target biomolecule is implicated, may be regularly updated. The updates may be, for example, automatic. In this aspect, the database may seek information available on the Internet, or information otherwise available, such as the seller's experimental results. Reference Data Sets that may be consulted for updates include, for example, RefSeq (http://www.ncbi.nlm.nih.gov/RefSeq/), (Pruitt K D, et al., Nucleic Acids Res 2005 Jan. 1; 33(1):D501-D504; Pruitt K D, et al., Trends Genet. 2000 January; 16(1):44-47; MGC (Mammalian Gene Collection, http://mgc.nci.nih.gov/)(MGC Project Team, Genome Res. 2004; 14:2121-7; Baross, A., et al., Genome Res. 2004, 14:2083-92; Wu, J Q, et al., Biotechniques, 2004, 36(4):690-6, 698-700; MGC Program Team, Dec. 11, 2002, 10:1073; Strausberg, R L, et al., Science 1999, 286:455-457); Ensembl (http://www.ensembl.org/, Hubbard, T. et al. 2002, Nucleic Acids Research 30: 38-41); UniProt (http://www.pir.uniprot.org/database/DBDescription.shtml (Apwieler, R., et al. 2004, Nucleic Acids Res. 32:D115-119; Leinonen, R., et al. 2004, Bioinformatics 2004 Mar. 25; Apweiler, R., et al. 2004, Curr. Opin. Chem. Biol. 8(1):76-80; SNP (http://www.ncbi.nlm.nih.gov/SNP/); Affymetrix (http://www.affymetrix.com/support/technical/technotes/annotmethodtechnote.affx) and Unigene (http://wwvv.ncbi.nlm.nih.gov/entrez/query.fcgi?db=unigene)(Wheeler, D L., et al. 2003, Nucleic Acids Res. 31:28-33; Schuler, G D, 1997, J. Mol. Med. 75:694-698; Schuler, G D et al., Science 1996, 274:540-546; Boguski, M S. And Schuler, G D, 1995, Nature Genetics 10:369-371).

A collection of biological research reagents generally is searched according to the methods provided herein, by inputting one or more biological elements into an input interface or input function. Input interfaces and input functions are known and are provided in a convenient apparatus, orientation and location for a user, and can be provided via a wide area network, such as an Internet portal. A biological element may be input by a variety of means, including but not limited to, manual input devices or direct data entry devices (DDEs). For example, manual devices may include, keyboards, concept keyboards, touch sensitive screens, light pens, mouse, tracker balls, joysticks, graphic tablets, scanners, digital cameras, video digitizers and voice recognition devices. DDEs may include, for example, bar code readers, magnetic strip codes, smart cards, magnetic ink character recognition, optical character recognition, optical mark recognition, and turnaround documents.

A user in a remote location often inputs information in the input interface, where access is remotely provided to an electronic data server to a user where the server receives input from a user and processes the input to produce a first output, based on interfacing with one or more public consortium databases, where the latter database has one or more databases which are, for example, proprietary to an offeror of the product or service. The user can select one or multiple products or services or a hyperlinked description of a product or service to create an extract, where the extract serves as an output for the user, thus, facilitating delivery of a product or service to the user, whether delivery is remote or local to the offerer/user. In a related aspect, the choice of delivery may be that of the offerer or user. A server utilized sometimes is an in-house server, public server or other private server. For example, the public server may include a government institution, a private institution, a college or university, a consortium or a private individual. Other databases may include data related to inventory, shippers, seasonal or regional requirements, credit history, hazardous products and interactions, notifications associated with making dangerous or hazardous products, warning flags, and the like.

Any search or sorting feature useful for identifying a sub-group of biological reagents matched to a biological element from a larger collection can be utilized. Such searches include but are not limited to word-for-word searches, Boolean searches, proximity searches, phrase searches, truncation searches or a combination of the foregoing. In other embodiments, methods may include processing string searches using a BLAST server (including, but not limited to, in-house or external server) or keyword jump navigation. Further, such searches may include accessing external databases/servers. Search algorithms can include but are not limited to Dijkstra and Bellman-Ford algorithms, sometimes with skeletal or heuristic elements, for example.

A matched collection that is the output from a search is in a form useful to a user (e.g., a list, a table), and may include a set of descriptors selected by the user (e.g., price information and nucleotide sequences of research reagents). An output format also may include a relevance indicator that shows a user the degree of relation between an input parameter and a matched reagent in the output collection.

The resulting outputs may, for example, be displayed as browser pages containing for example, hierarchical menus that are based on the retrieved extracts which provide the user with one or more subsets or compilations of the stored target items. The menus represent assortments of target items within the subsets, where the content and/or format of the displayed target items is based on an empirical measure of similarity of the associated biological attributes for all of the assorted target items. Moreover, the hierarchical menu output display pages identify favored or all target items assorted into each of the files which have one or more associated biological attributes in common to enable a user, for example, to differentiate products and/or services of interest stored on electronic media and to obtain or purchase one or more listed products or services (i.e., custom order, catalog listing or service provided) by activating an appropriate graphic user interface (e.g., a check box) that is included on the displayed output pages. In one aspect, any one menu item output on the displayed format page will contain a buy option graphic user interface (GUI) and one or more of the following, including a clone identification number, definition of the expressed product, gene symbol, and accession number. For example, a hierarchical menu may, on the first page, provide the user with names of more than one target biomolecule from a matched biological reagent collection associated with a given pathway. Each of the target biomolecules may be linked to the next level of pages, with items from the matched biological reagent collection matched to each of the target biomolecules. In one example, when the user clicks the hyperlink, a list of products and/or services can be presented to the customer, or a series of options can be presented such as “isolated proteins,” “antibodies,” “nucleic acid probes,” “clones,” “biological research products,” “cell culture products,” or “services” that when selected link to Internet pages with the matched product and/or service that can be customized based on the identified target protein(s).

Or, after a search based on a disease, the output may first be a browser page listing multiple pathways or target biomolecules associated with that disease, with further links to additional matched biological reagents.

When the user clicks the hyperlink, a list of products and/or services can be presented to the customer, or a series of options can be presented such as “isolated proteins,” “antibodies,” “nucleic acid probes,” “clones,” or “services” that when selected link to Internet pages with the matched product and/or service that can be customized based on the identified target protein(s).

Convenient and useful database structures, input interfaces, search algorithms, output formats, user interfaces, and information transmission systems are known and described elsewhere, such as in U.S. patent application Ser. No. 10/830,074, filed 23 Apr. 2004 by Feng Liang, entitled “Online procurement of biologically related products/services using interactive context searching of biological information,” incorporated in its entirety by reference. U.S. patent application No. 60/591,541, filed 26 Jul. 2004 by Paul Predki et al., entitled “Methods for providing protein microarrays,” incorporated in its entirety by reference; and U.S. patent application No. 60/608,293, filed 8 Sep. 2004 by Siamak Baharloo et al., entitled “Methods and systems for in silico experimental design and for providing a biotechnology product to a customer,” Incorporated in its entirety by reference.

The purchasing function included in methods provided herein can provide one or more hyperlinks to related products or services. The purchasing function allows the customer to purchase the related products or services presented to the customer after the customer identifies a target biological molecule or target biological pathway. The purchasing function can be linked to an Internet based shopping cart. Therefore, the customer upon being presented with links for purchasing related biotechnology products, can click the links to learn more about the biotechnology products and/or to add the related biotechnology products to an Internet shopping cart. Therefore, the provider generates revenue when the purchaser purchases the one or more products and/or services using the purchasing function

A skilled artisan will understand that many database design strategies can be used to carry out the methods provided herein. The database can be a relational database that includes the following tables:

a) Product tables for each product line that includes a product line's own unique attributes, including its original accession and version;

b) Master product table that links all different product types with common features (sku, size, name, description), and consolidates the search by product id and sku, and speeds up the data retrieval;

c) Product accession association table that manages gene association of different product lines, product association, and consolidates a search by gene related ids;

d) Product reporting tables that manage the daily update of gene and its product association and report the mapping status to managers for each product line; and

e) LIMS (pipeline) table that links on shelf products with products in pipeline to provide consolidated reporting view of product portfolios related with a specific set of gene targets, a critical feature for developing matched reagent set

All of the updates to the tables can be tracked and time stamped

Examples of database structures, input interfaces, search algorithms, output formats, user interfaces, and information transmission systems, are presented in the Examples.

### EXAMPLES

The examples set forth below illustrate but do not limit the invention.

### Example 1

### Collections of Biological Reagents Comprising siRNA Reagents

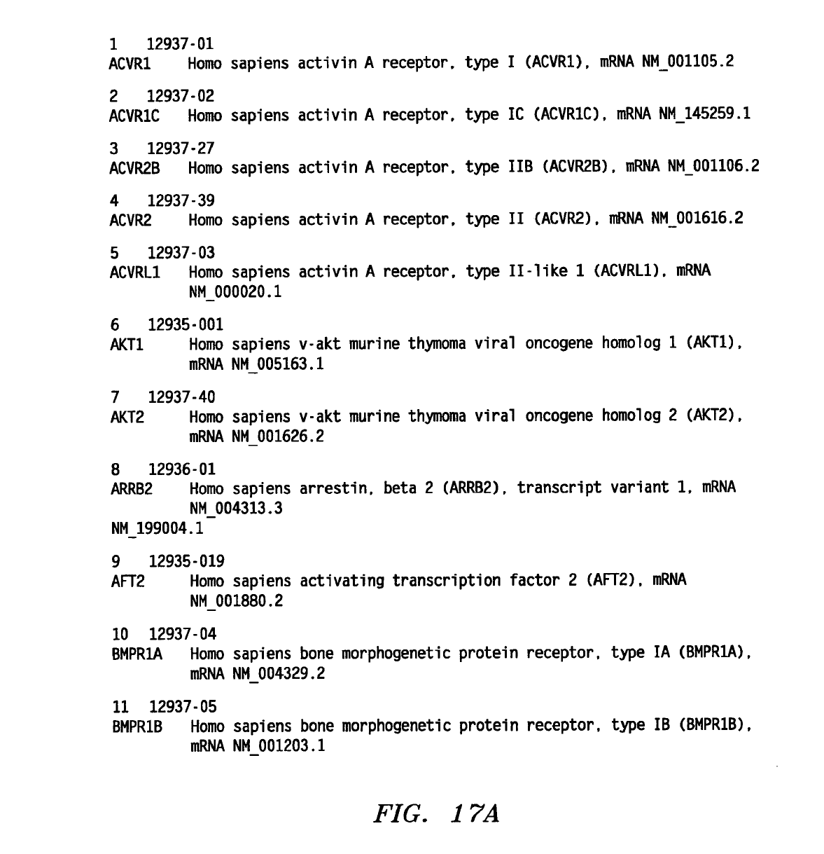

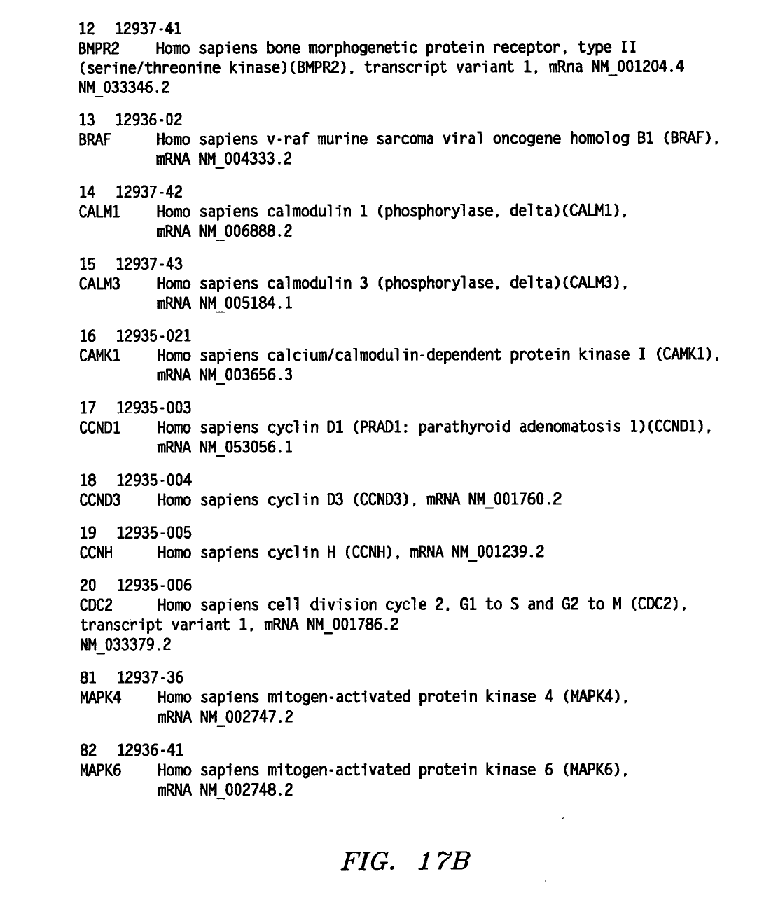

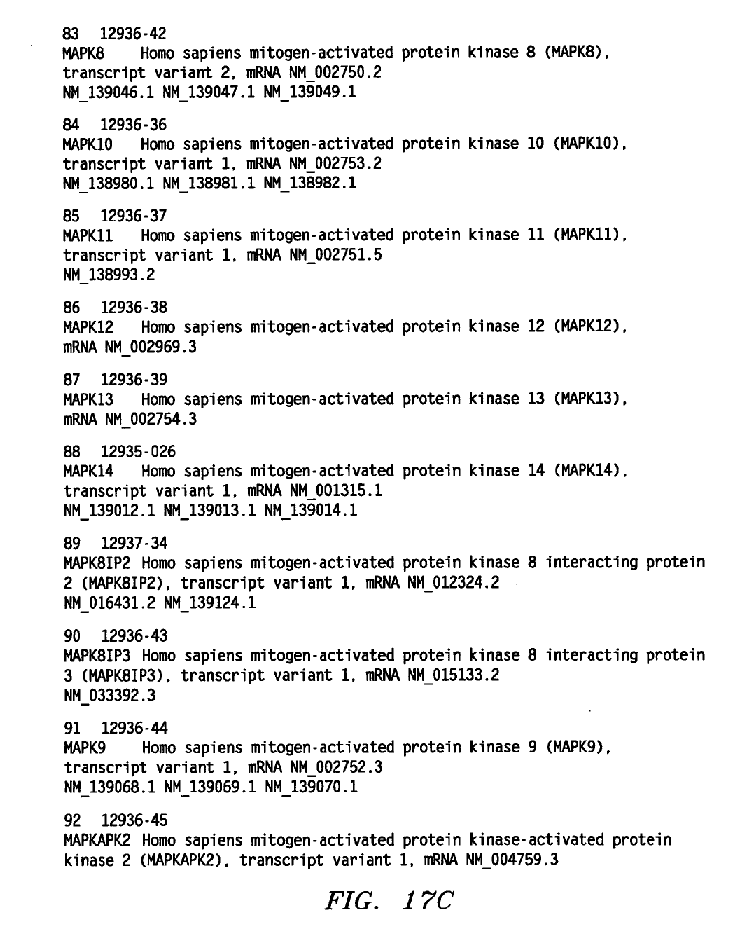

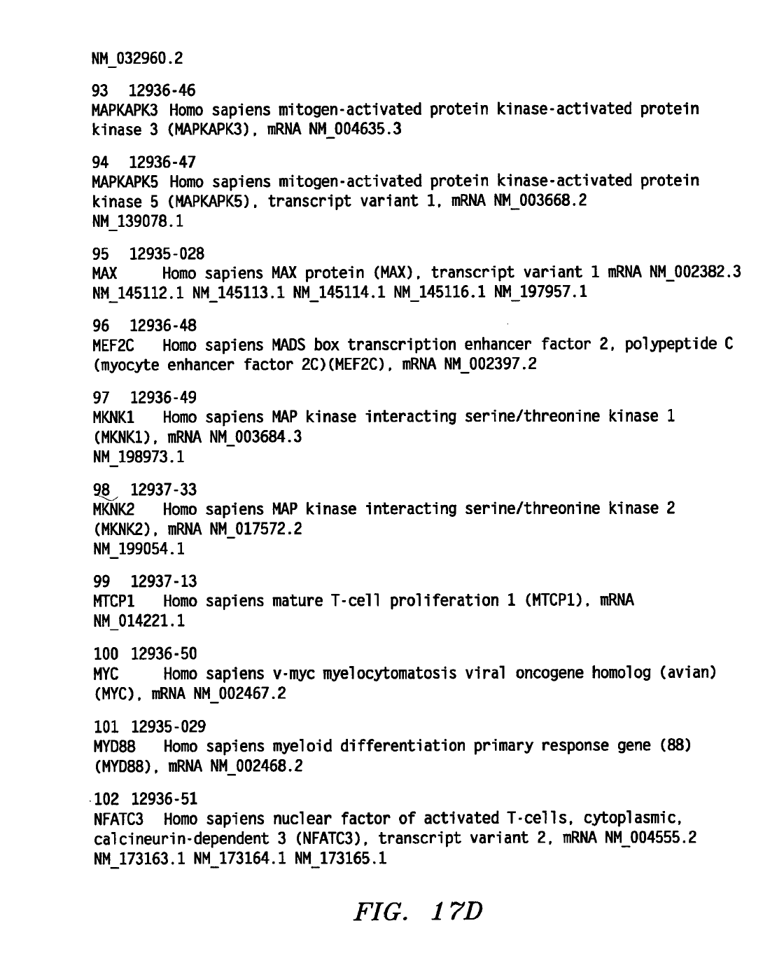

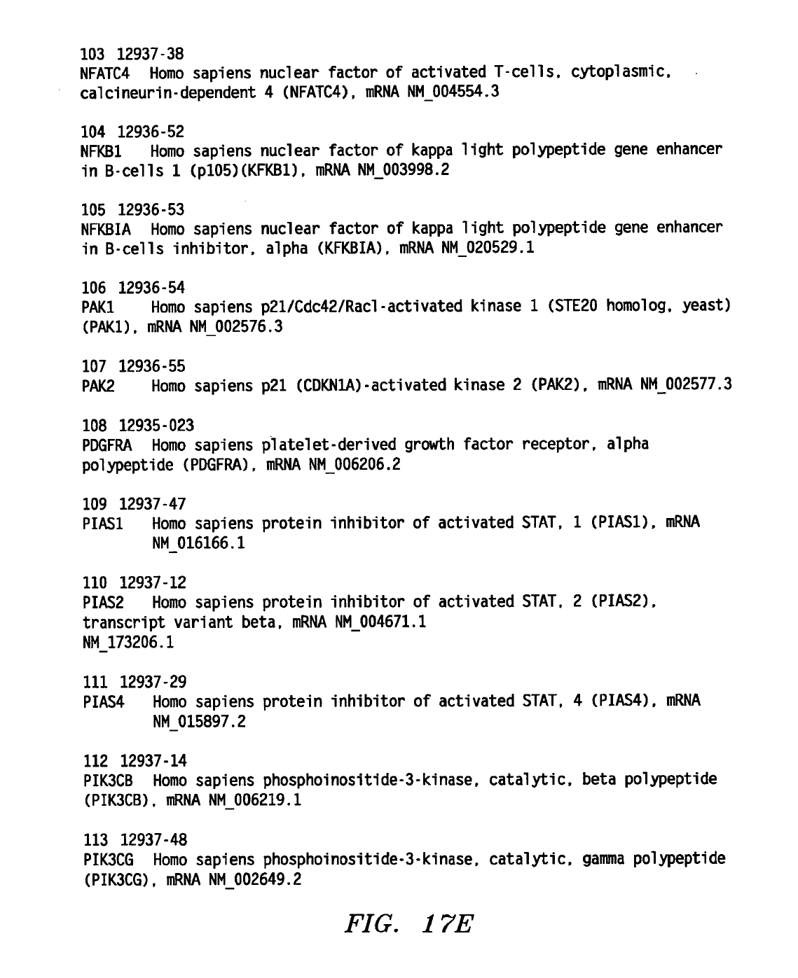

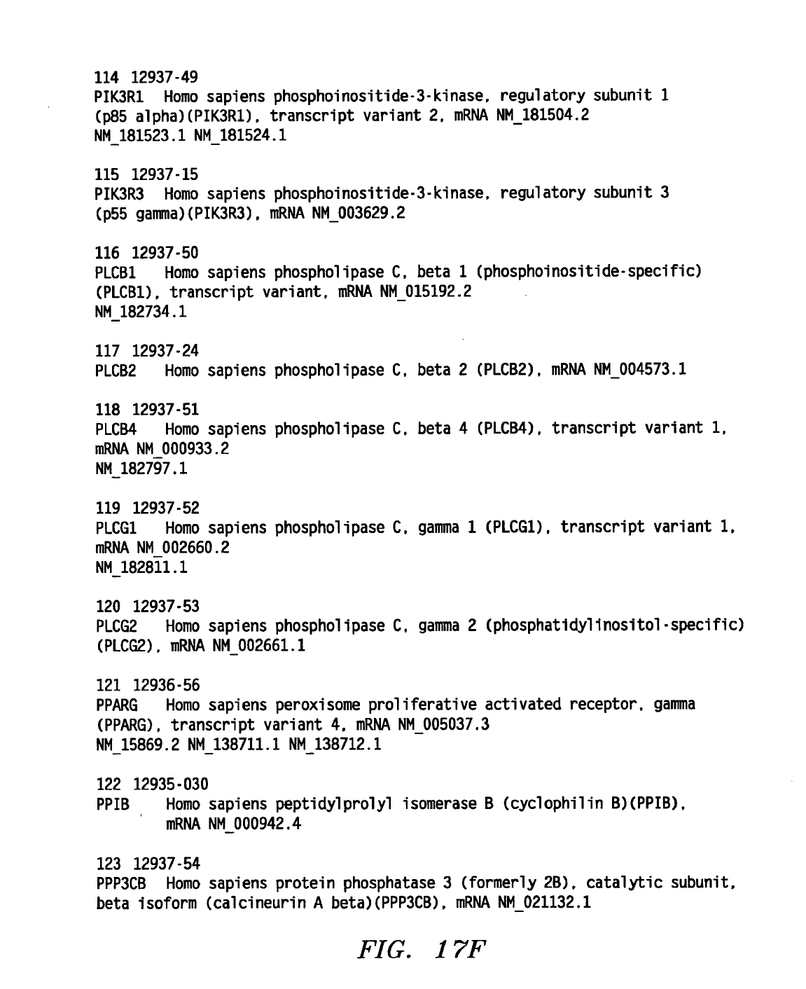

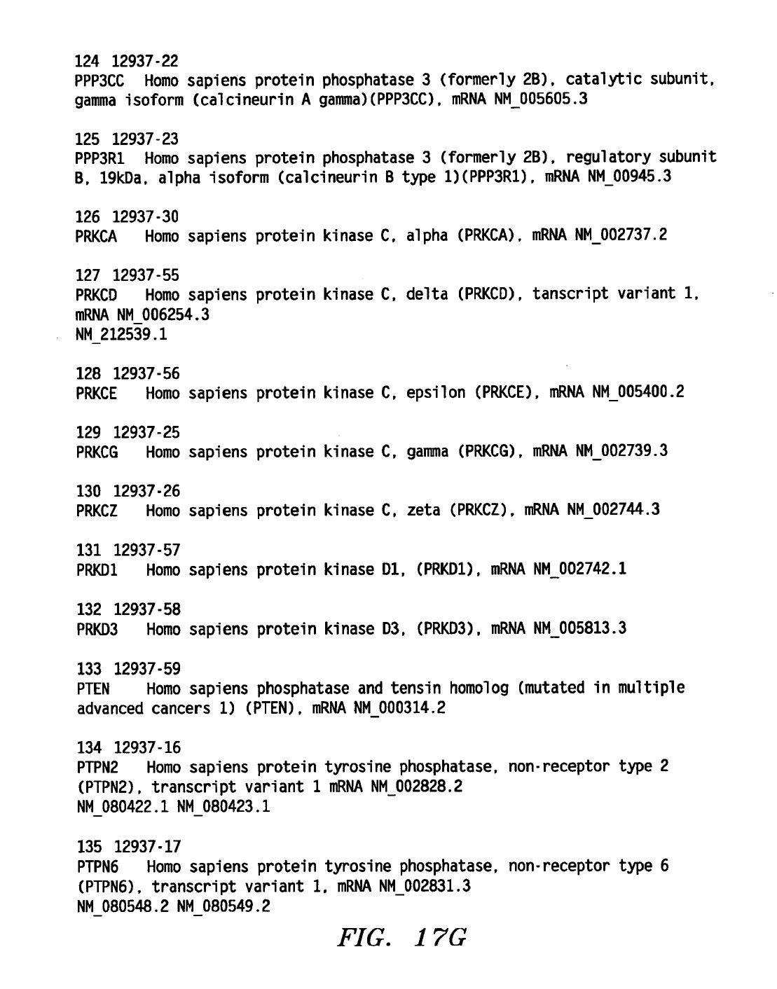

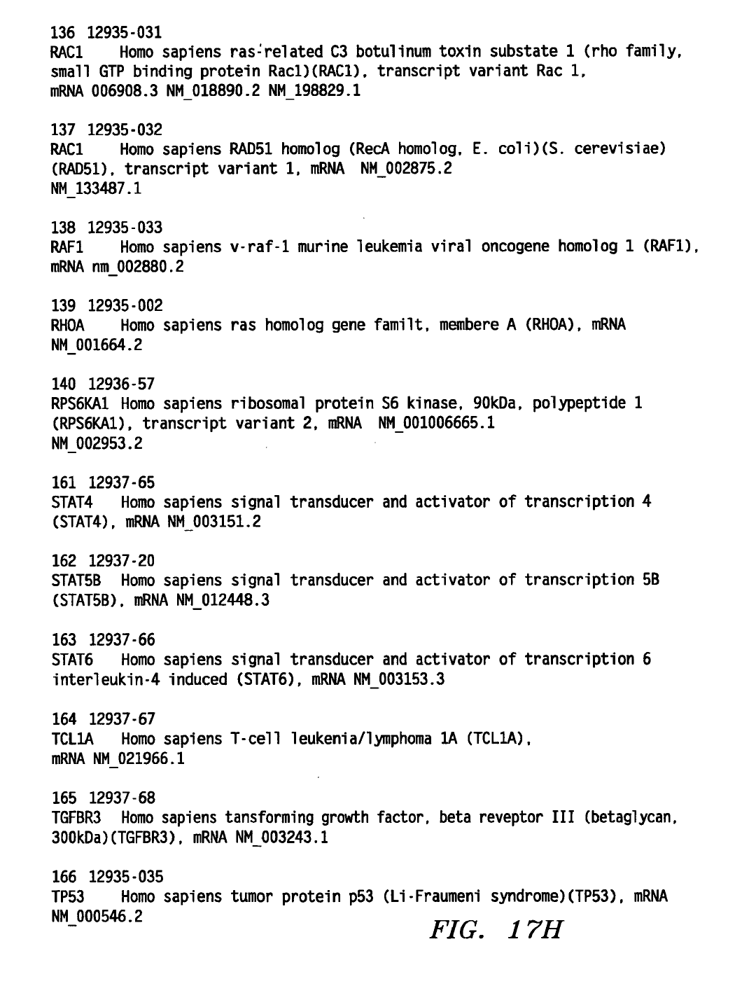

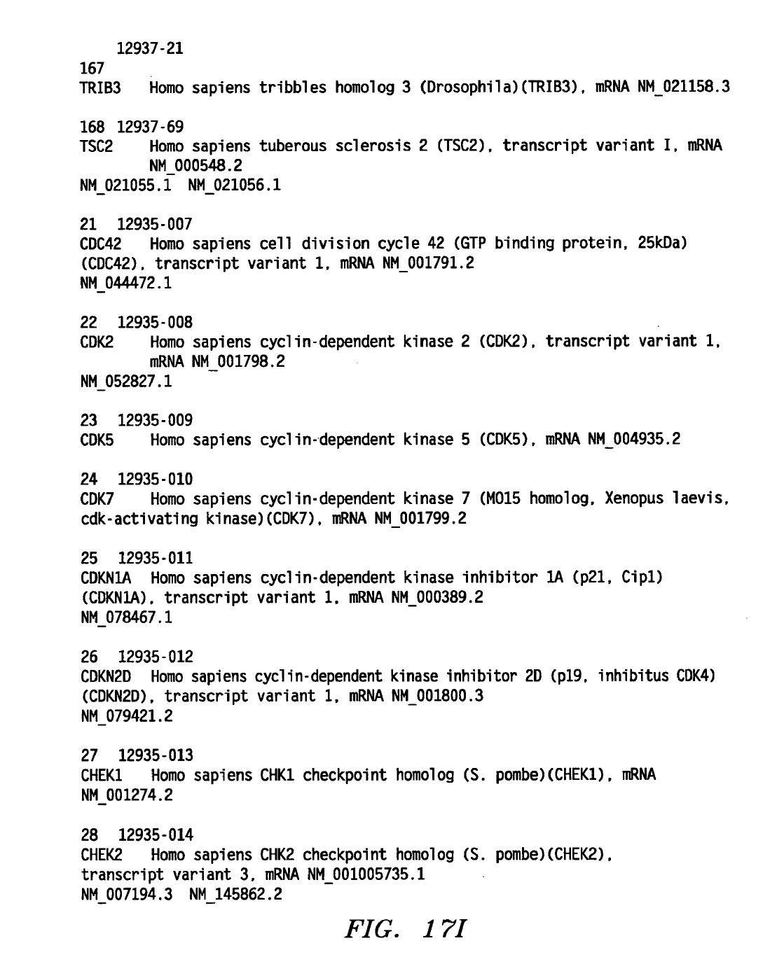

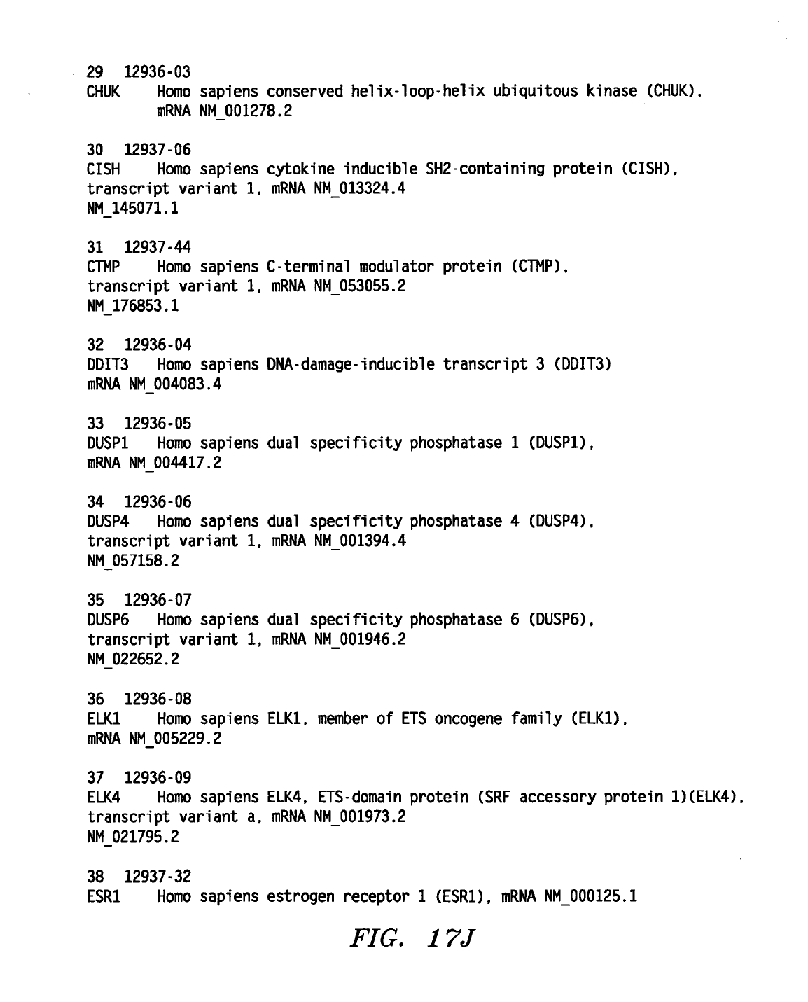

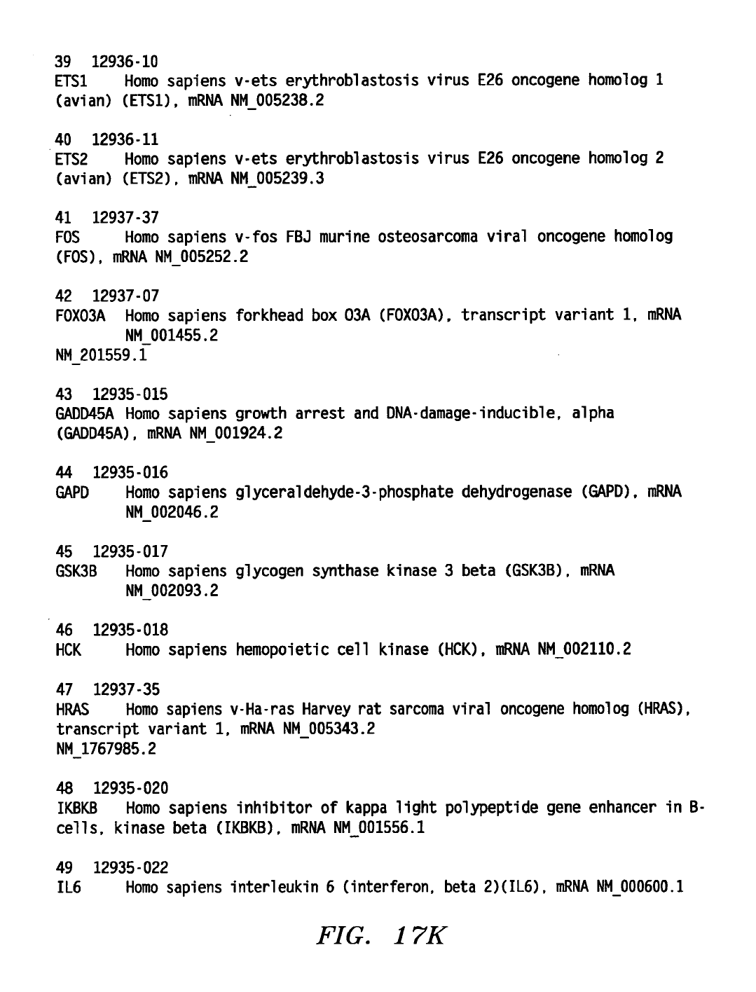

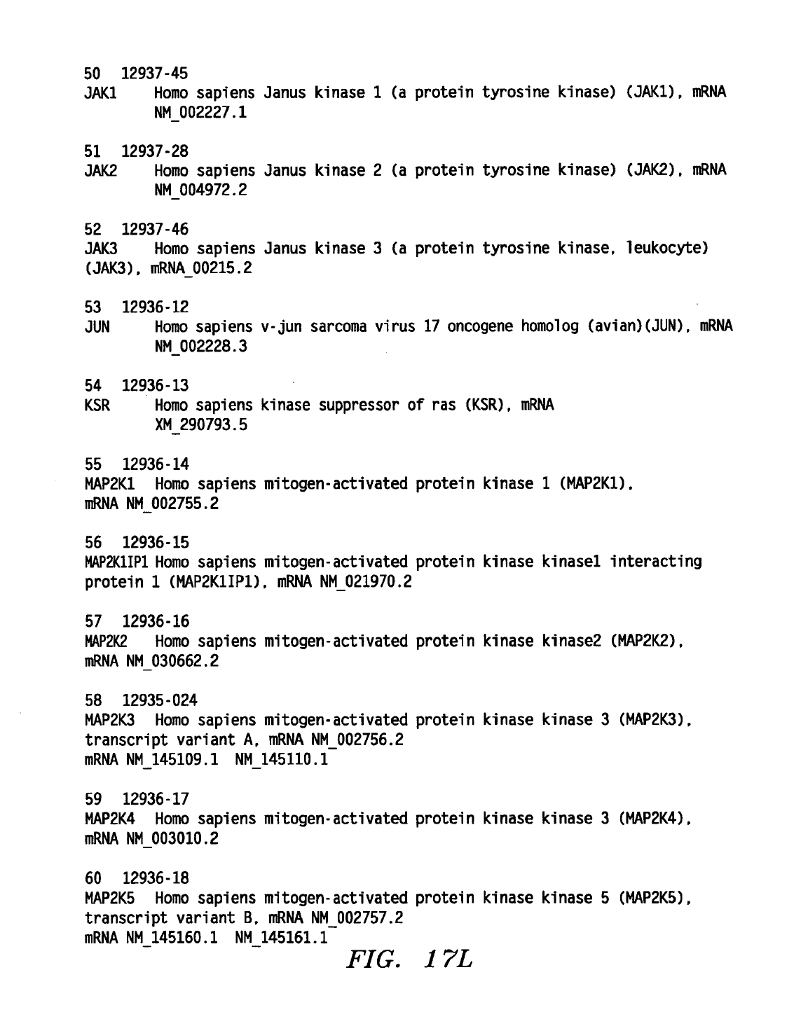

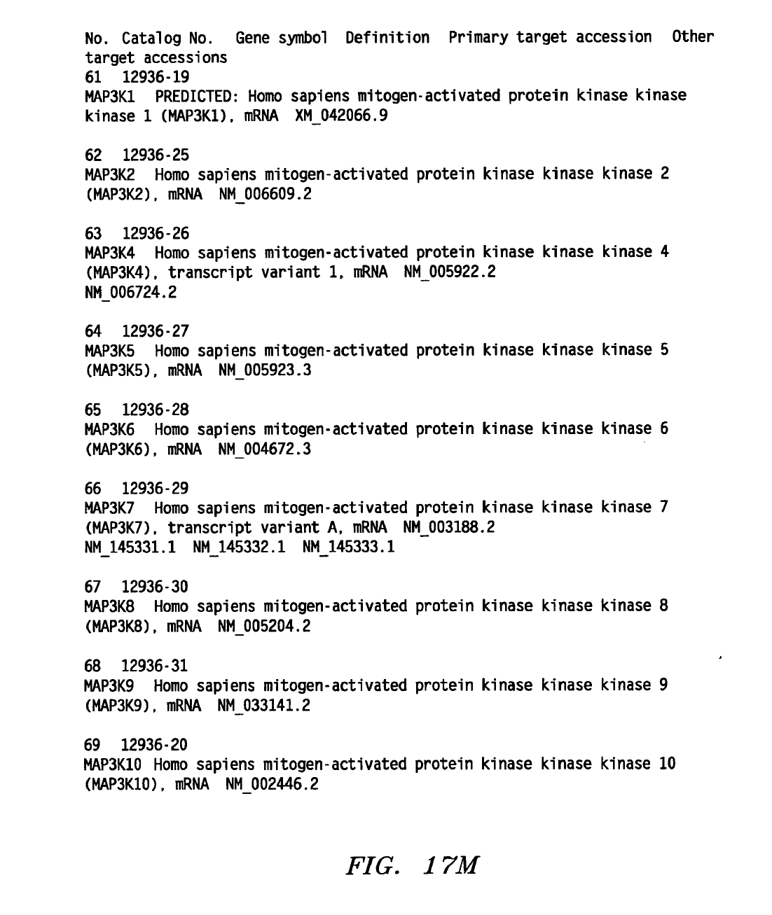

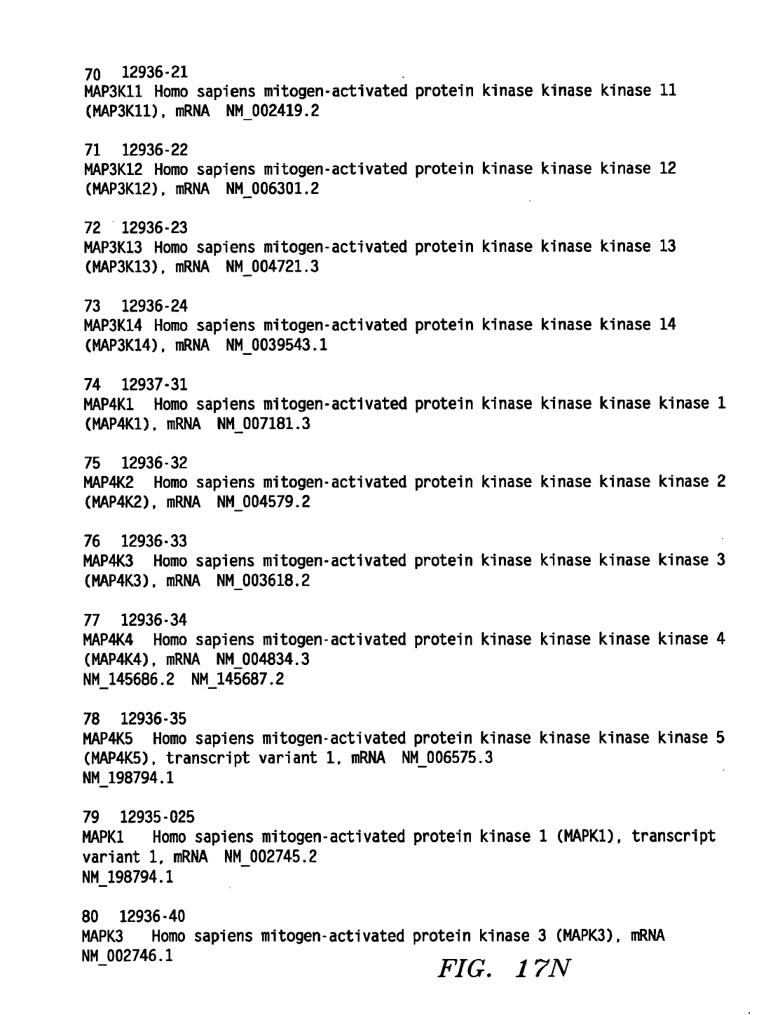

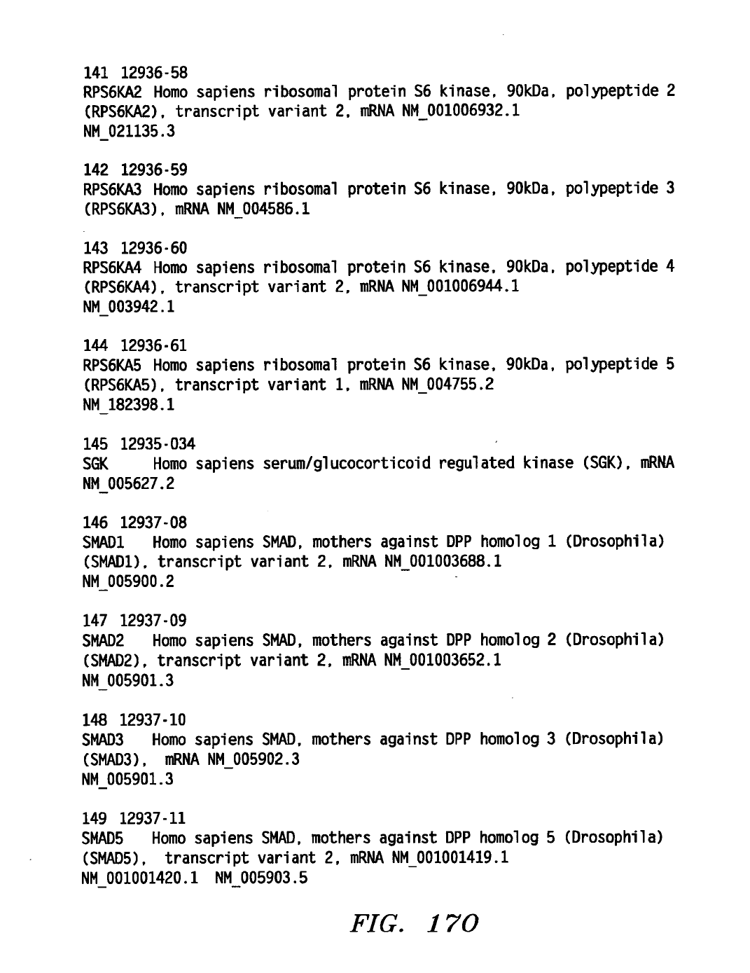

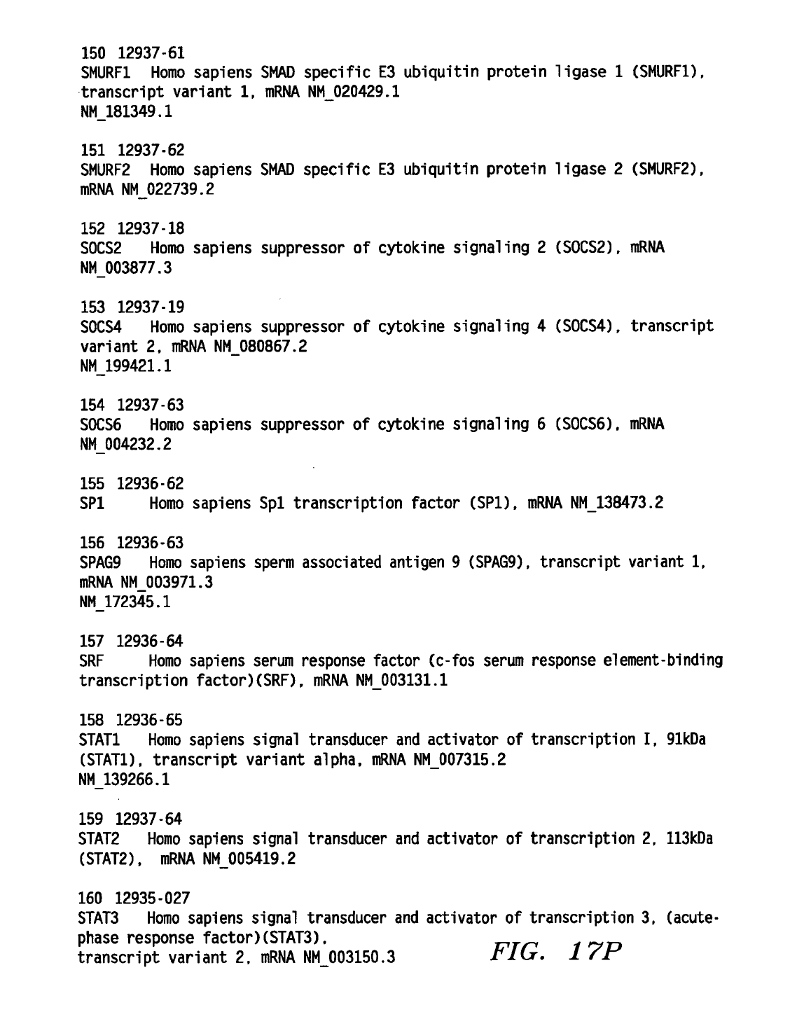

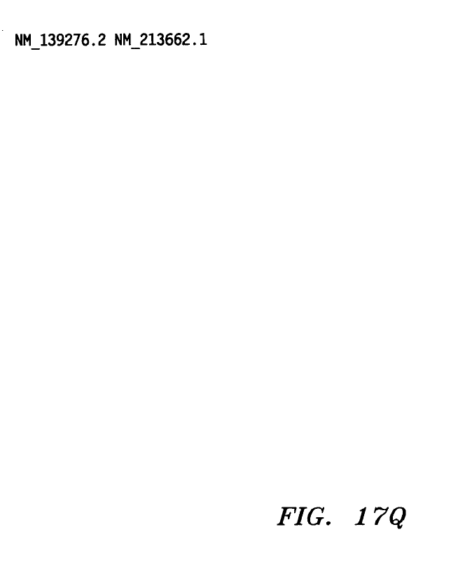

Collections of biological reagents may comprise, for example, siRNA reagents. Those of ordinary skill in the art will recognize that the present example relating to siRNA reagents may be used to exemplify collections of biological reagents that comprise, for example, other nucleic acids, proteins, and antibodies. Collections of biological reagents may comprise, for example, siRNA and siRNA reagents presented herein in FIG. 17, or any of the siRNA reagents disclosed at and linked to http address rnaidesigner.invitrogen.com/sirna/searchValidatedStealth.jsp on the date this patent application is filed, which collection is hereby incorporated by reference in its entirety. A collection of biological reagents comprising siRNA reagents may be searched, for example, by inputting a search term into an input interface or input function. Such search terms may include, for example, any term that may be used to identify the siRNA, its target, the cellular pathway comprising the target, or diseases associated with the target or the cellular pathway. Search terms may include, for example, a gene symbol, accession number, key word, locus ID, Unigene ID, catalog number, target biological molecule, target biological pathway, disease, disease pathway, disease pathway member, cellular process, or a nucleotide sequence. Examples of input search terms include NCBI gene accession numbers, such as those having formats NM_{—}130786, NM_{—}130786.2, NP_{—}570602, NP_{—}570602.2; NM_{—}000014, NM_{—}00014.3, NP_{—}000005, NP_{—}000005.1; NM_{—}000662, NM_{—}000662.4, NP_{—}000653, NP_{—}000653.3; NM_{—}000015, NM_{—}000015.1, NP_{—}000006, and NP_{—}000006.1. Examples of Unigene IDs include, for example, those having formats Hs.529161, Hs212838, Hs.155956, Hs.2, Hs.534293, Hs.546822, Hs.506908, Hs.83347, Hs.315137, Hs.336768, Hs.429294, and Hs.421202. Examples of gene symbols include, for example, those having formats ADH6, ADH7, ADK, ADORA1, ADORA2A, ADORA2B, ADORA3, ADPRH, PARP1, ADRA ID, ADRA1B, ADRA2A, ADRB2, ADRB3, ADRBK1, ADRBK2, ADSL, ADSS, AP2A1, and AP2A2.

In one example, the user may input a search term. Once the user inputs a search term, a search or sorting feature is used to identify a sub-group of siRNA reagents from the collection that are matched to or related to the particular search term. The user may be presented with, for example, any number of matched siRNA reagents, for example the most closely matched siRNA reagent, or, for example the three, five, ten, fifteen, twenty, thirty, fifty, or one hundred most closely matched siRNA reagents to the search term. These may include, for example, the siRNA reagent most closely matched with the gene symbol, and may also include, for example, the siRNA reagents associated with genes involved upstream or downstream on the same cellular pathway as the gene associated with the gene symbol. The user may select at least one of the output siRNA reagents, and is then presented with matched biological reagents from the matched biological reagent collection. The siRNA reagents and the matched biological reagents may, for example, be presented with a purchasing function comprising links to the purchase of the siRNA reagents and matched biological reagents.

In another example, the user may order a custom-designed siRNA. Upon entering the order for the custom-designed siRNA, the user if provided with a collection of biological reagents matched to the siRNA target and any pathway or cellular process that is related to the target.

### Example 2

### Collections of Biological Reagents Comprising Isolated Proteins

Collections of biological reagents may comprise, for example, isolated proteins. Those of ordinary skill in the art will recognize that the present example relating to isolated proteins may be used to exemplify collections of biological reagents that comprise, for example, other biological reagents, such as nucleic acids and antibodies. Collections of biological reagents may comprise, for example, isolated proteins from any organism, including, for example, bacteria, insects, plants, and animals. Isolated proteins include, for example, isolated native proteins, isolated recombinant native proteins, and isolated recombinant proteins with post-translational modifications. Such collections may comprise, for example, mammalian isolated proteins, or, for example, humans isolated proteins, such as those presented herein in Table 11, or any of the isolated proteins disclosed at and linked to http address invitrogen.com on the date this patent application is filed, which collection is hereby incorporated by reference in its entirety. Such collections may comprise, for example, representatives of various protein families and classes, such as those presented herein in Table 10, wherein the proteins are arranged by protein functional family. Such protein functional families include, for example, proteins associated with biological processes, behavior, cell communication, cell-cell signaling, signal transduction, development, cell differentiation, embryonic development, growth, cell growth, morphogenesis, reproduction, physiological processes, cell death, cell homeostasis, cell proliferation, cell cycle, transport, ion transport, protein transport, death, metabolism, biosynthesis, protein biosynthesis, carbohydrate metabolism, catabolism, electron transport, energy pathways, lipid metabolism, DNA metabolism, transcription, protein metabolism, protein biosynthesis, protein modification, secondary metabolism, cellular component, cell, cell envelope, cell wall, intracellular, chromosome, nuclear chromosome, cytoplasm, cytoplasmic vesicle, cytoskeleton, cytosol, endoplasmic reticulum, endosome, Golgi apparatus, mitochondrion, peroxisome, ribosome, vacuole, lysosome, nucleus, nuclear chromosome, nuclear membrane, nucleolus, nucleoplasm, ribosome, nuclear membrane, plasma membrane, extracellular, extracellular matrix, extracellular space, unlocalized, molecular function, antioxidant activity, binding, calcium ion binding, carbohydrate binding, lipid binding, nucleic acid binding, DNA binding, chromatin binding, transcription factor activity, RNA binding, nucleotide binding, protein binding, actin binding, receptor binding, catalytic activity, hydrolase activity, nuclease activity, peptidase activity, kinase activity, protein kinase activity, transferase activity, enzyme regulator activity, motor activity, signal transducer activity, receptor activity, receptor binding, structural molecule activity, transporter activity, and ion channel activity.

A collection of biological reagents comprising isolated proteins may be searched, for example, by inputting a search term into an input interface or input function. Such search terms may include, for example, any term that may be used to identify the isolated protein, the nucleic acid or gene encoding the protein, biomolecules such as proteins that bind to or otherwise interact with the protein, the protein functional family of which the isolated protein is a member, the cellular pathway comprising the protein, or diseases associated with the protein or the cellular pathway. Search terms may include, for example, a gene symbol, accession number, FASTA header, key word, locus ID, Unigene ID, catalog number, protein name, biological pathway, disease, disease pathway, disease pathway member, cellular process, amino acid sequence, or a nucleotide sequence.

In one example, the user may input a search term. Once the user inputs a search term, a search or sorting feature is used to identify a sub-group of isolated proteins from the collection that are matched to or related to the particular search term. The user may be presented with, for example, any number of matched isolated proteins, for example the most closely matched isolated protein, or, for example the three, five, ten, fifteen, twenty, thirty, fifty, or one hundred most closely matched isolated proteins to the search term. These may include, for example, the isolated protein most closely matched with the gene symbol, and may also include, for example, the isolated proteins associated with genes involved upstream or downstream on the same cellular pathway as the gene that encodes the isolated protein. The user may select at least one of the output isolated proteins, and is then presented with matched biological reagents from the matched biological reagent collection. The isolated proteins and the matched biological reagents may, for example, be presented with a purchasing function comprising links to the purchase of the isolated proteins and matched biological reagents.

In another example, the user may order a custom-designed isolated protein. Upon entering the order for the custom-designed isolated protein, the user if provided with a collection of biological reagents matched to the isolated protein and any pathway or cellular process that is related to the isolated protein.

### Protein Expression in Insect Cells

Isolated proteins may be isolated according to any method known to those of ordinary skill in the art, including, for example, isolating the native proteins from their native source, or isolating recombinant proteins by synthesizing them in vitro, or by isolating them from a recombinant source such as, for example, bacterial, plant, insect, or animal, such as mammalian, cells. Presented herein is an example of the expression and isolation of recombinant proteins from insect cells, although the isolated proteins of the matched biological reagent collections are not limited to those isolated from insect cells, or to the particular protocols presented herein.

Entry Clones Preparation and Plasmid Isolation:

E. coli cultures of human clones are inoculated into 2 ml deep well culture plates with 900 μl of 2×YT media containing 50 μg/μl Ampicillin and 50 μg/μl carbenicillin and incubated in a 37° C. floor shaker for overnight growth (220 rpm). The next day, plasmids containing hORF clones are isolated by Eppendorfs Perfectprep Plasmid 96 Vac Direct Bind kit (Eppendorf). Plasmid DNA is eluted with 70 μl of Molecular Biology Grade Water. Quality and quantity of DNA are visualized by running 5 μl of isolated plasmid DNA on a 1% E-Gel 96 agarose gel (Invitrogen).

LR Reaction into pDEST 20 Vectors:

The LR reaction is performed in a 10 μl volume in a 96-well PCR plate with the above entry clones and the destination vector pDEST20. 2.5 μl of the following mixture: 100 μl of LR reaction buffer (5× stock, Invitrogen), 50 μl of resuspended pDEST20 DNA (6 μg) and 100 μl of LR clonase (5× stock) is aliquoted into each well of a 96-well PCR plate, and 2.5 μl of the isolated entry clone plasmid is added into each well. The plate is sealed with an aluminum foil cover, spun down at 3000 rpm briefly and incubated at 25° C. overnight.

Transformation of pDEST20 LR into DH10Bac:

40 μl of DH10Bac competent cells are dispensed into each well of the 96-well plate containing the overnight LR mixture. A plate containing the cell mixture is incubated at 4° C. for 15 minutes, and then cells are heat-shocked at 42° C. for 40 seconds. After chilling, 120 μl of LB media are added to each well and the plate is incubated at 37° C. for 5 hours without shaking. At the end of the 5 hr incubation, 50 μl of cells are diluted into 500 μl of LB media containing Gentamycin (7 μg/μl), Kanamycin (50 μg/μl) and Tetracycline (12 μg/μl) in a 2 ml 96 deep well culture plate. Cultures are incubated at 37° C. overnight (12-18 hrs) with shaking at 220 rpm. The next morning, the overnight culture is diluted into 800 μl of distilled water using a 96 pin replicator. 20 μl of diluted overnight culture from each well of the 96-well plate is plated onto one Nunc square plate containing LB media plus Gentamycin, Kanamycin and Tetracycline. Plates are incubated at 37° C. overnight. The next day, two Mantis 384-well output plates with 60 μl of LB plus Gentamycin (14 μg/μl) and Kanamycin (100 μg/μl) in each well are prepared, and 8 colonies from each transformation plate are picked into each well of the output plate by the Mantis colony picker. The output plates are incubated at 37° C. overnight.

Blue-White Colony QC:

Cultures in the output plate are replicated onto a LB/Bluo-Gal agar plate using a 384 pin replicator, and plates are incubated at 37° C. for at least 1 to 2 days or until the blue color developed. The blue and white colonies are analyzed using the Alpha FluorChem 8100. Wells which have nothing growing or have either light or blue colonies are failed for the next procedure. One passed colony from each clone is selected and rearrayed from the 384-well output plate into a 96-well 2 ml deep well plate containing 900 μl of 2×YT media plus Kanamycin 50 μg/μl and Gentamycin 7 μg/μl.

Bacmid Isolation:

The culture plate is grown for approximately 20-22 hours at 37° C. with shaking at 180 rpm. The next day, bacmid DNA is isolated using Perfectprep BAC 96 kit following the manufacturer's protocol (Eppendorf). 5 μl of purified bacmid DNA is analyzed on a 1% E-Gel 96 agarose gel.

Transfection and Amplification:

Insect Sf9 cells are grown in SF-900 SFM medium supplemented with 10% (v/v) Fetal Bovine Serum (FBS) and 1% (v/v) penicillin/streptomycin, and incubated in a spinner flask at 26° C. with constant stirring at 100 rpm. On the day of transfection, cells are counted and diluted to a final cell concentration of 5×105 cells/ml in Grace's insect unsupplemented medium. 100 μl of cells are aliquoted into each well of a 96-well flat bottom tissue culture plate, and attached to the surface of the plate at 26° C. for 1 hour. Meanwhile, in a new 96-well PCR plate, the DNA and cellfectin mixture is prepared as follows:

Mixture A: 3 μl of Grace's insect medium is added into each well of a

96-well PCR plate first, then 3 μl of purified bacmid DNA from the above step is added to each well of the same plate to mix with the medium.

Mixture B: For each transfection, 0.3 μl of Cellfectin is diluted into 5 μl of Grace's insect unsupplemented medium.

After adding mixture B to mixture A, the DNA:Cellfectin mixture is incubated at room temperature for 45 to 60 minutes. After 45 to 60 minutes of incubation time, for each transfection, 50 μl of Grace's insect medium is added to the mixture of A and B. Meanwhile, Sf9 cells are washed once with 100 μl of Grace's insect medium, and finally replaced with the diluted mixture A and B (about 60 μl volume). Cells are incubated in 26° C. for 5 hours. After incubation, the supernatant which contains the transfection mixtures is removed, and is replaced with 100 μl of SF-900 SFM medium containing 10% FBS and 1% (v/v) penicillin/streptomycin. Cells are incubated at 26° C. for another 72 hours. At 72 hours posttransfection, the supernatant containing the original viruses (100 μl) is harvested and transferred into a sterile round-bottom 96-well plate. The plate is sealed and stored at 4° C. in the dark. For long term storage, viruses can be stored at (−80° C.). Original viruses are amplified once to increase the virus titer. 100 μl of Sf9 cells are plated out at 1×106 cells/ml density in each well of a 96-well tissue culture plate, and allowed to attach to the surface of the plate at 26° C. for at least half an hour. 2 μl of original virus are added to the cells, and cells are incubated at 26° C. for 72 hr. At 72 h post-infection, the amplified viruses are collected into a new sterile round bottom 96-well plate, can be stored at 4° C. or −80° C., or used directly for protein expression.

Protein Expression:

S19 cells are counted and diluted in SF-900 II SFM medium containing 10% FBS+1% penicillin/streptomycin to a final cell density of 2×106 cells/ml. 600 μl of Sf9 cells are aliquoted into each well of a 96-deep well cell culture plate, and 6 μl of the amplified viral stock are added to the wells. The plate is sealed with a Microporous sealing film which allows compressed air to permeate during incubation, and is loaded into the Higro™ cassette. The Higro™ is run at 26° C. with shaking at 450 rpm for 72 hours.

Protein Purification:

Boxes are lysed using a Harbil paint shaker for 30 seconds in 650 μL Tris lysis buffer with protease inhibitors, incubated shaking for 15 mins then lysed again for 30 secs. Lysates are clarified by centrifugation. 38 μL of glutathione-Sepharose 4B (GE Healthcare) is added, incubated at 6° C. for 1 hr with shaking, the slurries transferred to 96 well PVDF filter plates (Whatman) then washed twice with 200 μL of HEPES wash buffer 1 and twice with 200 ul HEPES wash buffer 2. Proteins are eluted with 65 μL of Elution Buffer and consolidated into 384 well plates (Greiner, polypropylene/flat-bottom).

Western QC Sample Preparation:

At the end of expression period, 50 μl of cells from each well of the deep well culture plate are transferred into a new 96-well PCR plate. Cells are spun down, lysed in the lysis buffer and ready for further analysis as whole cell lysate. After proteins are purified, 10 μl of the purified protein is transferred into a new 96-well PCR plate. 10 μls of 2×SDS sample buffer are added to each well, and boiled in a PCR machine for 10 minutes.

SDS-PAGE:

The purchased precast gels are prerun at 150 volts for 30 minutes. Each gel has 26 lanes, therefore, 10 μls of the denatured purified proteins from two rows of the 96-well plate are loaded to the same gel using a 12-channel pipetman. On the same gel, 10 μl of the pertained protein molecular weight marker and the 10 μl of standard GST proteins (10 μg/μl) are loaded onto two separate lanes. Gels are run at a constant voltage of 150 volts for 1 hour or until the bromophenol blue marker dye is near the bottom end of the gel.

Blotting:

Each nitrocellulose membrane is labeled and soaked in the transfer buffer for a few minutes along with the Whitman 3 MM paper. The precast gel is opened, a nitrocellulose membrane is placed on top of the gel, and two Whatmann 3 MM paper are placed on each side of the gel-membrane. The gel sandwich is placed on the surface of the Semi Dry blotting apparatus with the nitrocellulose membrane on top of the gel. The electroblotting is performed at a constant current 250 mA for 20 minutes for each gel sandwich. After blotting, the apparatus is dissembled, and the membranes are probed immunochemically as described as follows:
Non-specific protein binding is blocked by incubating the membrane in blocking buffer (TBS, 0.5% Tween and 5% dried milk) for 2 hours at room temperature or overnight at 4° C.
Blocking buffer is discarded, and the membrane is incubated with primary antibody (Rabbit polyclone GST, 1:5000 dilution) in Blocking buffer for 1 to 2 hours at room temperature or overnight at 4° C.
Membrane is washed with Washing buffer for three times with 15 minutes of wash for each
Membrane is incubated with second antibody (1:5000 dilution for HRP conjugated goat antirabbit IgG) in TBS, 0.2% BSA for 1 to 2 hours at room temperature
Membrane is washed with washing buffer again for 3 times with 15 minutes of wash for each

Developing Membrane:

After the third wash of the membrane, it is ready for developing. Excess of washing buffer from the membrane is blocked by putting it on a paper tower for 5 seconds. A small piece of RADTape is placed on the side of prestained molecular weight marker on the membrane, the position of each band on the marker is manually marked on the tape. On a clean surface of a transparency sheet, 170 μl of solution A of the SuperSignal West Pico Maximum Signal substrate is mixed with 170 μl of solution B. The membrane is placed on top of this mixture, making sure it is covered by the solution completely. The membrane is scanned in the Alpha Innotech Fluoro Chem Apparatus, and the image is saved to a database.

Western QC Data Analysis:

The Western blot image is loaded into Western Kodak 1D 3.5 software, and analyzed by the software. Based on the size of proteins on the molecular weight marker, the size of each band for each protein on the image is calculated by the software. All the data file is saved and uploaded into ProtoMine, and proteins are passed or failed Western QC based on the following criteria:

1. If the calculated molecular weight is within the 20% range of the predicted molecular weight, it is passed.

2. If the calculated molecular weight is above the 20% range of the predicted molecular weight, it is passed.

3. If the calculated molecular weight is below a 23% range of the predicted molecular weight, it is failed.

4. If a strong protein band is observed at the expected molecular weight for the GST tag, it is failed.

5. If no protein band is observed from Western blot, it is failed.

Concentration QC—The concentrations of human proteins are measured using microarrays. Human proteins and controls are printed on S&S FAST slides. The arrays are probed with anti-GST antibody followed by Alexa Fluor 647 antibody. The protein concentrations are derived from a GST standard gradient on the array and the spot intensities of the human proteins.

### Example 3

### Example of a Biomolecular Pathway Search

For purposes of illustration of a biomolecular pathway search, the calcium signaling pathway is used in the present example, the present invention is not limited to any particular pathway. Calcium (Ca²⁺) is a potent signaling molecule that is involved in many different cellular responses. Following receptor activation, members of the phosphatidylinositol-specific PLC (PI-PLC) family hydrolyze phosphatidylinositol 4,5 bisphosphate (PIP₂) to generate inositol 1,4,5 triphosphate (IP₃) and diacylglycerol (DAG). IP₃ initiates the release of intracellular Ca²⁺ from the endoplasmic reticulum. Extracellular Ca²⁺ influx is subsequently triggered through the activation of Ca²⁺ release activated Ca²⁺ channels (CRAC) by a process called capacitative Ca²⁺ entry.

Calmodulin, an intracellular Ca²⁺ sensor, binds to Ca²⁺ and activates the serine-threonine phosphatase calcineurin. Calcineurin dephosphorylates serine residues on the N-terminus of NFATc transcription factors activating nuclear translocation. In the nucleus, NFATc proteins bind to DNA in conjunction with other associated transcription factors (NFATn) to regulate gene expression. Another protein family that is regulated by Ca²⁺ and DAG is protein kinase C (PKC). PKC is a serine-threonine kinase that regulates many different cellular processes including cell cycle, proliferation, differentiation, cytoskeletal organization, migration, and apoptosis. The PKC enzyme family includes three subgroups corresponding to conventional (α1,β1,β2,γ), novel (δ,ε,η,θ,μ), and atypical isoforms (ζ,λ). Although only the conventional PKC isoforms are activated by Ca²⁺, both the conventional and novel PKC isoforms are activated by DAG.

A user that requires products from a database related to the calcium signaling pathway may enter search terms related to this pathway. For example, the user may enter the term “calcium signaling pathway.” As a result of that search, the output may be, for example, all members of the biological reagent collection that match that pathway. For example, the output may include nucleic acids, proteins, siRNA reagents, antibodies, and cell lines expressing at least one of phosphatidylinositol-PLC, calmodulin, calcineurin, NFAT, and protein kinase C, as well as assay reagents such as phosphatidylinositol 4,5 bisphosphate (PIP₂), cell culture products, detection products, assay kits, enzymes, enzyme substrates, separation media, specific microarrays, and other matched biological reagents.

In one example, the user may first be presented with the name of the pathway members, wherein the pathway members are each linked to other matched biological reagents to that pathway member. Or, the user may input just one member of the pathway, for example, “calcineurin” and either obtain as output all the information and links for the pathway, or just members of the pathway and matched biological reagents related to calcineurin. In another search, the user may input the name of a disease in which the calcium signaling pathway is implicated, and receive as output the biological matched reagents for the pathway.

### Example 4

### Example of a Disease Pathway Search

For purposes of illustration of a disease pathway search, a search term related to a particular disease may be inputted. It is understood, however, that the present invention is not limited to any particular pathway. For example, upon inputting the keyword “Alzheimer's” in a search related to biological elements involved in a pathway implicated in Alzheimer's disease, the output may be, for example, all members of the biological reagent collection that match that pathway. For example, the output may include nucleic acids, proteins, siRNA reagents, antibodies, and cell lines expressing at least one of acyl carrier protein, acyl-ACP synthetase, ApoE2, ApoE1, ApoE3, BACE1, GGTase-1, Rac-1, Ras, Rab, Tau, and VEGF. The output may also include assay reagents such as cell culture products, detection products, assay kits, enzymes, enzyme substrates, separation media, specific microarrays, and other matched biological reagents. In one example, the user may first be presented with the name of the pathway members, wherein the pathway members are each linked to other matched biological reagents to that pathway member.

### Example 5

### Example of Graphically-Integrated Biological Pathway or Function Search

To increase the ease by which a customer accesses biological reagents, visual links representing various biological reagents may be presented in a graphic form as part of a biological pathway. This example presents method of selling where biological reagents, such as the matched biological reagents of the present application, are presented to the customer in a biologically relevant context. Customers are presented with a graphical representation of a biological pathway, for example, a biological pathway map, and customers may then navigate across pathways to individual genes, then to related products. Furthermore, customers can use a search function, which is part of the input function, to query a database of matched reagent identities and characteristics using a number of search criteria (e.g., keyword, gene name, gene symbol, Gene ID), to identify not only biological reagents that are related to one another in a structural and/or biological context, but also to identify pathways that involve these biological products. The customer may therefore query the database and identify, for example, one or more genes, proteins, or pathways of interest. The genes, proteins, other biological reagents, or pathways, may also, for example, be linked to functional annotations, such as, for example, those provided by the seller, or those that may be publicly available. Once a customer is presented with an input function for identifying a target biological molecule or pathway, and provides input information, the customer may be presented with a purchasing function. The purchasing function may, for example, comprise a graphical representation of a biological pathway comprising the target biological molecule. The graphical representation may, for example, comprise at least one visual link, where the visual link is related to a purchase function of one or more biological reagents related to the target biological molecule. Graphical representations of biological pathways may be obtained from any source known to those of ordinary skill in the art, and, for example, from GeneGo, Inc. (500 Renaissance Drive, Suite 106, St. Joseph, Mich. 49085; world wide web address www.genego.com).

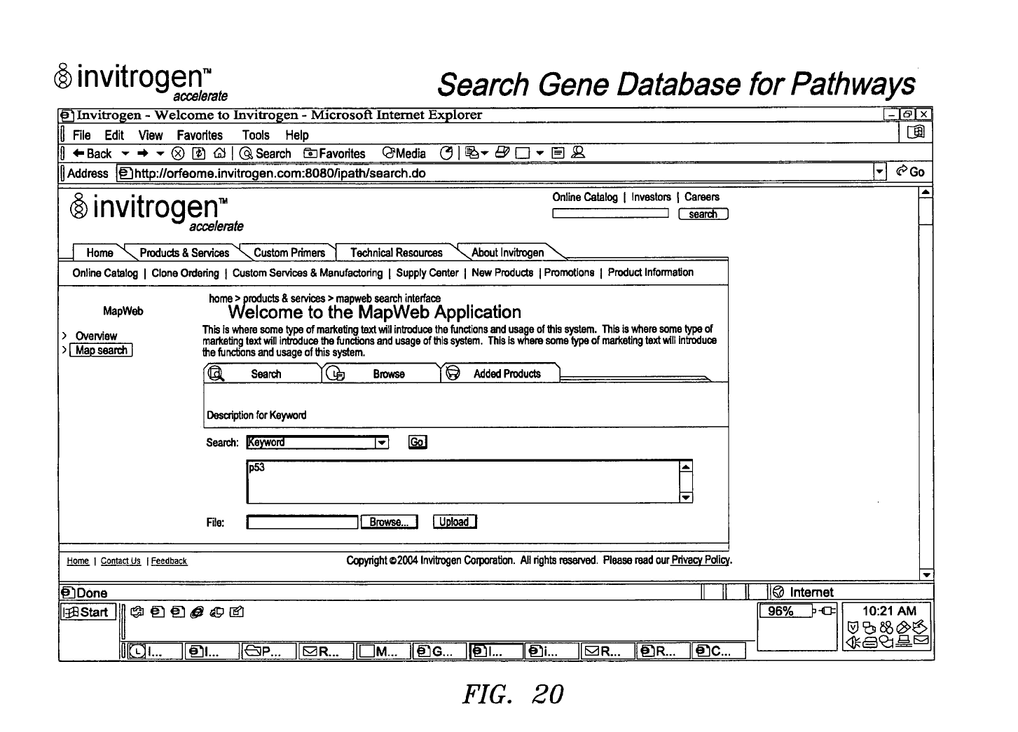

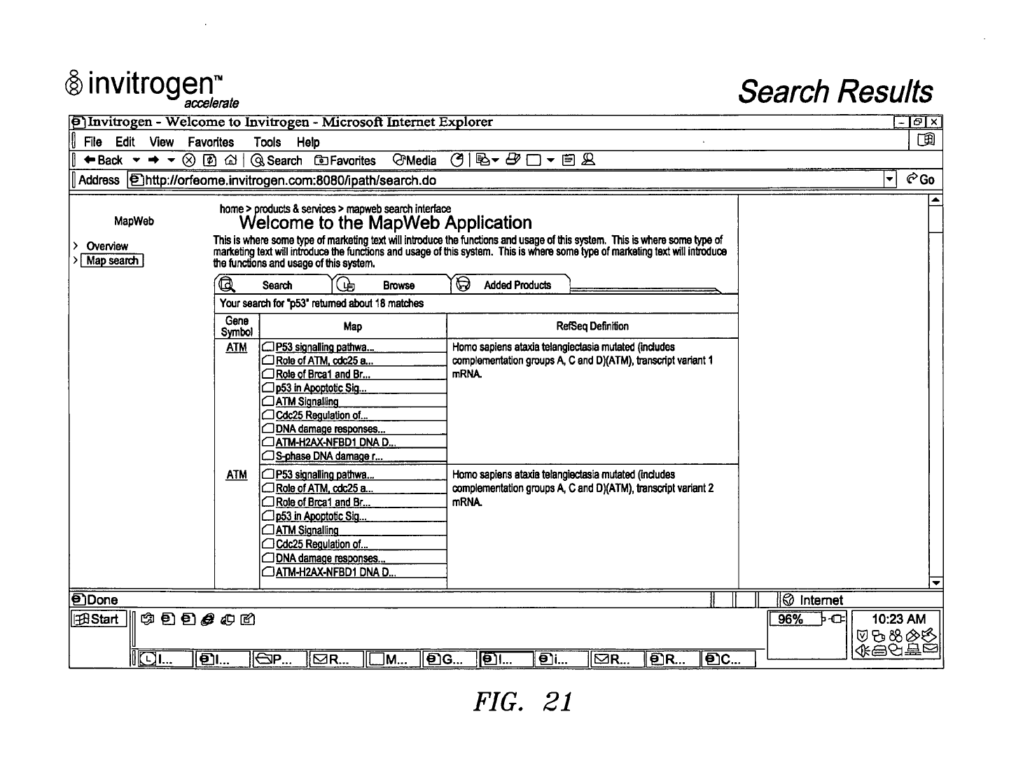

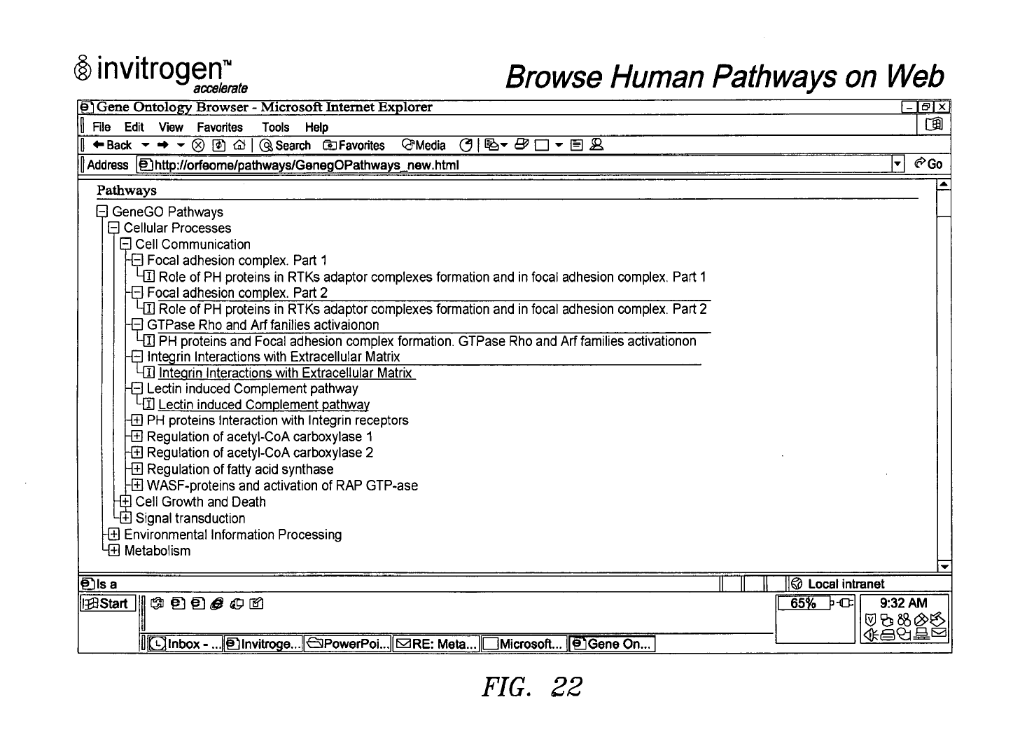

In this example, the customer is presented with an input page for searching a database of information related to collections of biomolecules and pathways involving those biomolecules (FIG. 20). The type of input information may include any identifier sufficient to identify a particular target biomolecule or biological pathway, and may include, for example, any identifier of the present application. Further, the input information may include data obtained from protein or DNA expression arrays. The customer then enters the input information into a window. Using this method, a customer may, for example, upload a file including, for example, DNA expression array data, and the data will be mapped to proteomics pathways that are related to the particular target molecules that the data indicates are expressed. The customer may also browse the lists of target biomolecules that are available or link to products in the customer's shopping cart. Once the search has been performed and target biomolecules and pathways have been identified from the databases, the user may identify specific pathways relevant to the user's research from a listing of search results that displays, for example, gene name, pathway name and gene description. (FIG. 21). The graphical representation of these specific pathways then include at least one visual link related to a purchase function of one or more biological reagents related to the target biological molecule. The customer may also browse through a list of biological pathways or functions that may have related biological reagents (FIG. 22).

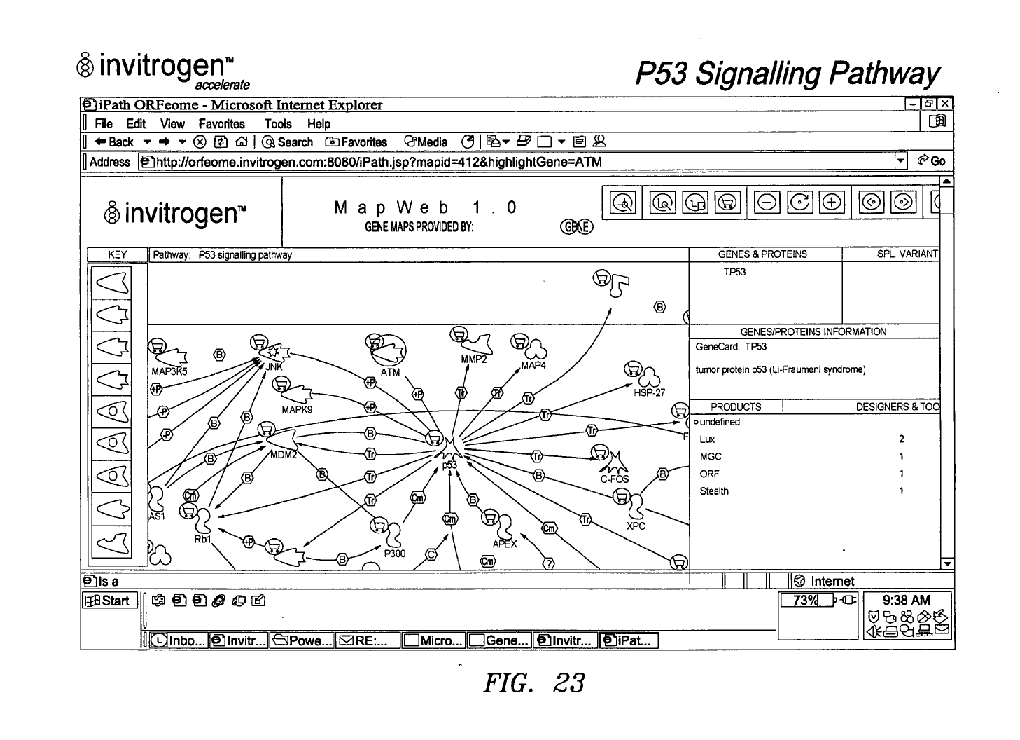

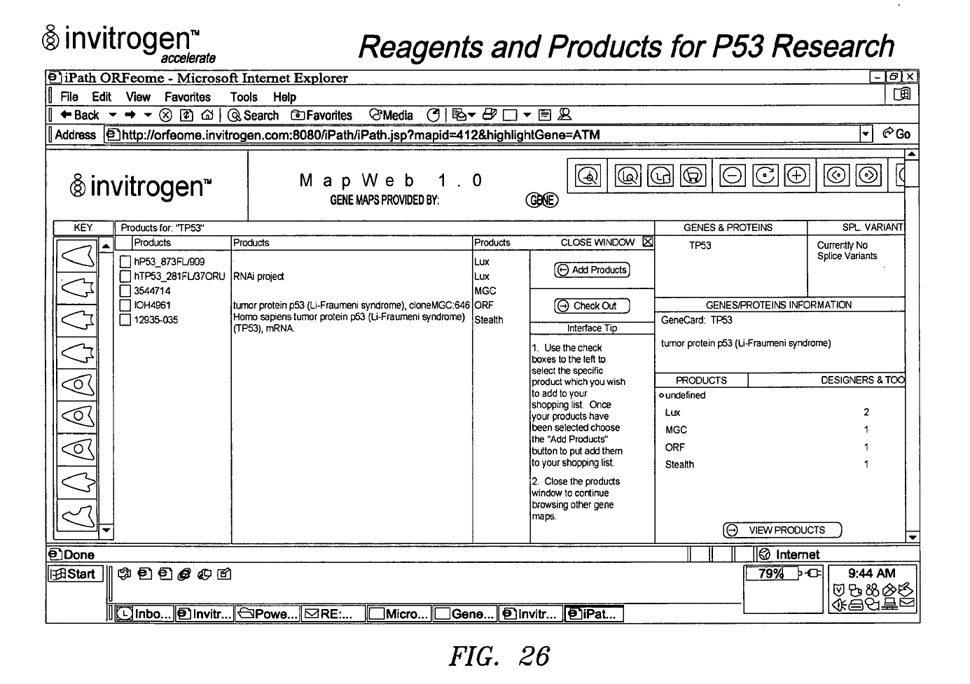

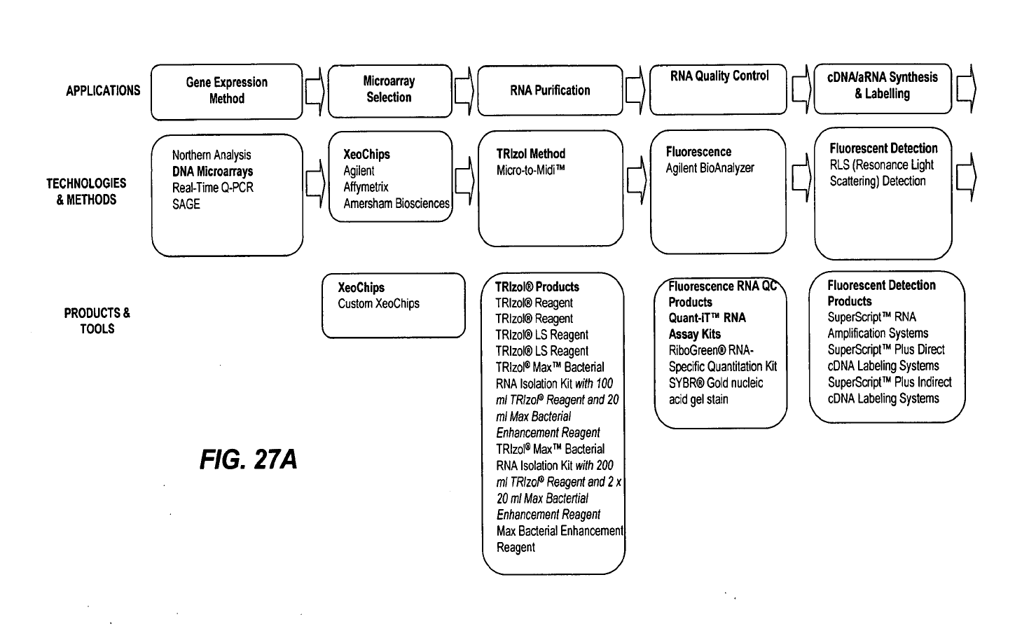

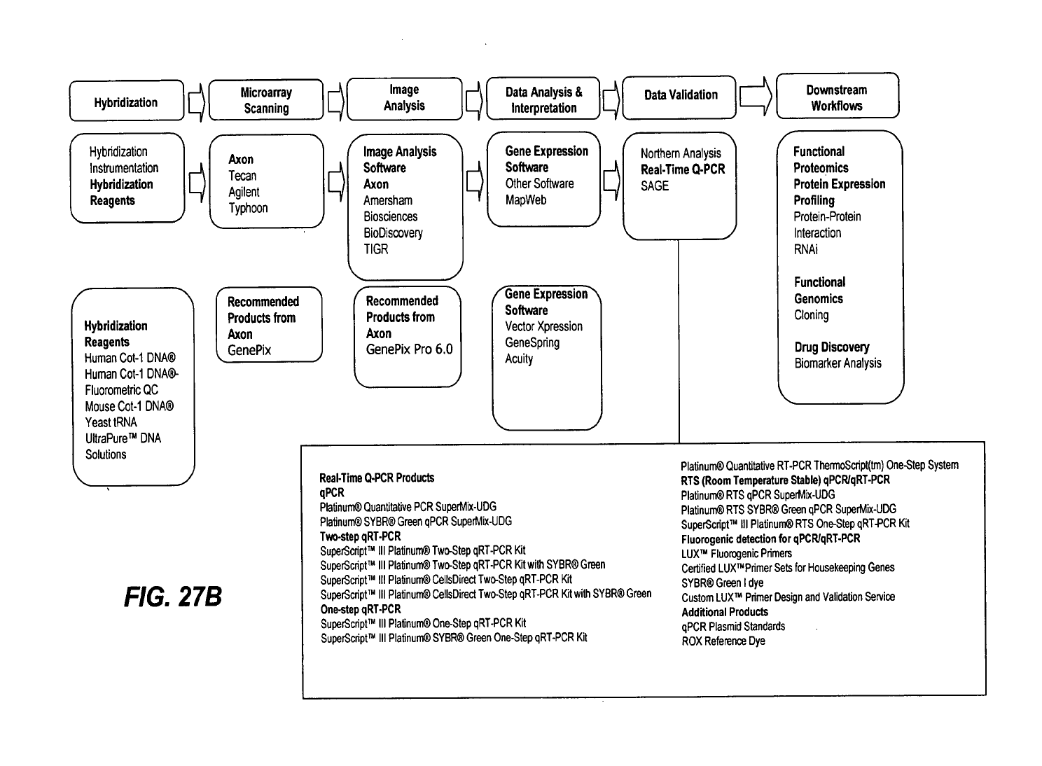

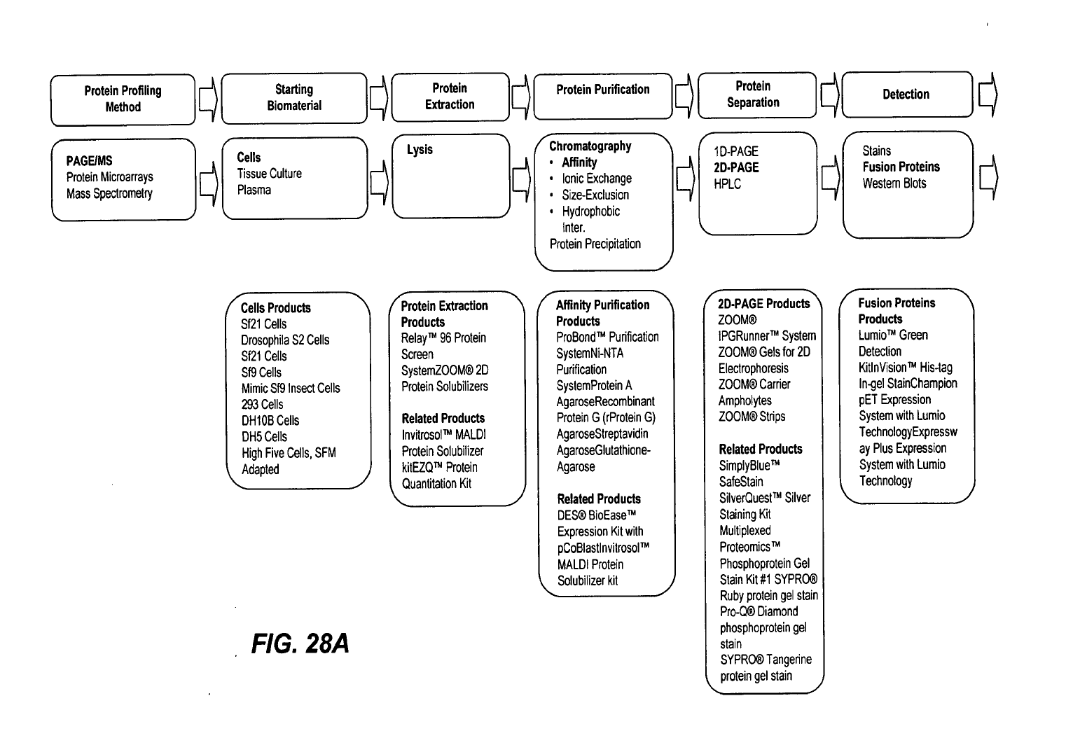

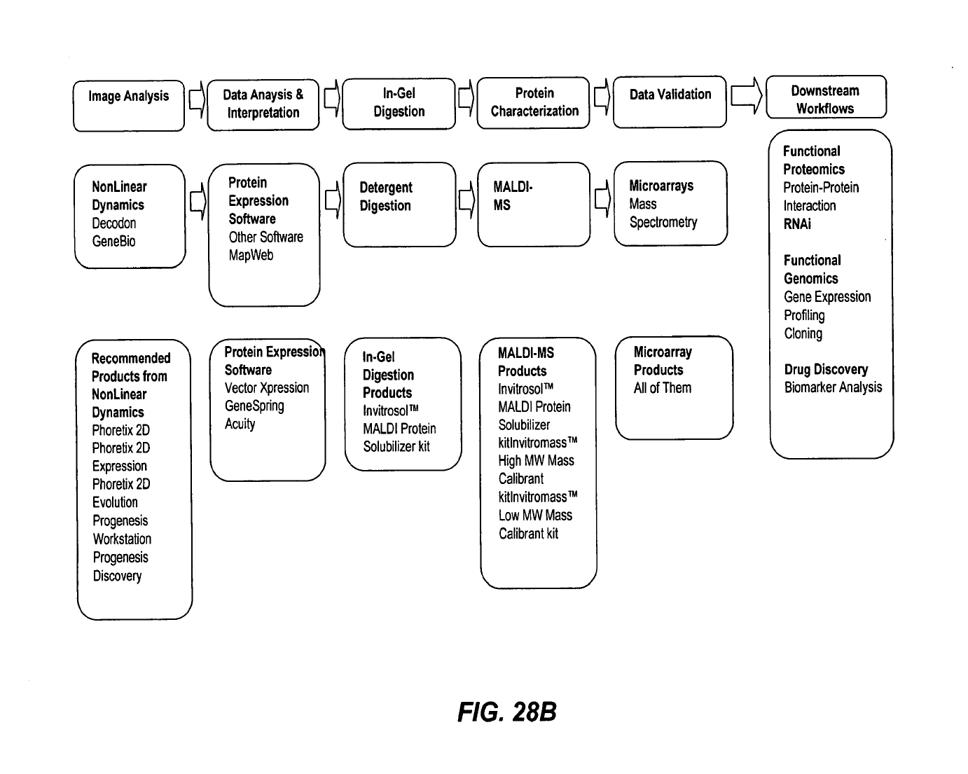

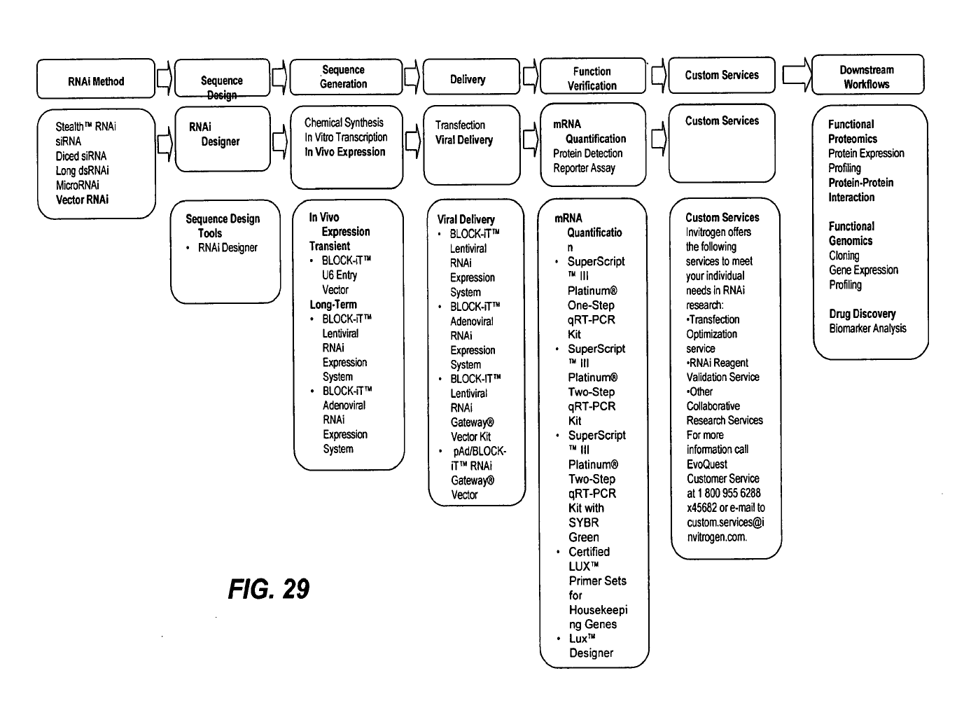

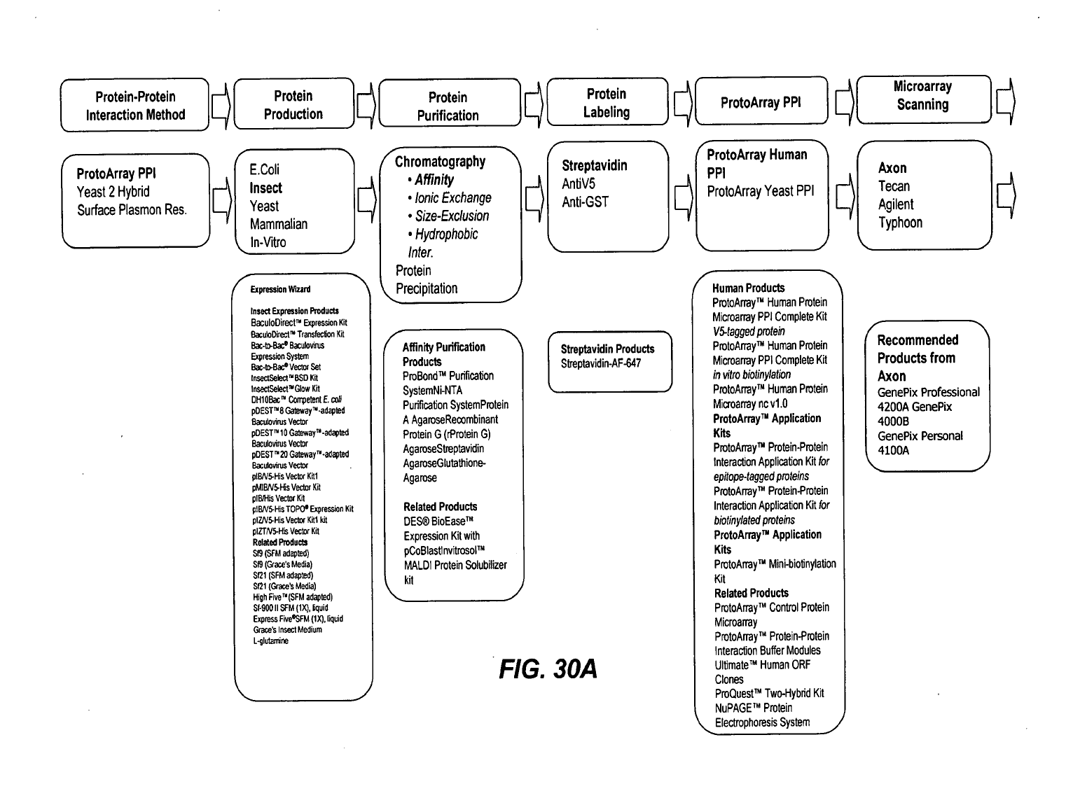

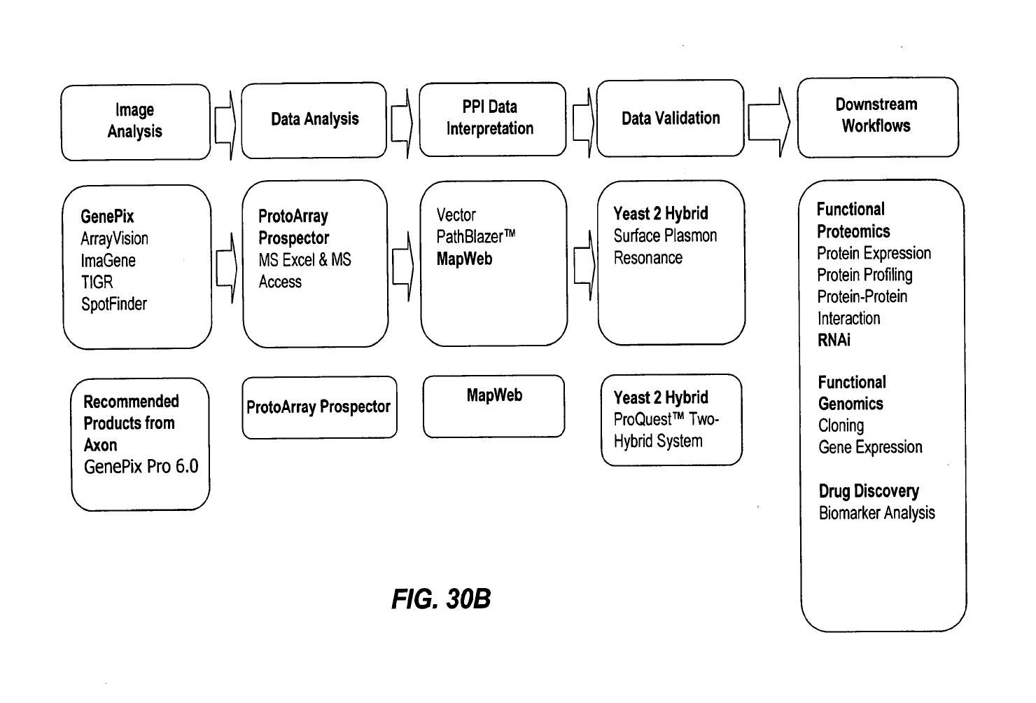

Clicking on the pathway name on one of the previously described displays, opens a display of a biological pathway map that illustrates the molecules, such as genes and proteins involved in a target pathway and the interactions between them. Furthermore, where the output information is in the form of a biological pathway map, the map may, for example, be displayed in an interface in which the customer may zoom in on a particular section, or zoom out, and, for example, in a form that is scrollable (FIG. 23). The map may display symbols related to particular target biological molecules, such as gene symbols, based on user preferences. For example, any of the various names or identifiers used to indicate a particular target biological molecule, may be used on the map. The user may have an option where all genes with associated products and tools may be highlighted, or, the user may request that only genes with specific associated products and tools be highlighted. For example, a user could select to highlight only those genes on the map that have associated clones in the collection of biological reagents. In one example, the user may access the information associated with the visual links for the various target biological molecule symbols by using a computer mouse. In this method, single mouse clicks may, for example, provide a brief gene description box, whereas full gene descriptions are accessible from the brief gene description box. The full gene description box would, in this example, then display the various biological reagents that may be purchased, or be linked to a product page (FIG. 26). The brief gene description box may also be linked to a product page. In some cases, where many biological reagents are available, the full gene description box may provide summary information about the biological reagents, and then link to more specific pages for various biological reagents.

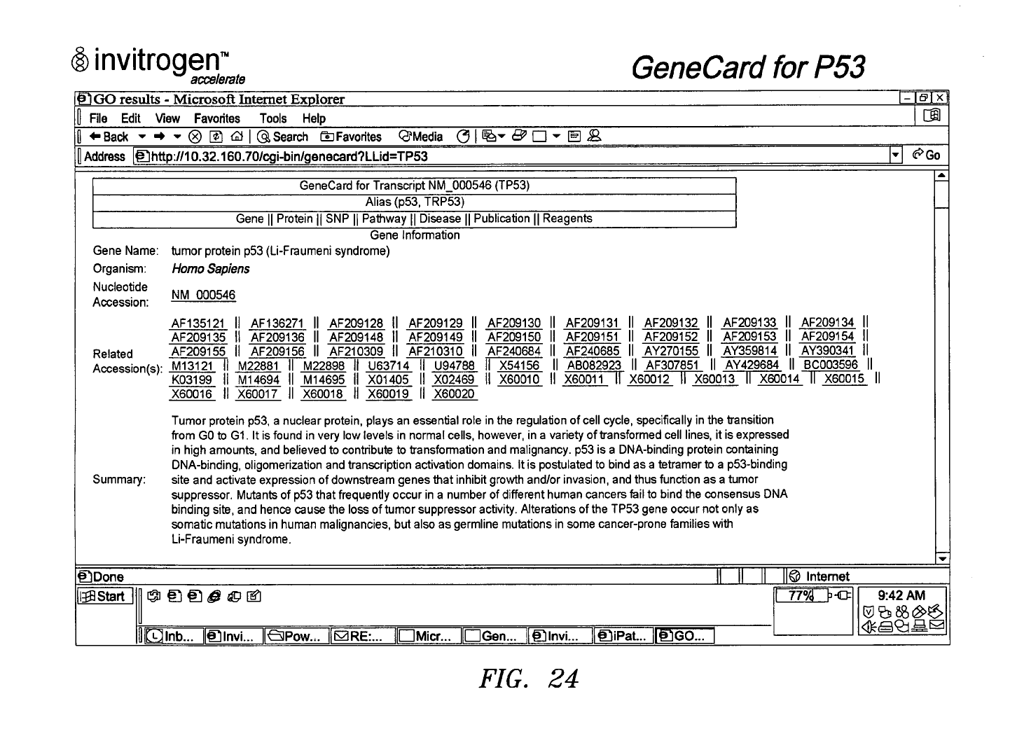

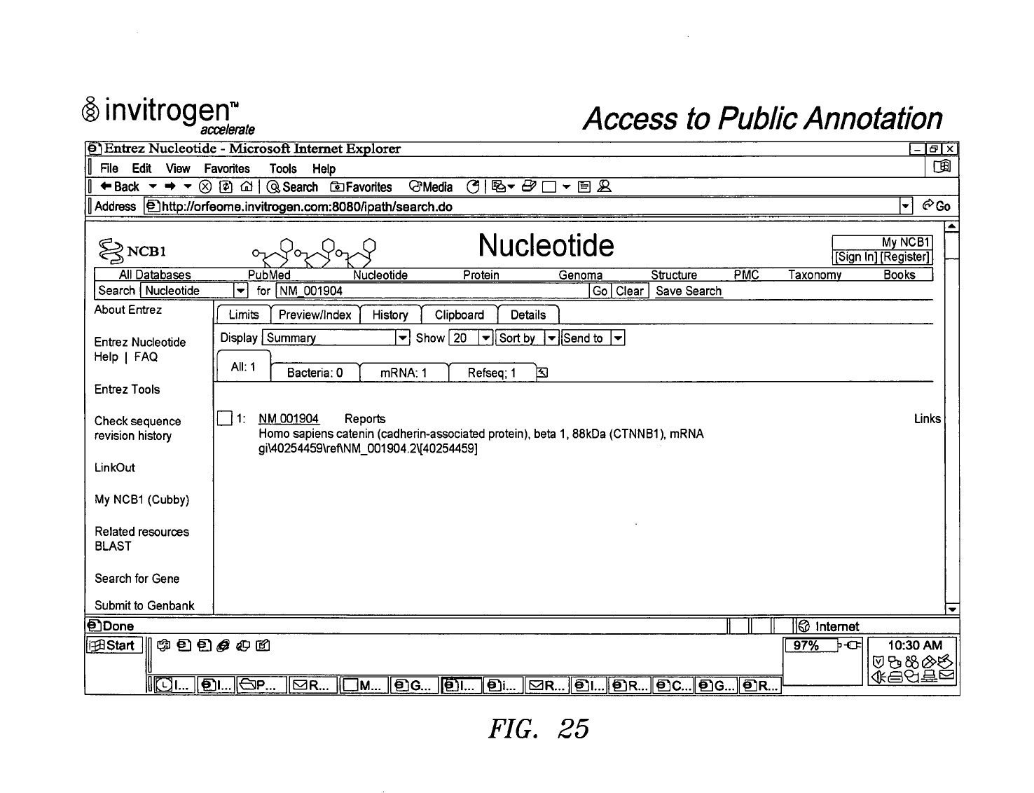

The target biological molecule visual links may be linked to functional annotations, such as those displayed in FIG. 24 or 25. FIG. 24 illustrates a GeneInformation or GeneCard page that summarizes much of the public information available for a target gene that serves as reference material for that gene. The page can include one or multiple links to one or more external web sites.

Users may have the option of storing their target biomolecules, pathways, or search results of interest on the database, such as, for example, the shopping cart database or other database associated with the customer identification function, for later review of associated maps and available products and services. The seller may also track the user's searches or purchases in order to market other related products to that user.

In one example, the customer may desire to purchase biological reagents related to protein p53. As shown in FIG. 20, the customer may input any keyword or identifier of p53 to search the database of information regarding collections of matched reagents, including inputting array data or a nucleotide or protein sequence. The customer is then presented a page indicating various biological pathway maps that include p53 as a component, as shown in FIG. 2L Upon clicking on one of the links to a biological pathway map, the customer is presented with a map of that pathway, with hyperlinks to various biological reagents (FIG. 23). Clicking on one of the visual links of the pathway results in an output of functional annotations (FIGS. 24 and 25). Functional annotations may include, for example, information about the gene and its potential or known function. This annotations page may be linked to a product page, or the pathway visual link may be linked to a product page, for example, as shown in FIG. 26. The product page provides links to a purchasing function. Accordingly, the customer may then select a product from the product page, add it to a shopping cart, and purchase the product, which the seller may then ship to the customer.

### Example 6

### Database Systems

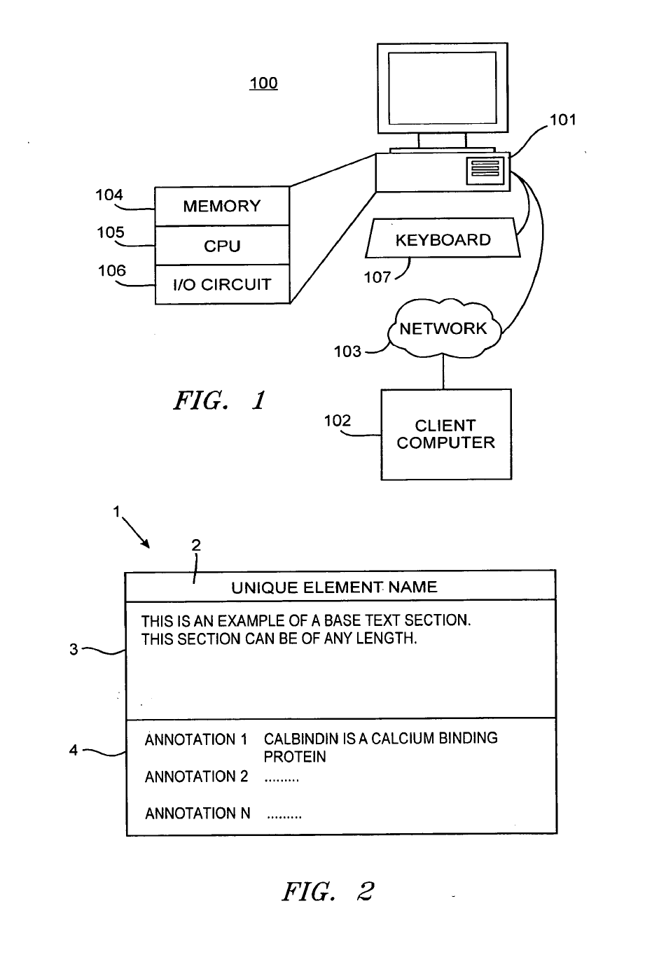

It will be appreciated by one of ordinary skill in the art that computer 101 can be part of a larger system (FIG. 1). For example, computer 101 can be a server computer that is in data communication with other computers. As illustrated in FIG. 1, computer 101 is in data communication with a client computer 102 via a network 103, such as a local area network (LAN) or the Internet.

In particular, computer 101 can include session tracking circuitry for performing session tracking from inbound source to net sale in accordance with the teachings of the present invention. In one embodiment, as will be appreciated by one of ordinary skill in the art, the present invention can be implemented in software executed by computer 101, which is a server computer in data communication with client computer 102 via network 103 (e.g., the software can be stored in memory 104 and executed on CPU 105), as further discussed below.

The present invention may be implemented using hardware, software or a combination thereof and may be implemented in a computer system or other processing system. An example computer system 100 is shown in FIG. 1. The computer system 100 includes one or more processors. A processor can be connected to a communication bus. Various software embodiments are described in terms of this example computer system. After reading this description, it will become apparent to a person skilled in the relevant art how to implement the invention using other computer systems and/or computer architectures.

Computer system 100 also includes a main memory, e.g., 104, preferably random access memory (RAM), and can also include a secondary memory. The secondary memory can include, for example, a hard disk drive and/or a removable storage drive, representing a floppy disk drive, a magnetic tape drive, an optical disk drive, memory card etc. The removable storage drive reads from and/or writes to a removable storage unit in a well-known manner. A removable storage unit includes, but is not limited to, a floppy disk, magnetic tape, optical disk, etc. which is read by and written to by, for example, a removable storage drive. As will be appreciated, the removable storage unit includes a computer usable storage medium having stored therein computer software and/or data.

In alternative embodiments, secondary memory may include other similar means for allowing computer programs or other instructions to be loaded into computer system 100. Such means can include, for example, a removable storage unit and an interface device. Examples of such can include a program cartridge and cartridge interface (such as that found in video game devices), a removable memory chip (such as an EPROM, or PROM) and associated socket, and other removable storage units and interfaces which allow software and data to be transferred from the removable storage unit to computer system 100.

Computer system 100 can also include a communications interface (106). Communications interface allows software and data to be transferred between computer system and external devices. Examples of communications interface can include a modem, a network interface (such as an Ethernet card), a communications port, a PCMCIA slot and card, etc. Software and data transferred via communications interface are in the form of signals, which can be electronic, electromagnetic, optical or other signals capable of being received by communications interface. These signals are provided to communications interface via a channel. This channel carries signals and can be implemented using wire or cable, fiber optics, a phone line, a cellular phone link, an RF link and other communications channels.

In this document, the term “electronic storage medium” is used to generally refer to media such as removable storage device, a hard disk installed in hard disk drive, and signals. These computer program products are means for providing software to computer system 100.

Computer programs (also called computer control logic) are stored in main memory and/or secondary memory. Computer programs can also be received via communications interface. Such computer programs, when executed, enable the computer system to perform the features of the present invention as discussed herein. In particular, the computer programs, when executed, enable the processor to perform the features of the present invention. Accordingly, such computer programs represent controllers of computer system 100.

In an embodiment where the invention is implemented using software, the software may be stored in a computer program product and loaded into computer system 100 using removable storage drive, hard drive or communications interface. The control logic (software), when executed by the processor, causes the processor to perform the functions of the invention as described herein.

In another embodiment, the invention is implemented primarily in hardware using, for example, hardware components such as application specific integrated circuits (ASICs).

Implementation of the hardware state machine so as to perform the functions described herein will be apparent to persons skilled in the relevant art(s).

In yet another embodiment, the invention is implemented using a combination of both hardware and software. In addition, the data computer system preferably includes a display, which can be any device for displaying (101) information in a graphical form, a keyboard (107), which can be any device for inputting characters, and a mouse with a button, which can be any device for indicating screen position.

As envisaged by the present invention, the computer system possesses a database comprising matched biological reagent information of the present invention. In a related aspect, the choice of properties possessed by particular fields may include fields which are searchable and displayable or displayable only.

In a related aspect, the database is parsable. Parsing is the manner in which information is divided for searching. In a further related aspect, parsing may be viewed in at least one of two ways. One way is word-for-word (word parsing) where the computer breaks at every space. For example, with a title such as “The Electronic Mail Box,” the computer would break after “The,” “Electronic,” “Mail,” and “Box.” Thus, each word would be searchable. Further, with word parsing systems, the computer can be programmed to ignore words such as “the,” “of,” and, “but,” etc. Moreover, a hyphenated word may be read as a single word by the computer, so the text must be impeccably consistent if the system is to operate effectively.

A second method is phrase parsing. In this system, the breaks occur only where indicated “break.” The break indicator, or subfield delimiter, determines where each phrase is to be broken. Phrase parsing solves the problem of double-word descriptors. Within these breaks the information must be consistent in order to facilitate searching. Also, as envisaged by the present invention, a system can be programmed for both word and phrase parsing to make searching more extensive and complete.

Alternatively, a Boolean expression may be supplied by the user to retrieve files from the database (see, e.g., U.S. Pat. No. 4,384,325). For example, such an expression would involve a process of arithmetically comparing fields of records within a database to corresponding fields of records containing reference words in order to derive arithmetic, logical comparisons. The comparison results would be compared to inputs of a user supplied Boolean expression (e.g., those that contain AND, OR, AND NOT, etc.) to determine if the comparisons satisfy the user supplied Boolean expression. In one embodiment, there would be a corresponding indication where a Boolean expression hit is determined based on identification of an appropriate record and a separate indication as a Boolean expression miss whenever the Boolean expression is not satisfied upon determining the comparison.

The present invention may be embodied in a software program residing on a data processing system operating under Unix and/or Windows operating systems. In one embodiment, the software program is written in the perl, C, C++, C# and Java programming languages and uses the relational database management system, as the data storage.

According to the present invention, the data processing system receives a query, such as a natural language query, from a user and displays the terms of the query on a display screen. Each term is preferably displayed surrounded by a box. A displayed term and its surrounding box is called a “tile,” although the term “tile” should not be limited only to the use of a box surrounding a term. Instead, a “tile” refers more generally to a graphical representation corresponding to a displayed query term.

The data processing system, as envisaged, also preferably includes a dictionary and a thesaurus stored in another auxiliary memory, which is preferably an external hard disk drive, but could also be an external CD ROM or similar device. The dictionary contains a list of words that can be used, for example, as terms in the Boolean query and identifies the part of speech for each of the words. The words may be stored in the dictionary in “citation form,” which is a morphologically uninflected form that is related to a number of variations of the term. For example, the term “copy” may be preferably stored in the dictionary and identified as either a verb or a noun. The memory includes morphological rules to change words such as “copied,” “copies,” and “copying” to their citation form of “copy” before they are looked up in the dictionary. Similarly, certain query terms using lower case letters are stored in the dictionary with a citation form having all capital letters. Thus, “sql” would be stored as “SQL.” Such a system maintains a list of morphological rules for shortening words to their citation forms in memory and a list of parse rules for syntactic analysis in memory.

Target items and queries may be associated with tags as flags for generating and sending notices, such as a single flag to trigger notification of non-user managers/systems (e.g., sales, manufacturing, news release, IT maintenance and security, accounting, financial management or support etc.). In a related aspect, multi-flag notices are envisaged, where a set of flags is associated with target items or queries, which then trigger such notification as above. In a further related aspect, override flags such as not to notify a security function when for example, the query is from a specific source or list of sources. In another related aspect, the multi-flag tagging involves the use of a decision tree to determine which if any of the non-user managers/systems are to be notified.

A thesaurus stores lists of words related to citation terms. The related words preferably include more specialized/more general words, lists of synonyms, alternative terms and lists of related terms. The exact organization of both the dictionary and thesaurus is not important to the present invention. Any organization that will accommodate the invention may be used.

In a related aspect, most files, such as those produced by the large time-sharing vendors, have what is known as a “basic index,” or “default file.” This file index consists of the basic controlled term vocabulary as well as terms preceded by their categorical mnemonics, such as OR for “organism,” NA for “nucleotide accession,” GN for “gene name,” or RF for “references.” In one embodiment, searching can be processed using the mnemonic tags or codes or through general, or natural language terms. In one embodiment, for each index an inverted file is created. The advantage of an inverted file is its speed.

In one embodiment, the database comprises sets of named annotated text strings. Each element of the set is defined (e.g., unique identification, base text, etc.). Annotations can be applied to any element of the set (e.g., base text).

An example of data set entry is illustrated in FIG. 2. The entry 1 comprises a unique element (identification) name 2, a base text section 3, and an annotation section 4.

In another embodiment, further additional indexing may be attached. For example, providing full-text searching in addition to a basic index. Such a full-text search increases the coverage of the search. In a related aspect, the search can be absolutely scoped (limited to only certain parts of a site) or scoped to a topic, category or idea.

“Dialog box” refers to sub-widows that open to provide a user with a set of options from which to choose. The dialog box may contain control options that are split into two or more tabs. Tabs may include, but are not limited to Search By Sequence, Search By Keyword/ID, Browse By Ontology and ORF FAQs (Frequently Asked Questions). Further, the dialog box may contain one or more buttons that present the user with two or more mutually exclusive options. For example, to limit search to human or mouse species for a sequence search, a user may check the appropriate button in the dialog box prior to search.

Right-clicking and shortcut menus are available, to get quick hints about what an item is or what it can do to view its shortcut menu. The short cut menu can offer a list of options e.g., properties, printing, open a new window, save target as, add to favorites, define how item functions and/or proper method of interfacing by user.

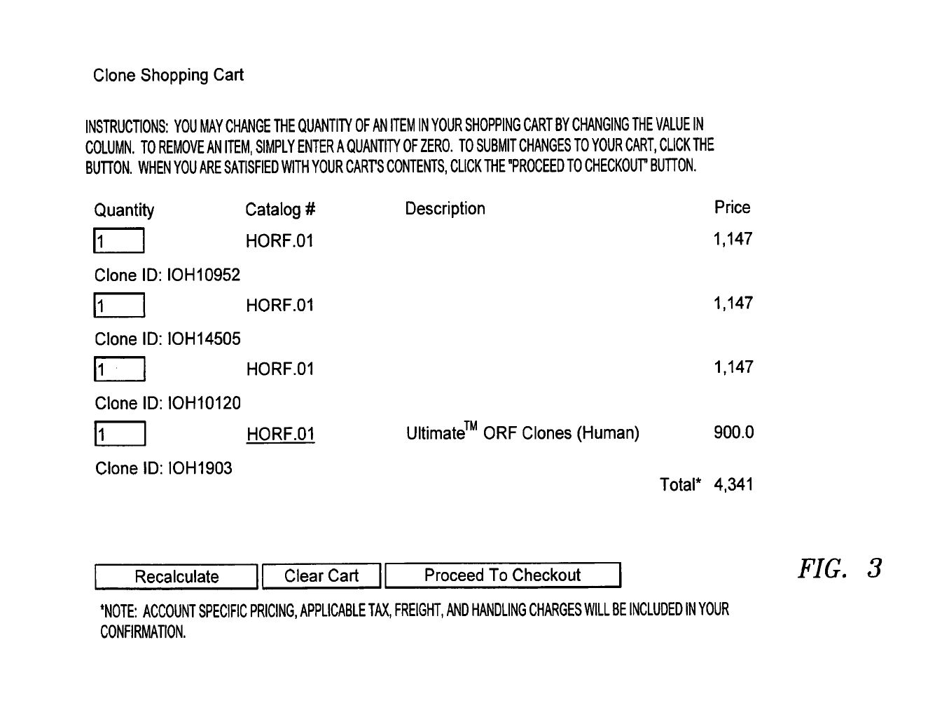

The user interacts with the system through a user interface. A user interface is something which bridges the gap between a user who seeks to control a device and the software and/or hardware that actually controls that device. The user interface for a computer is typically a software program running on the computer's central processing unit which responds to certain user-entered commands. Order entry system (FIG. 3) uses object-based windows as the preferred user interface. In a related aspect, PowerBuilder® by Powersoft Corporation is used as the window development tool.

In one embodiment, the present invention can be implemented using an interactive graphical user interface for specifying and refining database queries. One example of such an interface is provided by the “AVS™” visual application development environment manufactured by Advanced Visual System, Inc., of Waltham Mass. Another example of a visual programming development environment is the IBM® Data Explorer, manufactured by International Business Machines, Inc. of Armonk, N.Y.

It is noted that using a visual-programming environment, such as AVS, is just one example of a means for implementing an embodiment of the present invention. Many other programming environments can be used to implement alternate embodiments of the present invention, including customized code using any computer language available. Accordingly, the use of the AVS programming environment should not be construed to limit the scope and breadth of the present invention.

In one embodiment, using such a system reduces custom programming requirements and speeds up development cycles. In addition, the visual programming tools provided by the AVS system facilitate the formulation of database queries by researchers who are not necessarily knowledgeable about databases and programming languages. In addition, an advantage to using a programming environment such as AVS, is that the system automatically manages the flow of data, module execution, and any temporary data file and storage requirements that may be necessary to implement requested database queries.

AVS is particularly useful because it provides a user interface that is easy to use. To perform a database query, users construct a “network” by interacting with and connecting graphical representations of execution modules. Execution modules are either provided by AVS or are custom modules that are constructed by skilled computer programmers. For example, customized AVS modules can be constructed using a high level programming language, such as C, C++ or FORTRAN, in accordance with the principles as described.

The purpose of constructing a network in AVS is to provide a data processing pipeline in which the output of one module can become the input of another. In one aspect of the present invention, database queries are formulated in this manner. A component of the AVS system referred to as the “Flow Executive” automatically manages the execution timing of the modules. The Flow Executive supervises data flow between modules and keeps track of where data is to be sent. Modules are executed only when all of the required input values have been computed.

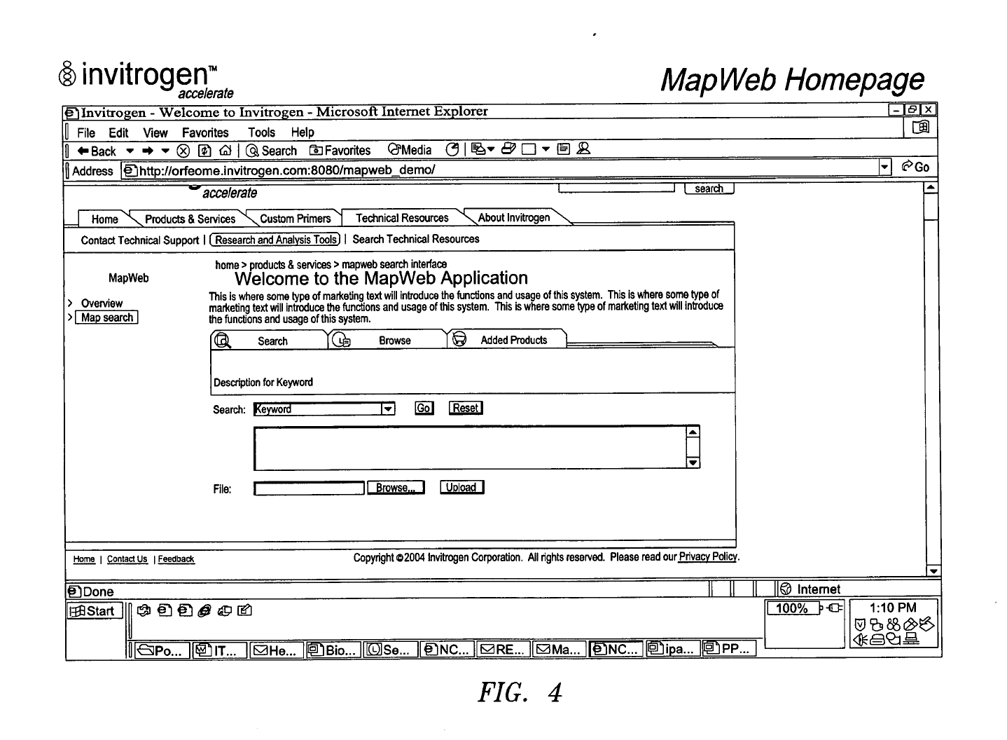

One envisaged user interface is shown in FIG. 4. The user interface employs window 120 preferably in the form of a rectangular shaped box having a toolbar 121 across the top which provides a set of standard menu options represented by a plurality of tabs or buttons A through D.

Window 120 also includes a plurality of other tabs/buttons represented preferably as search options. Tab A typically represent an action or choice, which is activated immediately upon user selection thereof. The tabs/buttons on window 120 may contain text, graphics or both. In a related aspect, buttons A through D contain graphics (i.e., icons) so that the user may readily determine the function they represent.

Window 120 preferably includes a plurality of data capture fields 122 and 123 for capturing data. The data capture fields allow the capture of variable length text. The data can be captured either automatically by system-to-system communication or by the user, such as through a keyboard.

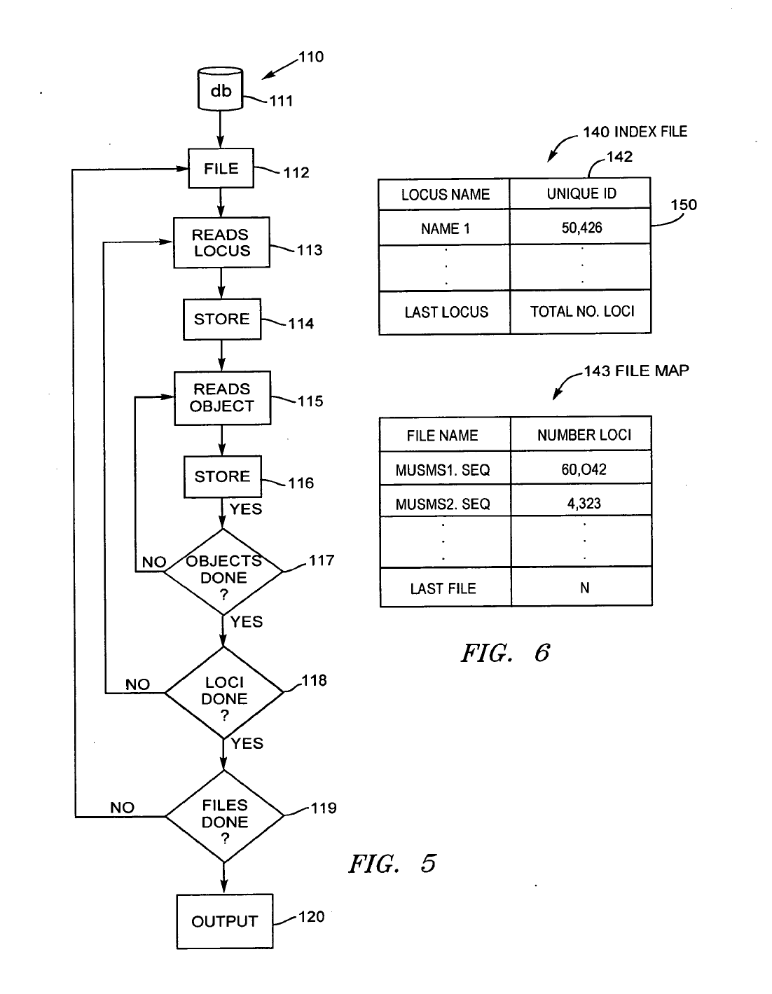

FIG. 5 is a flowchart (110) that depicts the beginning process that can be used to search for a record. The process begins with step 111, where control immediately passes to step 112. In step 112, the process opens the next ORF file. Typically, the first time step 112 is executed, the first file listed in the file map is opened. An example of a file map can be seen in FIG. 6. FIG. 6 illustrates in block diagram form the contents of an index file and a file map in accordance with an embodiment of the present invention.

As shown, the index file 140 comprises, for example, the unique Name 1 of each element in the database (see e.g., FIG. 2), and a unique ID 142 that is assigned to each element. Typically, the unique ID 142 assigned is simply the order number in which the entry appears in the database. Typically, when multiple files are used, their ordering is performed according to the file map described below.

A file map 143 may comprise the file name of each file in the database, and the number of entries (loci) within each file. Thus, given a loci number (i.e., the unique ID 142 assigned to each loci, as described above), one can easily determine which file contains the entry by consulting the file map 143.

Returning to FIG. 5, next, in step 113, the process parses the file and reads the next locus in the file. Of course, the first time step 113 is executed for each file, the first locus in the file is read. Next, as indicated by step 114, the offset and length of the locus read and parsed in step 113 is stored in an associated card file (card files contain a road map pertaining to the searchable objects within the associated locus). Typically, for example, the card file would have same name as the associated sequence file for identification purposes. For example, for a mouse file named “MUSMS.SEQ,” the associated card file is named “MUSMS.CRD.”

Next, as indicated by step 115, the next searchable object is read. For example, the first time this step is executed, the LOCUS section is read and its offset and length are determined. This offset and length is next stored in the associated objects file, as indicated by step 116. Typically, for example, the objects file would have the same file name (but different file type), as the associated sequence file for identification purposes. For example, for a mouse file named “MUSMS.SEQ,” the associated parameter file is named “MUSMS.OBJTS.”

Next, as indicated by step 117, the process determines if there are additional searchable objects in the locus. If so, control loops back and steps 115 and 116 are executed, thereby storing offsets and lengths for all searchable objects in the locus, until all searchable objects have been processed.

As indicated by step 117, once all searchable objects have been processed, control passes to step 118. In step 118, the process determines if there are any additional loci remaining in the file read in step 117. If so, control passes back to step 113, and the next locus is processed in the same manner as described above. Once the last locus in the file has been processed, control passes to step 119, as indicated.

In step 119, the process determines if there are any more files listed in the file map that need to be processed. If so, control passes back to step 112, where the next file is opened. Next, the process repeats itself, as described above, until all files have been processed in the manner described above. Finally, as indicated the process ends with step 120.

The net result of the process depicted in FIG. 5, is the creation of an index file and an objects file (i.e., extract) for each file used in a particular implementation of the present invention.

The index files and object files are each read into memory and a file name is associated for each Unique ID once the system receives a request to perform a search on a particular locus.

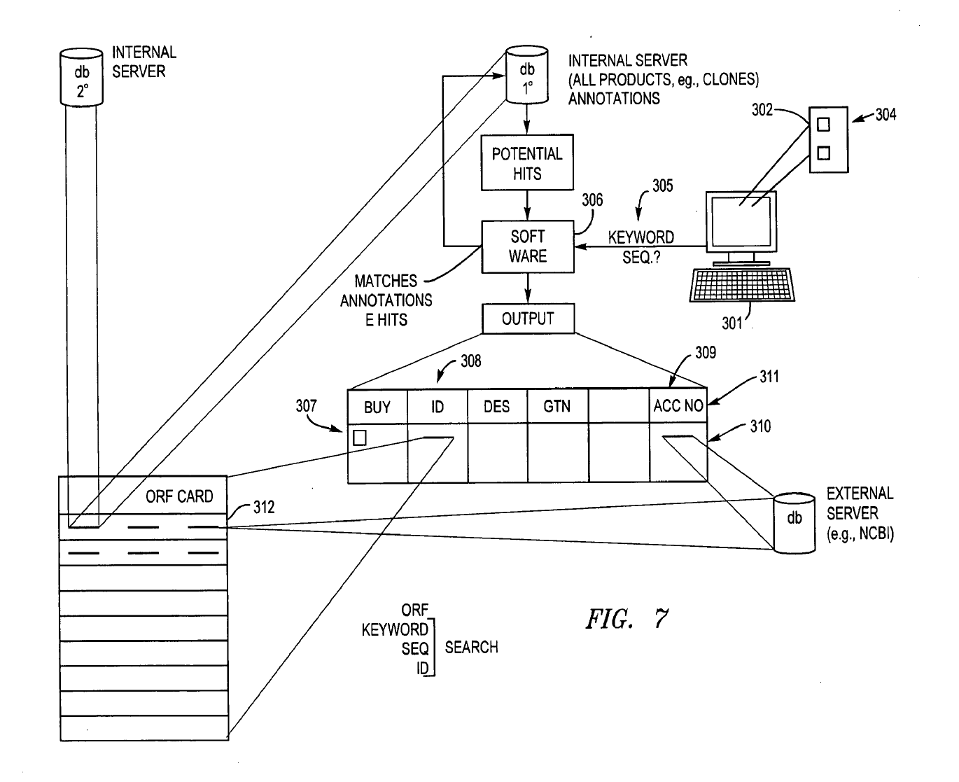

A flow chart for use of the index file and object file is shown in FIG. 7. A user interface 301 allows the user to input parsable/searchable information (e.g., a word, phrase, sequence, ID number). Optionally, the search can be scoped by activating GUI 304 prior to inputting parsable/searchable information 305. In the next step, the scoped search limits access to only a certain portion of all of the products available on the database 302 (e.g., all mouse data, each associated with a unique ID). Software 306 processes the inputted command to limit output to only those files matching the keyword within the scoped products, e.g., page 311.

The output page will contain a list of hits 307 corresponding to the input command, where the user can point to embedded hyperlinks to access annotation data associated with, for example, a unique ID number 308 or accession number 309. If the hyperlink for the unique ID number 310 is activated, the number is used to search the index file and the corresponding data is matched to the objects file. Matching of the index and object file will retrieve the appropriate locus from the ORF file database 312 and an annotated document for the unique ID number will be displayed to the user.

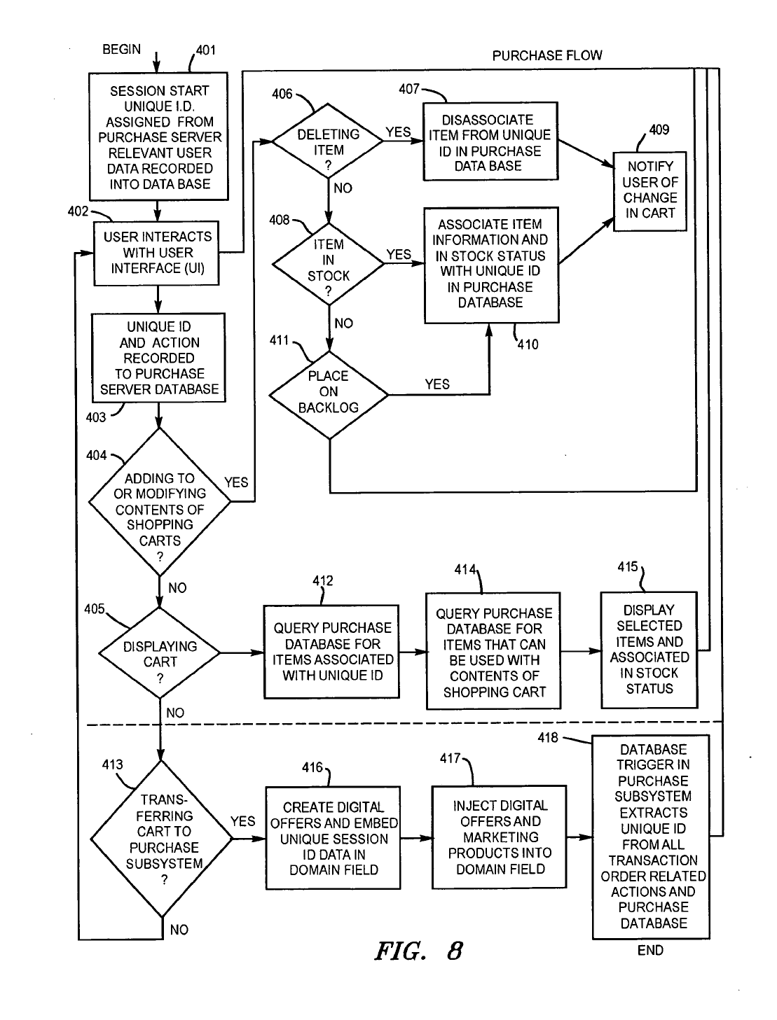

FIG. 8 is a purchase flow diagram of interactive network session tracking from inbound source to net sale in accordance with one embodiment of the present invention. Operation begins at stage 401 in response to a new user initiating access to an interactive network site. At stage 401, a unique session ID (identifier) is assigned from a front-end session database, and relevant user data is recorded in the session database associated with the session ID. For example, the relevant user data includes the user's inbound source (origin), such as a unique source ID of a banner (advertisement) on a search engine WWW site (e.g., which can be determined using standard name-value pairs passed via HTTP protocol).

At stage 402, the user interacts with the user interface of the network site. For example, the user interacts with the WWW online site by adding or deleting items from a virtual shopping cart or by jumping to different, dynamically generated HTML pages of the WWW site. At stage 403, any action performed by the user during stage 402 is recorded in the session database and associated with the session ID.

At stage 404, whether the user added or modified items in the shopping cart during stage 402 is determined. If so, operation proceeds to stage 406. Otherwise, operation proceeds to stage 405. At stage 406, whether an item is to be deleted from the shopping cart is determined. If so, operation proceeds to stage 407. Otherwise, operation proceeds to stage 408. At stage 407, the deleted item is disassociated from the session ID in a purchase server shopping cart database. Operation then proceeds to stage 409, which is discussed below. At stage 408, whether the item to be added is in stock is determined. If so, operation proceeds to stage 410. Otherwise, operation proceeds to stage 411. At stage 410, the added item is associated with the session ID in the shopping cart database. The in-stock status is also associated with the session ID in the shopping cart database. At stage 411, the out-of-stock item is placed on backorder. The entry in the shopping cart database that is associated with the session ID is then appropriately updated at stage 409. At stage 409, the user is notified of the change in the shopping cart. For example, the user is appropriately notified of the added or modified item(s) in the shopping cart.

In one embodiment, if the item is out of stock or the item requires custom service (e.g., but not limited to, antibody generation, clone production, vector design, nucleic acid/primer design, etc.), alternatively, the user can be linked to a product service page for such custom service. Further, the user can be linked directly to a service, technical or customer representative.

At stage 405, whether the user desires to have the contents of the user's shopping cart displayed is determined. For example, the user may want to view the currently added items in the user's shopping cart. If so, operation proceeds to stage 412. Otherwise, operation proceeds to stage 413. At stage 412, the shopping cart database is queried for items associated with the user's session ID. This can include items or services that can be used in connection with contents of the shopping cart (e.g., enzymes, clones, vectors, antibodies that can be used with protein query, custom designs for plasmids, maps, host organisms, etc.). At stage 415, the selected items and associated in-stock status are displayed to the user. For example, the user's selected items for purchase are output to the user's display.

At stage 413, whether the user is ready to purchase the currently selected items is determined. If so, operation proceeds to stage 416 and transitions to a (secure) purchase subsystem (e.g., a purchase subsystem that communicates via the Internet using an encrypted protocol to protect sensitive financial data). Otherwise, operation returns to stage 402. In particular, as shown by the horizontal dashed line of FIG. 8, if the user elects to proceed to purchases of the selected items in the user's shopping cart, then operation transitions across a seam between a first subsystem and a second subsystem of the network site (e.g., a WWW server). In one embodiment, the first subsystem is a catalog subsystem, which uses standard HTTP protocol, and the second subsystem is a secure purchase subsystem, which uses standard SSL (Secure Sockets Layer) protocol (i.e., an encrypted protocol for security purposes).

At stage 417, a digital offer is created to execute a net sale transaction (e.g., a customer order) of the selected items. For example, the shopping cart data stored in the shopping cart database can be passed to Open Market's commercially available TRANSACT software for creation of one or more digital offers (e.g., one digital offer per product). The session ID is embedded in the Domain field (also called the unique ID field) of each digital offer such that inbound source, user activity at the network site, and net sales data are all associated with the same unique session ID for subsequent (e.g., offline) correlation and analysis.

At stage 418, the digital offer is injected into a transaction database, such as the commercially available Open Market TRANSACT database. Thus, the user's shopping cart data is also maintained in the transaction database of the purchase subsystem and is associated with the user's unique session ID.

The user can modify items in the user's shopping cart after entering into the purchase subsystem. For example, the user may decide to delete an item from the user's shopping cart. Accordingly, at stage 418, the shopping cart data associated with the session ID that is stored in the Open Market TRANSACT database is extracted from all TRANSACT order-related actions and the shopping cart database is appropriately updated. Accordingly, the shopping cart database of the catalog subsystem is synchronized with the shopping cart data stored in the transaction database of the purchase subsystem. If the user executes any further interactions with the user interface of the WWW online site, then operation returns to stage 402. Otherwise, (i.e., the user exits the browser session) operation terminates.

In a related aspect, each new record includes the new session ID, a source ID (i.e., an inbound source), a time stamp, a referrer URL (Universal Resource Locator), an IP (Internet Protocol) address, and an entry point (e.g., WWW online site start page). The session ID is associated with the user's browser session using a standard transient (HTTP) cookie (i.e., the cookie stored on the user's computer includes the session ID). Thus, the user's subsequent actions (e.g., HTTP requests) are associated with the user's unique session ID at least until the user exits the user's browser (i.e., the user's session is viewed as the life of the user's browser session).

In one embodiment, such user information can be used to track the accumulation of materials for illicit purposes (e.g., bio-terrorism), where orders to be shipped to separate sites for assembly may be tracked back to the same URL.

In another related aspect, every WWW page (e.g., HTML page) that is viewed is tracked in the session database and associated with the session ID. Further, every shopping-cart-related activity is tracked in the session database and associated with the session ID. In particular, the session database records include the following: the session ID, the time stamp, the page viewed or nature of interaction, and (for shopping-cart-related activities) the online products or services added or modified.

In a further related aspect, when adding a product to the shopping cart, a new record is added in the shopping cart database. For example, the new record includes the session ID, a model identifier, an in-stock indicator (e.g., Y or N for in stock or out-of-stock, respectively, which can then be interpreted to determine if an added item is on back-order), and a quantity. Moreover, when modifying the quantity of an item already in the shopping cart, the record in the shopping cart database containing the item is located using the session ID, model, and in-stock indicator as criteria. The appropriate criteria can then be updated. An adjusted quantity can trigger a change to an out-of-stock indicator if the quantity exceeds available inventory. At stage 406, when deleting a product from the shopping cart, the appropriate record is located as similarly discussed above. The located record can then be deleted.

The following design considerations may, for example, be used to design a database used in the present invention: Product tables: each product line has a table with its own unique attributes, including its original accession and version. A Master product table links all different product types with common features (sku, size, name, description), consolidates the search by product id and sku, and speeds up the data retrieval. A product accession association table manages gene association of different product lines, product association, and consolidates the search by gene related identifications. Product reporting tables manage the daily update of gene and its product association and report the mapping status to managers for each product line. A LIMS (pipeline) table links on shelf products with products in pipeline to provide consolidated reporting view of product portfolios related with a specific set of gene targets, which may, for example, be necessary for developing matched reagent set. In addition, the updates may, for example, be tracked and time stamped.

### Example 7

### Advanced Search Modules

The present Example provides an illustration of advanced search modules that may be used to search a biological element and obtain matched biological reagents. Such search modules may be designed such that the output includes matched biological reagents, or, for example, the initial output on the first page would include only the specific target molecules that are the results of the search, each comprising a hyperlink to matched biological reagents to that target molecule.

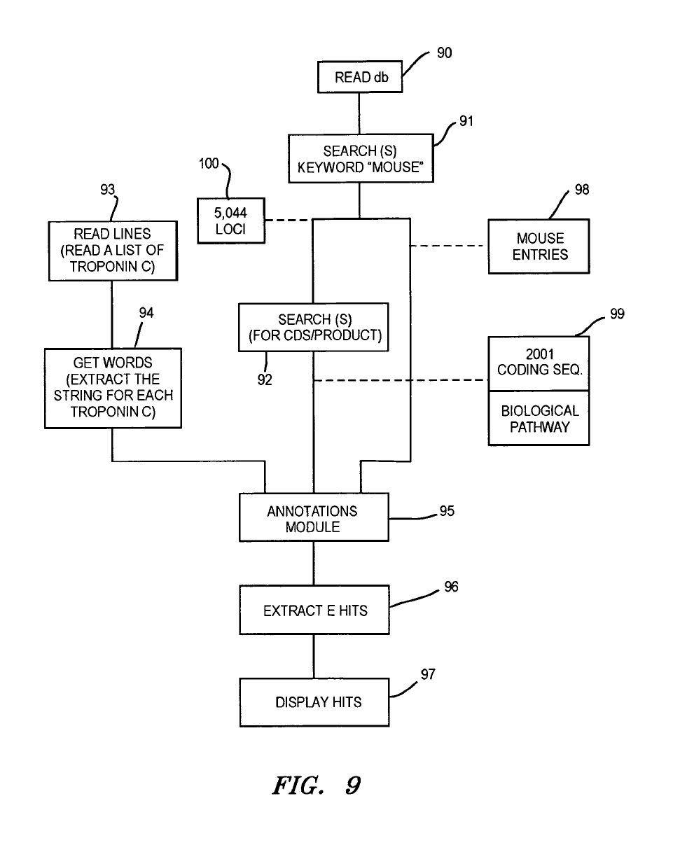

Advanced search modules 120 identify the way in which a user may retrieve objects from the server for that are of procurement interest. A dialog flow for the advanced search modules is shown in FIG. 9.

In FIG. 9 a search is performed in the mouse database to search for troponin C for mice. As shown, the first step is to execute the read database module 90. The output is the mouse portion of the database. Next, as indicated, the search database module 91 is executed. In this case, the user enters search parameters to extract all “mus musculus” (mouse) entries from the database. As indicated by the output block 98, this results in a total of 60,055 entries.

Next, the search database module 92 is again executed. This time the input is the 5,044 mouse loci from module 81. This time the search is performed to find coding sequences (CDS). A read lines module 93 is executed in parallel for reading in a pre-compiled list of named troponin c sequences. Next, as indicated, a get-words module is used to extract the sequence from each of the named troponin C sequences.

Next, the search database module 95 is executed. The search database module 95 has three input parameters. The first input parameter is the Hits list 100 comprising the 5,044 mouse loci. The second parameter is the Hits list 99 comprising the 2001 coding sequences. The coding sequences 99 are used to provide a context to the Annotation module 95. This annotation is used in conjunction with parameters from the vendor that defines the relationship for the annotation. For example, the vendor can specify a search for troponin c sequence 93 that is associated with pathway information 99

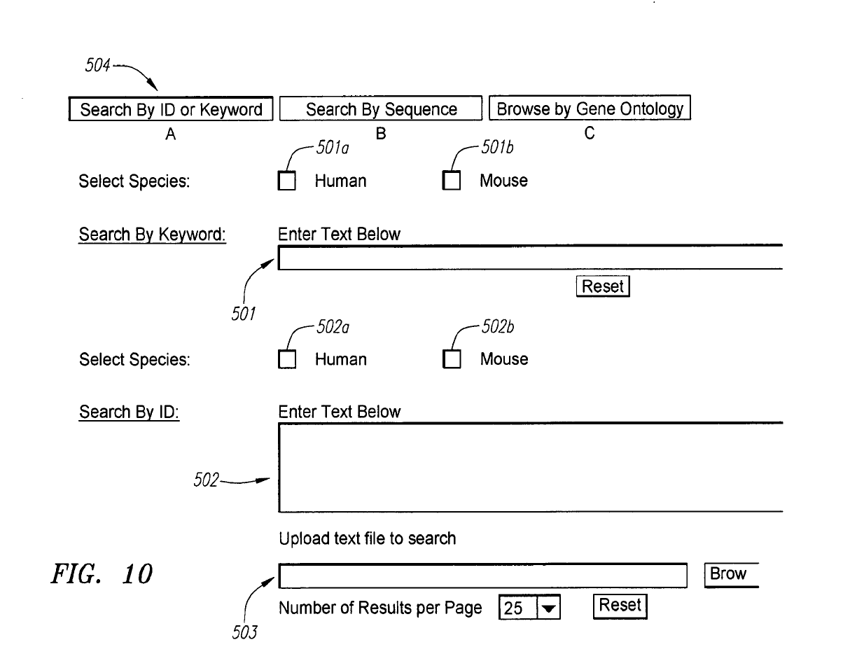

In order to initiate a search, the user must be able to pull up a subset of target items from the system. In this regard, the advanced search modules used are made up of at least 3 functions (FIG. 10), namely Search By Keyword/I.D. (which includes text file searching), Search By Sequence, and Browse By Ontology, all of which may be further parsed by selection of species (501(a) and (b)). These functions may be represented by tabs 504 (A), (B), and (C) of the user interface of FIG. 10. For example, such dialog boxes may include Search By Keyword (to include Select Species buttons 501 (a) and (b)) 501, Search By ID (to include Select species buttons) 502, and Upload text file to search 503.

Search by Keyword

Prior to activation of Search By Keyword 504, buttons are available for selection of species (501 (a) and (b)). Further, the number of results per page can be delimited on the first page of the browser.

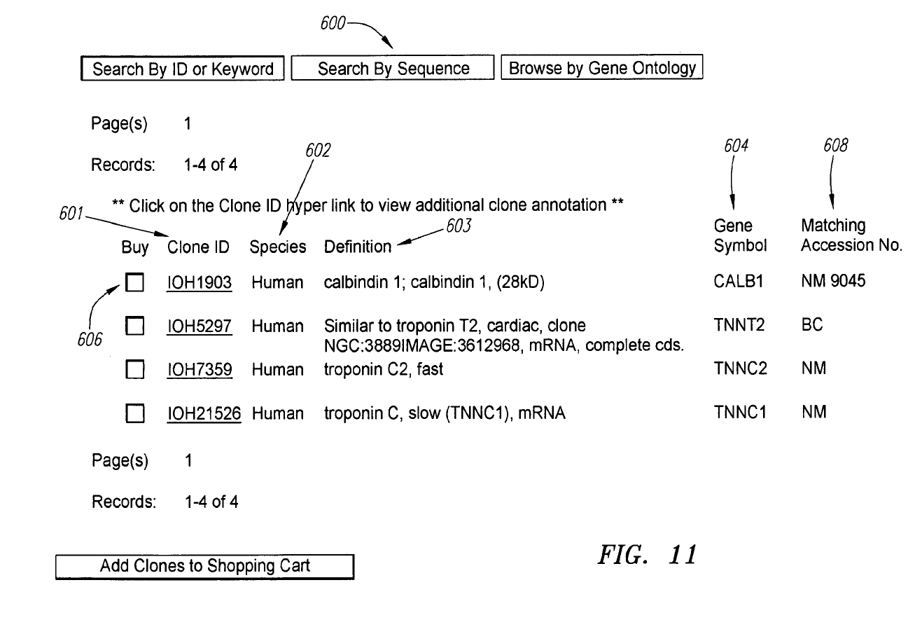

Upon inputting of keywords in the appropriate dialog box, a window 600 as shown in FIG. 11 opens and permits the user to view the products which conform to the biological attributes associated with the keywords. The search results window 600 defines the number of pages and records which conform to the search criteria of the user. As is shown from search results window 600 of FIG. 11, 5 search criteria data fields are preferably identified. These include a Clone ID field 601, species field 602, definition field 603, Gene Symbol filed 604 and Accession Number field 605. Also included is a button for the option to buy the biological material(s) meeting the criteria of the search (606).

It is understood that the search criteria will vary depending upon the keywords and species selected. Upon selecting a keyword and species, window 600 displays at least one page of results representing a number of records associated with the keywords currently used. For example, in the case of troponin C (human), window 600 provides results page displaying the number of pages encompassing the records, the number of records, option to buy, Clone ID, Species, Definition of the clone, Gene Symbol and Accession Number associated with the cloned gene (FIG. 11).

Search by ID

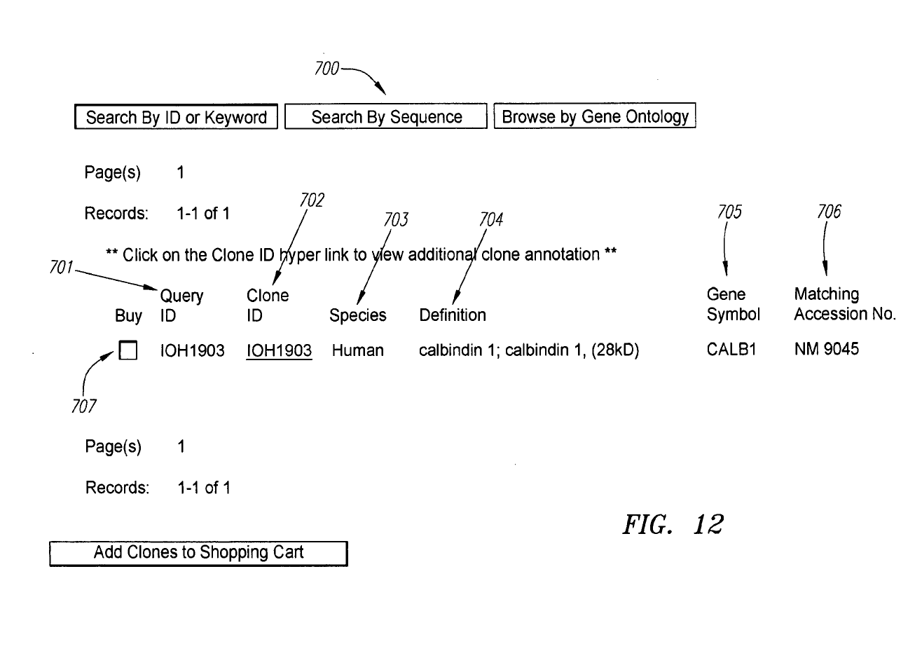

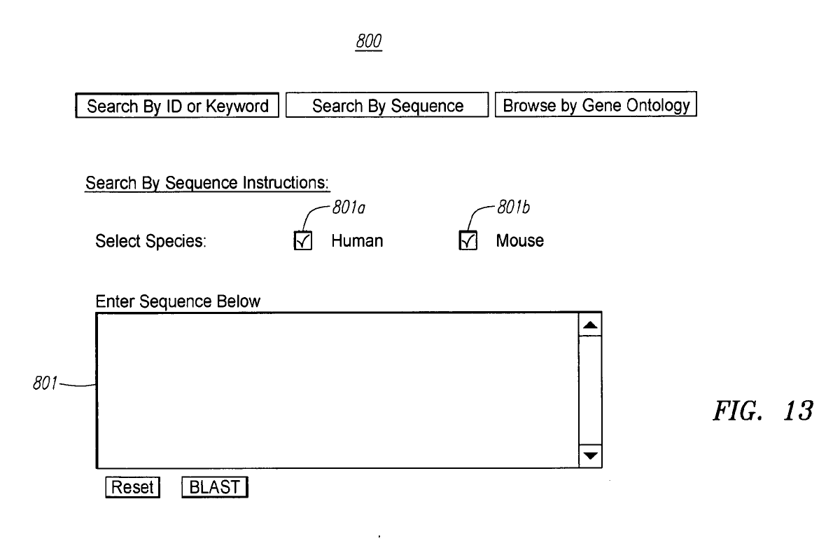

Prior to activation of Search By ID 502, buttons are available for selection of species (502 (a) and (b)). Upon inputting of appropriate ID (e.g., Catalog Number(s), GenBank Accession(s) Gene Symbols(s), LocusLink ID(s), Unigene Cluster ID(s), etc.) in the appropriate dialog box, a window 700 as shown in FIG. 12 opens and permits the user to view the products which conform to the biological attributes associated with the ID numbers. The search results window 700 defines the number of pages and records that conform to the search criteria of the user. As is shown from search results window 700 of FIG. 12, 6 search criteria data fields are preferably identified. These include a Query ID field 701, Clone ID field 702, species field 703, definition field 704, Gene Symbol filed 705 and Accession Number field 706. Also included is a button for the option to buy the biological material(s) meeting the criteria of the search (707).

Again, it is understood that the search criteria will vary depending upon the type of ID used and species selected. Moreover, text files can be uploaded from the users computer to the browser page at the “Upload Text File to Search” field for subsequent search (FIG. 10, 503).

Search by Sequence

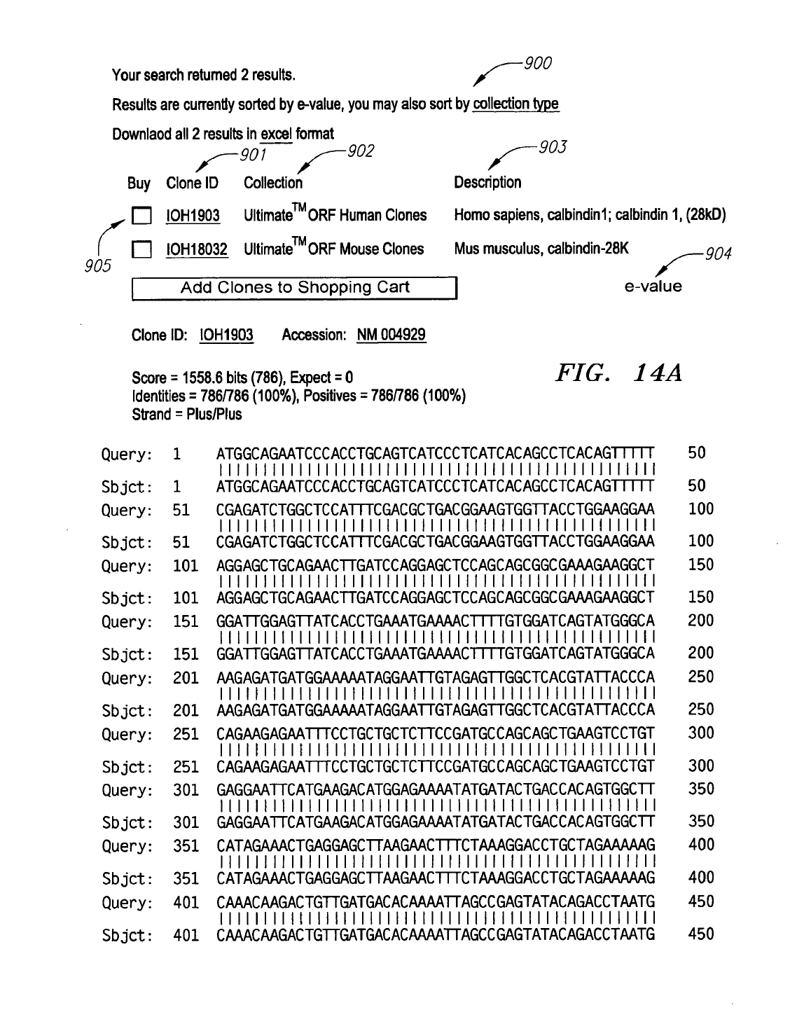

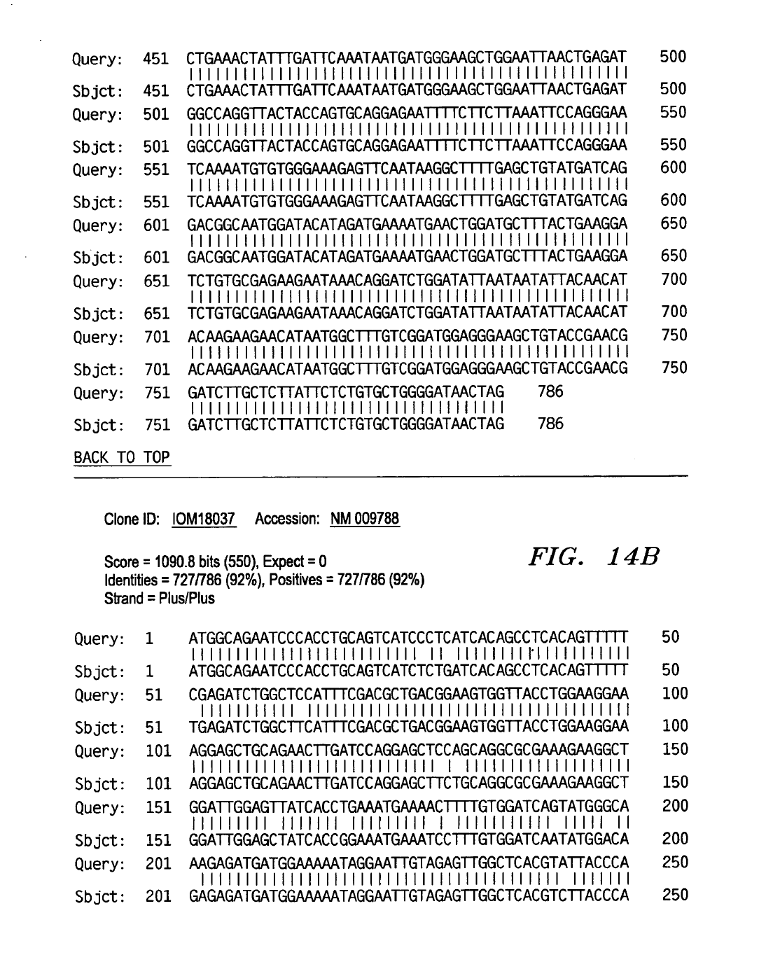

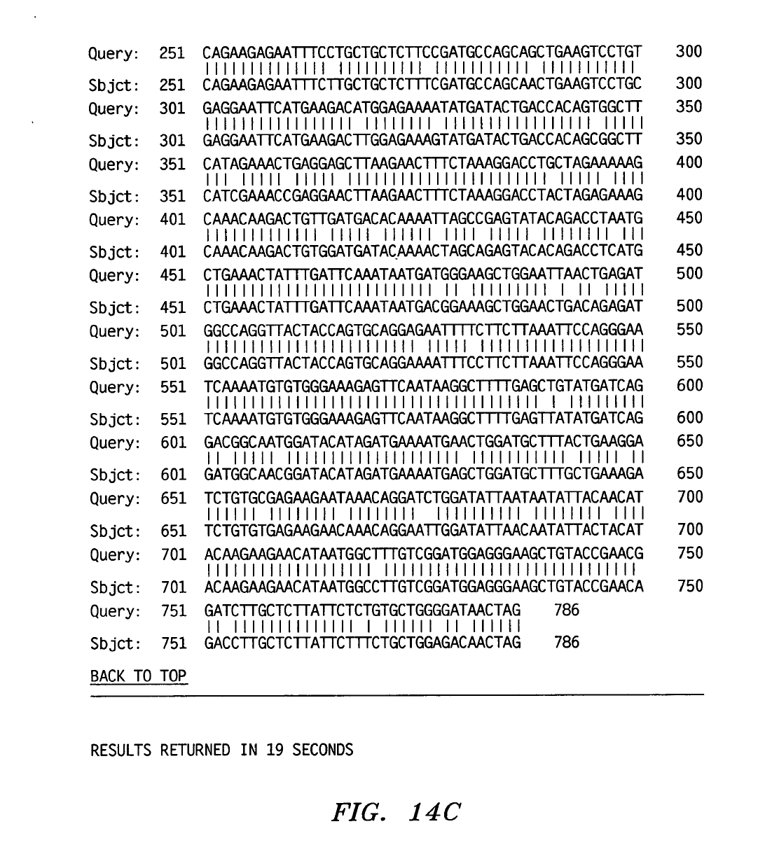

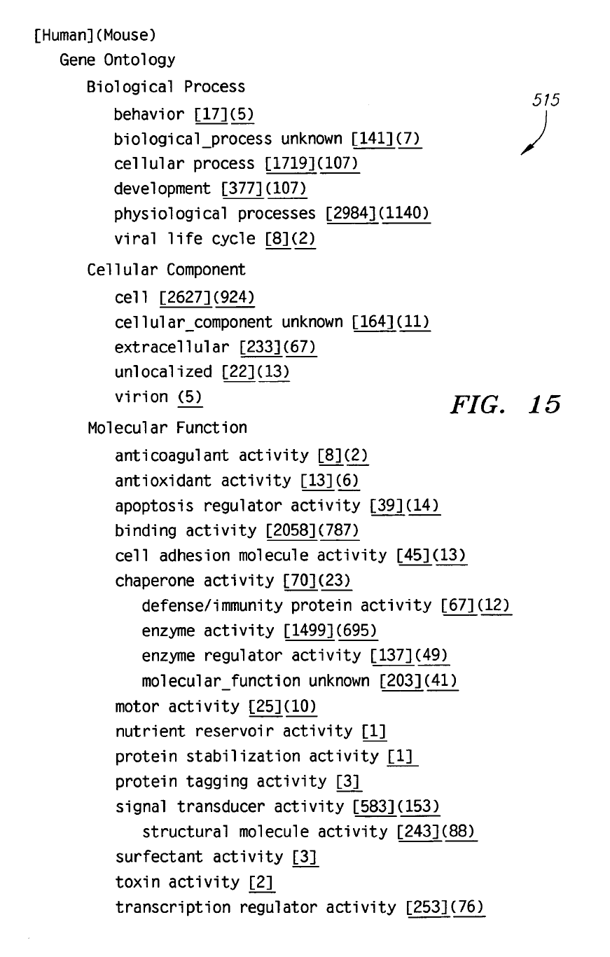

Prior to activation of Search By Sequence, buttons are available for selection of species (FIG. 13, 801(a) and (b)). Upon inputting of appropriate sequence (e.g., the input sequence window accepts nucleotide/amino acid sequences between 50 and 10,000 residues in FASTA, GenBank, and text formats, blastn is used to search the clone databases and results with e-values less than 0.01 are reported, etc.) in the appropriate dialog box (801), a window 900 as shown in FIG. 14 opens and permits the user to view the products which conform to the biological attributes associated with the sequence. The search results window 900 defines the number of results which conform to the search criteria of the user. As is shown from search results window 900, 4 search criteria data fields are preferably identified. These include a Clone ID field 901, collection field 902, description field 903, and e value 904. Further a field is available for linking user to the specific sequence described in 904. Also included is a button for the option to buy the biological material(s) meeting the criteria of the search (905).

Browse by Ontology

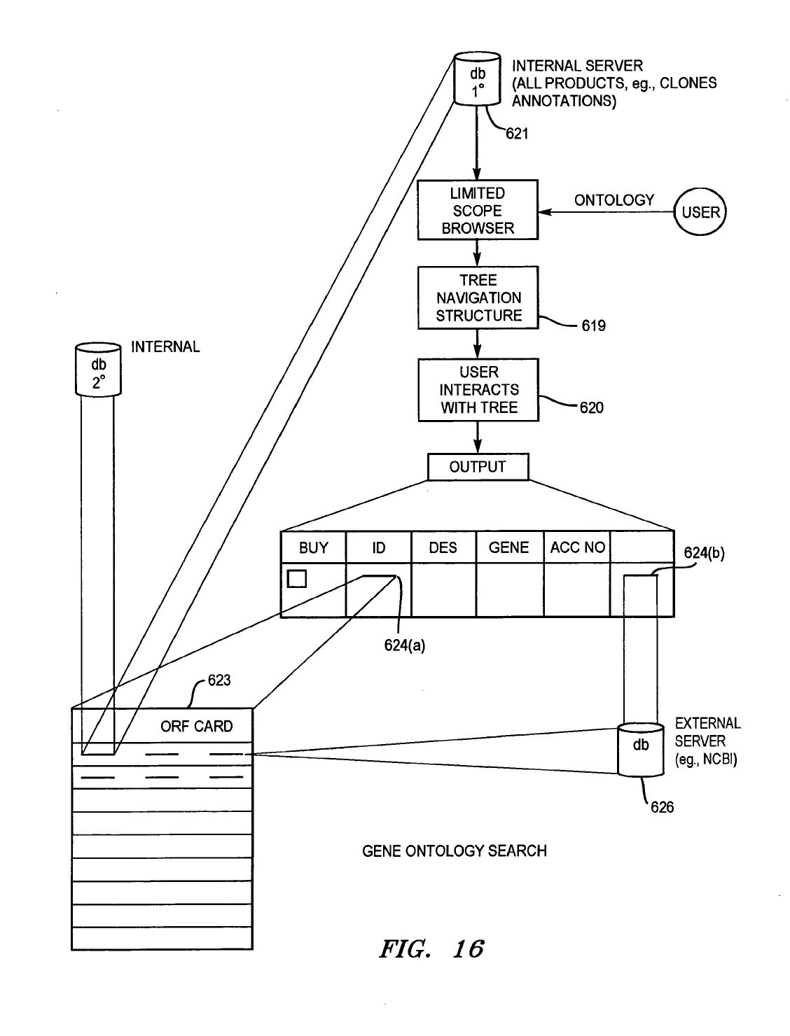

Activation of the Browse by Ontology tab triggers a keyword jump which loads a separate limited scope page (FIG. 15, 115). The illustration in FIG. 16, diagrams the flow (116). Using tree navigation (119), the gene ontology page displays, for example, three categories for viewing/activation by the user (e.g., Biological Process, Cellular Component, or Molecular Function). The user then activates a GUI (e.g., button, 120), that displays a number of headings (behavior, biological process unknown, cellular process, development, obsolete, physiological processes, viral life cycle, etc.) within that category. Optional indicators may include, but are not limited to, the number of subcategories under each category. The headings are followed by selectable species designations (e.g., human, mouse, etc.), which the user can activate, resulting in a search results window as described above.

The search results windows also contains hyperlinks (124 (a) and (b)) which may lead to another WWW site (126), or another place within the same browser (121). In the exemplified system, after a clone has been selected, the user can click the hyperlink in the Clone ID field (124 (a)) which leads to an electronic (ORF) card for the selected clone (123). The card may contain headings such as gene information, open reading frame (ORF) information, clone information, protein information, single nucleotide polymorphism information, and genomic links. In a preferred system, the headings are followed by fields containing hyperlinks to both commercial and private databases (e.g., gov't, universities, consortiums, etc. (126)) which provide further information regarding the category as denoted by the heading.

The Ontology database is regularly updated by manual inputting of new data or by tracking using a Web robot to search the World Wide Web for such new data (e.g., see U.S. Pat. No. 6,718,363).

In one aspect, a preference database may be generated to contain profile data on a user. In a related aspect, a type of device for building a preference database is a passive one from the standpoint of the user. The user merely makes choices (e.g., menu choice in a browser built into a reader) in the normal fashion and the system gradually builds a personal preference database by extracting a model of the user's behavior from the choices. It then uses the model to make predictions about what products or services the user would prefer in the future or draws inferences to classify the user (e.g., an industrial scientist or an academic scientist). This extraction process can follow simple algorithms, such as identifying apparent preferences by detecting repeated requests for the same product or service, or it can be a sophisticated machine-learning process such as a decision-tree technique with a large number of inputs (degrees of freedom). Such models, generally speaking, look for patterns in the user's interaction behavior (i.e., interaction with a UI [user interface] for making selections). Such a database can also be used to control inventory, marketing, manufacturing, send warnings or notices to sales staff, shipping and/or security, IT maintenance, promotions, etc. Further, the database can be a trigger to send such notification by, for example, e-mail or other forms of communication (i.e., electronic or non-electronic means).

As stated above, the Search Results window also contains a GUI (e.g., check box, 606) that can be activated to purchase selected items identified in the search (FIG. 11). The button 606, once activated, loads a shopping cart page which displays the item, quantity ordered, price and total for the amount of product ordered. Further, the page contains offers, services and advertisements that might be helpful to the user. The user may then cancel order (clear cart), recalculate order based on any discounts available, or proceed to checkout by activating the appropriate GUI (e.g., button).

Once the appropriate GUI is activated, a new web page is loaded and the user is directed to input user specific information for purchase and tracking in a customer field (dialog box).

TABLE 13

| | | | RNA | RNA |
|---|---|---|---|---|
| | | | Sense | Antisense |
| No. | Gene | Accession | Strand | Strand |
| 1 | p53 | NM_000546.2 | GCCAAGUCUGUGA | AGUACGUGCAAGU |
| | | | CUUGCACGUACU | CACAGACUUGGC |
| 2 | p53 | NM_000546.2 | CCGGACGAUAUUG | UGAACCAUUGUUC |
| | | | AACAAUGGUUCA | AAUAUCGUCCGG |
| 3 | p53 | NM_000546.2 | GCUUCGAGAUGUU | UUCAGCUCUCGGA |
| | | | CCGAGAGCUGAA | ACAUCUCGAAGC |
| 1 | CCNH | NM_001239.2 | GCACUUAACGUAA | UCUUCUUCGUGAU |
| | | | UCACGAAGAAGA | UACGUUAAGUGC |
| 2 | CCNH | NM_001239.2 | GGAGCGAUGUCAU | AAGCUCAGCAGAA |
| | | | UCUGCUGAGCUU | UGACAUCGCUCC |
| 3 | CCNH | NM_001239.2 | CCAAGAUCUGUUG | AAGCCGUACCCAC |
| | | | UGGGUACGGCUU | AACAGAUCUUGG |
| 1 | CHEK1 | NM_001274.2 | CCCAGCCCACAUG | AUAUGAUCAGGAC |
| | | | UCCUGAUCAUAU | AUGUGGGCUGGG |
| 2 | CHEK1 | NM_001274.2 | UCGCAGUGAAGAU | UUCAUAUCUACAA |
| | | | UGUAGAUAUGAA | UCUUCACUGCGA |
| 3 | CHEK1 | NM_001274.2 | GGCUUGGCAACAG | UAUACCGAAAUAC |
| | | | UAUUUCGGUAUA | UGUUGCCAAGCC |
| 1 | MAPK3 | NM_002746.1 | CCUGCUGGACCGG | AAAGGUUAACAUC |
| | | | AUGUUAACCUUU | CGGUCCAGCAGG |
| 2 | MAPK3 | NM_002746.1 | GCAUUCUGGCUGA | UUAGAGAGCAUCU |
| | | | GAUGCUCUCUAA | CAGCCAGAAUGC |
| 3 | MAPK3 | NM_002746.1 | GGAAGCCAUGAGA | AAUGUAGACAUCU |
| | | | GAUGUCUACAUU | CUCAUGGCUUCC |
| 1 | RAF1 | NM_002880.2 | GGAGUAACAUCAG | AAUAAGAGUUGUC |
| | | | ACAACUCUUAUU | UGAUGUUACUCC |
| 2 | RAF1 | NM_002880.2 | GACGUUCCUGAAG | ACAGAAGGCAAGC |
| | | | CUUGCCUUCUGU | UUCAGGAACGUC |
| 3 | RAF1 | NM_002880.2 | GGAGAUGUUGCAG | UUAGGAUCUUUAC |
| | | | UAAAGAUCCUAA | UGCAACAUCUCC |
| 1 | BRAF | NM_004333.2 | GACAUGUGAAUAU | AUGAAGAGUAGGA |
| | | | CCUACUCUUCAU | UAUUCACAUGUC |
| 2 | BRAF | NM_004333.2 | GGACCUCAGCGAG | AUGACUUCCUUUC |
| | | | AAAGGAAGUCAU | UCGCUGAGGUCC |
| 3 | BRAF | NM_004333.2 | GGAGCAUAAUCCA | AUAUAUUGAUGGU |
| | | | CCAUCAAUAUAU | GGAUUAUGCUCC |

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents.

Singular forms “a”, “an”, and “the” include plural reference unless the context clearly dictates otherwise. Thus, for example, reference to “a subset” includes a plurality of such subsets, reference to “a nucleic acid” includes one or more nucleic acids and equivalents thereof known to those skilled in the art, and so forth. The term “or” is not meant to be exclusive to one or the terms it designates. For example, as it is used in a phrase of the structure “A or B” may denote A alone, B alone, or both A and B.

Unless defined otherwise, all technical and scientific terms used herein have the same meanings as commonly understood by one of ordinary skill in the art to which this invention belongs. Although any methods and systems similar or equivalent to those described herein can be used in the practice or testing of the present invention, the methods, devices, and materials are now described. All publications mentioned herein are incorporated herein by reference for the purpose of describing and disclosing the processes, systems and methodologies which are reported in the publications which might be used in connection with the invention. Nothing herein is to be construed as an admission that the invention is not entitled to antedate such disclosure by virtue of prior invention.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

1.-30. (canceled)

31. A system for providing biological reagents matched to biological elements, comprising
a computer comprising an interface configured to provide a graphical representation to a user of a biological pathway comprising a plurality of biological molecules identified in a data file and a biological reagent matched to one or more of the plurality of biological molecules, wherein the interface is configured to accept input from the user; and
a server configured to communicate with the computer over a network and process the input from the user comprising a selection of one or more graphical representations of the biological reagents for purchase, wherein the server comprises one or more databases comprising data that matches the biological molecules to the biological reagents.

32. The system of claim 1, wherein:
the data file comprises identifiers of the biological molecules associated with experimental data indicating the presence of the biological molecules in an experiment, wherein the data file is uploaded to the server by the user.

33. The system of claim 1, wherein:
the server maps the biological molecules identified in the data file to the biological pathway and sends the biological pathway to the computer

34. The system of claim 1, wherein:
the data file comprises results from a DNA experiment.

35. The system of claim 4, wherein:
the results comprise array data.

36. The system of claim 1, wherein:
the interface is configured to provide a plurality of biological pathways comprising the plurality of biological molecules identified in the data file, wherein the input from the user comprises a selection of the biological pathway to provide on the graphical representation.

37. The system of claim 1, wherein:
the graphical representation of the biological pathway comprises representations of interactions between the plurality of biological molecules.

38. The system of claim 1, wherein:
the biological molecules matched to the biological reagents are highlighted in the graphical representation.

39. The system of claim 1, wherein:
the graphical representation of the biological molecules comprise visual links.

40. The system of claim 9, wherein:
the visual links provide functional annotation information.

41. The system of claim 10, wherein:
the visual links provide a purchase function of one or more of the biological reagents related to the biological molecules.

42. The system of claim 1, wherein:
the biological molecules comprise nucleic acid and protein molecules.

43. The system of claim 1, wherein:
the graphical representations of the biological molecules comprise names or identifiers.

44. The system of claim 1, wherein:
the server is configured to store the biological pathway and/or the biological reagents selected for purchase in the one or more databases.

45. The system of claim 1, wherein:
the data that matches the biological molecules to the biological reagents comprises a collection comprising at least 100 different biomolecules in at least 2 biomolecule classes.

46. The system of claim 1, wherein:
the data that matches the biological molecules to the biological reagents comprises a collection comprising at least 1000 different biomolecules in at least 2 biomolecule classes.

47. The system of claim 1, wherein:
the data that matches the biological molecules to the biological reagents comprises in a collection comprising at least 100 different biological reagents in at least 2 biological reagent classes.

48. The system of claim 1, wherein:
the data that matches the biological molecules to the biological reagents comprises a collection comprising at least 1000 different biological reagents in at least 2 biological reagent classes.

49. The system of claim 1, wherein:
the biological reagents comprise proteins and nucleic acids.

50. The system of claim 1, wherein:
the biological reagents comprise at least two of antibodies, RNAi, RNA, DNA, enzymes, and peptides.
